(19) United States
(12) Patent Application Publication
(10) Pub. No.: US 2014/0298061 A1
(43) Pub. Date: Oct. 2, 2014

(54) POWER CONTROL IN A DISPERSED STORAGE NETWORK

(71) Applicant: CLEVERSAFE, INC., CHICAGO, IL (US)

(72) Inventors: Ilya Volvovski, Chicago, IL (US); S. Christopher Gladwin, Chicago, IL (US); Gary W. Grube, Barrington Hills, IL (US); Timothy W. Markison, Mesa, AZ (US); Jason K. Resch, Chicago, IL (US); Thomas Franklin Shirley, JR., Wauwatosa, WI (US); Greg Dhuse, Chicago, IL (US); Manish Motwani, Chicago, IL (US); Andrew Baptist, Mt. Pleasant, WI (US); Wesley Leggette, Chicago, IL (US); Kumar Abhijeet, Chicago, IL (US)

(73) Assignee: CLEVERSAFE, INC., CHICAGO, IL (US)

(21) Appl. No.: 14/172,218

(22) Filed: Feb. 4, 2014

Related U.S. Application Data
(60) Provisional application No. 61/807,291, filed on Apr. 1, 2013.

(51) Int. Cl. G06F 1/32

(52) U.S. Cl. CPC G06F 1/3287
USPC 713/323

(57) ABSTRACT

A method begins by a dispersed storage (DS) processing module of a dispersed storage network (DSN) receiving a plurality of data access requests regarding a plurality of data objects. As individual data access requests of the plurality of data access requests are received, the method continues with the DS processing module, for each of the individual data access requests identifying a corresponding one of a plurality of logical storage pools of the DSN and determining power based access status of the corresponding one of the plurality of logical storage pools. When the power based access status is power saving mode, the method continues with the DS processing module queuing the individual data access request. When the power based access status is not in the power saving mode, the method continues with the DS processing module executing the individual data access request.

### CROSS REFERENCE TO RELATED PATENTS

The present U.S. Utility Patent Application claims priority pursuant to 35 U.S.C. §119(e) to U.S. Provisional Application No. 61/807,291, entitled “OPTIMIZING DATA ACCESS IN A DISPERSED STORAGE NETWORK”, filed Apr. 1, 2013, which is hereby incorporated herein by reference in its entirety and made part of the present U.S. Utility Patent Application for all purposes.

### STATEMENT REGARDING FEDERALLY SPONSORED RESEARCH OR DEVELOPMENT

NOT APPLICABLE

### INCORPORATION-BY-REFERENCE OF MATERIAL SUBMITTED ON A COMPACT DISC

NOT APPLICABLE

### BACKGROUND OF THE INVENTION

1. Technical Field of the Invention

This invention relates generally to computer networks and more particularly to dispersed storage of data and distributed task processing of data.

2. Description of Related Art

Computing devices are known to communicate data, process data, and/or store data. Such computing devices range from wireless smart phones, laptops, tablets, personal computers (PC), work stations, video game devices, to data centers that support millions of web searches, stock trades, or on-line purchases every day. In general, a computing device includes a central processing unit (CPU), a memory system, user input/output interfaces, peripheral device interfaces, and an interconnecting bus structure.

As is further known, a computer may effectively extend its CPU by using “cloud computing” to perform one or more computing functions (e.g., a service, an application, an algorithm, an arithmetic logic function, etc.) on behalf of the computer. Further, for large services, applications, and/or functions, cloud computing may be performed by multiple cloud computing resources in a distributed manner to improve the response time for completion of the service, application, and/or function. For example, Hadoop is an open source software framework that supports distributed applications enabling application execution by thousands of computers.

In addition to cloud computing, a computer may use “cloud storage” as part of its memory system. As is known, cloud storage enables a user, via its computer, to store files, applications, etc., on an Internet storage system. The Internet storage system may include a RAID (redundant array of independent disks) system and/or a dispersed storage system that uses an error correction scheme to encode data for storage.

### BRIEF DESCRIPTION OF THE SEVERAL VIEWS OF THE DRAWING(S)

FIG. 1 is a schematic block diagram of an embodiment of a distributed computing system in accordance with the present invention;

FIG. 2 is a schematic block diagram of an embodiment of a computing core in accordance with the present invention;

FIG. 3 is a diagram of an example of a distributed storage and task processing in accordance with the present invention;

FIG. 4 is a schematic block diagram of an embodiment of an outbound distributed storage and/or task (DST) processing in accordance with the present invention;

FIG. 5 is a logic diagram of an example of a method for outbound DST processing in accordance with the present invention;

FIG. 6 is a schematic block diagram of an embodiment of a dispersed error encoding in accordance with the present invention;

FIG. 7 is a diagram of an example of a segment processing of the dispersed error encoding in accordance with the present invention;

FIG. 8 is a diagram of an example of error encoding and slicing processing of the dispersed error encoding in accordance with the present invention;

FIG. 9 is a diagram of an example of grouping selection processing of the outbound DST processing in accordance with the present invention;

FIG. 10 is a diagram of an example of converting data into slice groups in accordance with the present invention;

FIG. 11 is a schematic block diagram of an embodiment of a DST execution unit in accordance with the present invention;

FIG. 12 is a schematic block diagram of an example of operation of a DST execution unit in accordance with the present invention;

FIG. 13 is a schematic block diagram of an embodiment of an inbound distributed storage and/or task (DST) processing in accordance with the present invention;

FIG. 14 is a logic diagram of an example of a method for inbound DST processing in accordance with the present invention;

FIG. 15 is a diagram of an example of de-grouping selection processing of the inbound DST processing in accordance with the present invention;

FIG. 16 is a schematic block diagram of an embodiment of a dispersed error decoding in accordance with the present invention;

FIG. 17 is a diagram of an example of de-slicing and error decoding processing of the dispersed error decoding in accordance with the present invention;

FIG. 18 is a diagram of an example of a de-segment processing of the dispersed error decoding in accordance with the present invention;

FIG. 19 is a diagram of an example of converting slice groups into data in accordance with the present invention;

FIG. 20 is a diagram of an example of a distributed storage within the distributed computing system in accordance with the present invention;

FIG. 21 is a schematic block diagram of an example of operation of outbound distributed storage and/or task (DST) processing for storing data in accordance with the present invention;

FIG. 22 is a schematic block diagram of an example of a dispersed error encoding for the example of FIG. 21 in accordance with the present invention;

FIG. 23 is a diagram of an example of converting data into pillar slice groups for storage in accordance with the present invention;

FIG. 24 is a schematic block diagram of an example of a storage operation of a DST execution unit in accordance with the present invention;

FIG. 25 is a schematic block diagram of an example of operation of inbound distributed storage and/or task (DST) processing for retrieving dispersed error encoded data in accordance with the present invention;

FIG. 26 is a schematic block diagram of an example of a dispersed error decoding for the example of FIG. 25 in accordance with the present invention;

FIG. 27 is a schematic block diagram of an example of a distributed storage and task processing network (DSTN) module storing a plurality of data and a plurality of task codes in accordance with the present invention;

FIG. 28 is a schematic block diagram of an example of the distributed computing system performing tasks on stored data in accordance with the present invention;

FIG. 29 is a schematic block diagram of an embodiment of a task distribution module facilitating the example of FIG. 28 in accordance with the present invention;

FIG. 30 is a diagram of a specific example of the distributed computing system performing tasks on stored data in accordance with the present invention;

FIG. 31 is a schematic block diagram of an example of a distributed storage and task processing network (DSTN) module storing data and task codes for the example of FIG. 30 in accordance with the present invention;

FIG. 32 is a diagram of an example of DST allocation information for the example of FIG. 30 in accordance with the present invention;

FIGS. 33-38 are schematic block diagrams of the DSTN module performing the example of FIG. 30 in accordance with the present invention;

FIG. 39 is a diagram of an example of combining result information into final results for the example of FIG. 30 in accordance with the present invention;

FIGS. 40A-40H are schematic block diagrams of an embodiment of a dispersed storage network (DSN) illustrating an example of power control in accordance with the present invention;

FIG. 40I is a flowchart illustrating an example of power control in accordance with the present invention;

FIG. 41A is a schematic block diagram of another embodiment of a dispersed storage network system in accordance with the present invention;

FIG. 41B is a flowchart illustrating an example of optimizing data storage in accordance with the present invention;

FIG. 42A is a schematic block diagram of another embodiment of a dispersed storage network system in accordance with the present invention;

FIG. 42B is a flowchart illustrating an example of optimizing data storage performance in accordance with the present invention;

FIG. 43 is a flowchart illustrating another example of optimizing data storage performance in accordance with the present invention;

FIG. 44 is a flowchart illustrating an example of optimizing data access in accordance with the present invention;

FIG. 45A is a schematic block diagram of another embodiment of a distributed storage and task (DST) execution unit in accordance with the present invention;

FIG. 45B is a flowchart illustrating an example of optimizing disservice storage and task (DST) execution unit operation in accordance with the present invention;

FIG. 46A is a schematic block diagram of another embodiment of a dispersed storage network system in accordance with the present invention;

FIG. 46B is a flowchart illustrating an example of optimizing dispersed storage processing unit operation in accordance with the present invention;

FIG. 47A is a schematic block diagram of another embodiment of a dispersed storage network system in accordance with the present invention;

FIG. 47B is a flowchart illustrating an example of optimizing dispersed storage network memory operation in accordance with the present invention;

FIG. 48A is a schematic block diagram of another embodiment of a dispersed storage network system in accordance with the present invention; and

FIG. 48B is a flowchart illustrating an example of consolidating redundantly stored data in accordance with the present invention.

### DETAILED DESCRIPTION OF THE INVENTION

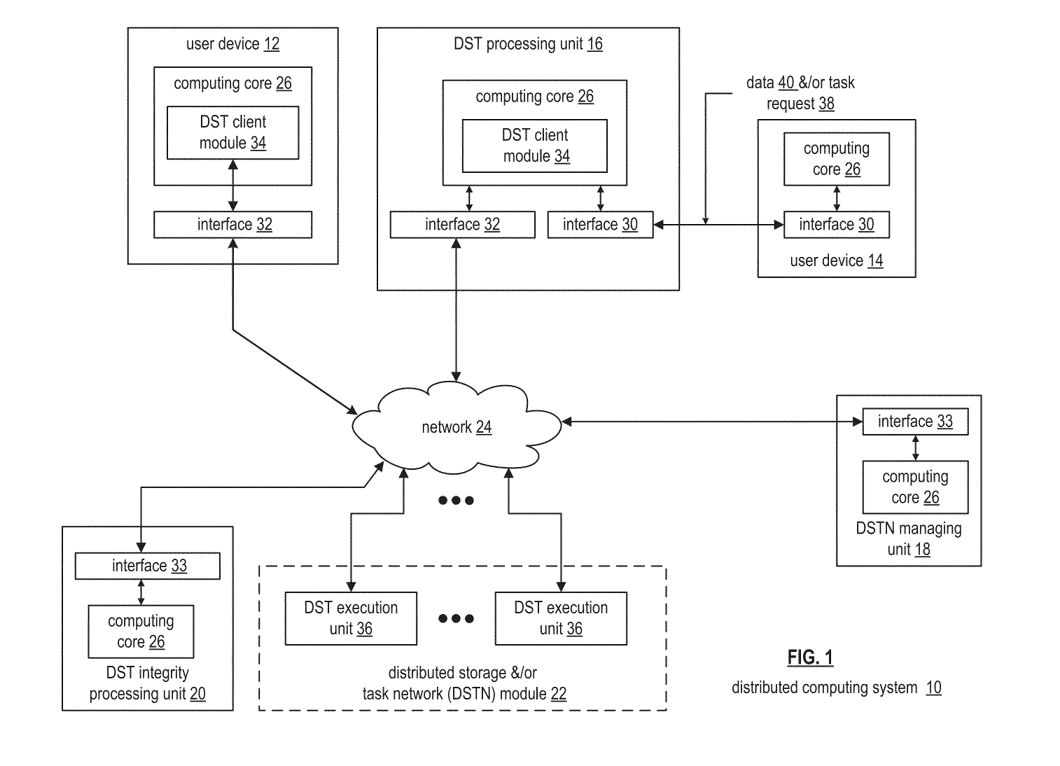

FIG. 1 is a schematic block diagram of an embodiment of a distributed computing system 10 that includes a user device 12 and/or a user device 14, a distributed storage and/or task (DST) processing unit 16, a distributed storage and/or task network (DSTN) managing unit 18, a DST integrity processing unit 20, and a distributed storage and/or task network (DSTN) module 22. The components of the distributed computing system 10 are coupled via a network 24, which may include one or more wireless and/or wire lined communication systems; one or more private intranet systems and/or public internet systems; and/or one or more local area networks (LAN) and/or wide area networks (WAN).

The DSTN module 22 includes a plurality of distributed storage and/or task (DST) execution units 36 that may be located at geographically different sites (e.g., one in Chicago, one in Milwaukee, etc.). Each of the DST execution units is operable to store dispersed error encoded data and/or to execute, in a distributed manner, one or more tasks on data. The tasks may be a simple function (e.g., a mathematical function, a logic function, an identify function, a find function, a search engine function, a replace function, etc.), a complex function (e.g., compression, human and/or computer language translation, text-to-voice conversion, voice-to-text conversion, etc.), multiple simple and/or complex functions, one or more algorithms, one or more applications, etc.

Each of the user devices 12-14, the DST processing unit 16, the DSTN managing unit 18, and the DST integrity processing unit 20 include a computing core 26 and may be a portable computing device and/or a fixed computing device. A portable computing device may be a social networking device, a gaming device, a cell phone, a smart phone, a personal digital assistant, a digital music player, a digital video player, a laptop computer, a handheld computer, a tablet, a video game controller, and/or any other portable device that includes a computing core. A fixed computing device may be a personal computer (PC), a computer server, a cable set-top box, a satellite receiver, a television set, a printer, a fax machine, home entertainment equipment, a video game console, and/or any type of home or office computing equipment. User device 12 and DST processing unit 16 are configured to include a DST client module 34.

With respect to interfaces, each interface 30, 32, and 33 includes software and/or hardware to support one or more communication links via the network 24 indirectly and/or directly. For example, interfaces 30 support a communication link (e.g., wired, wireless, direct, via a LAN, via the network 24, etc.) between user device 14 and the DST processing unit 16. As another example, interface 32 supports communication links (e.g., a wired connection, a wireless connection, a LAN connection, and/or any other type of connection to/from the network 24) between user device 12 and the DSTN module 22 and between the DST processing unit 16 and the DSTN module 22. As yet another example, interface 33 supports a communication link for each of the DSTN managing unit 18 and DST integrity processing unit 20 to the network 24.

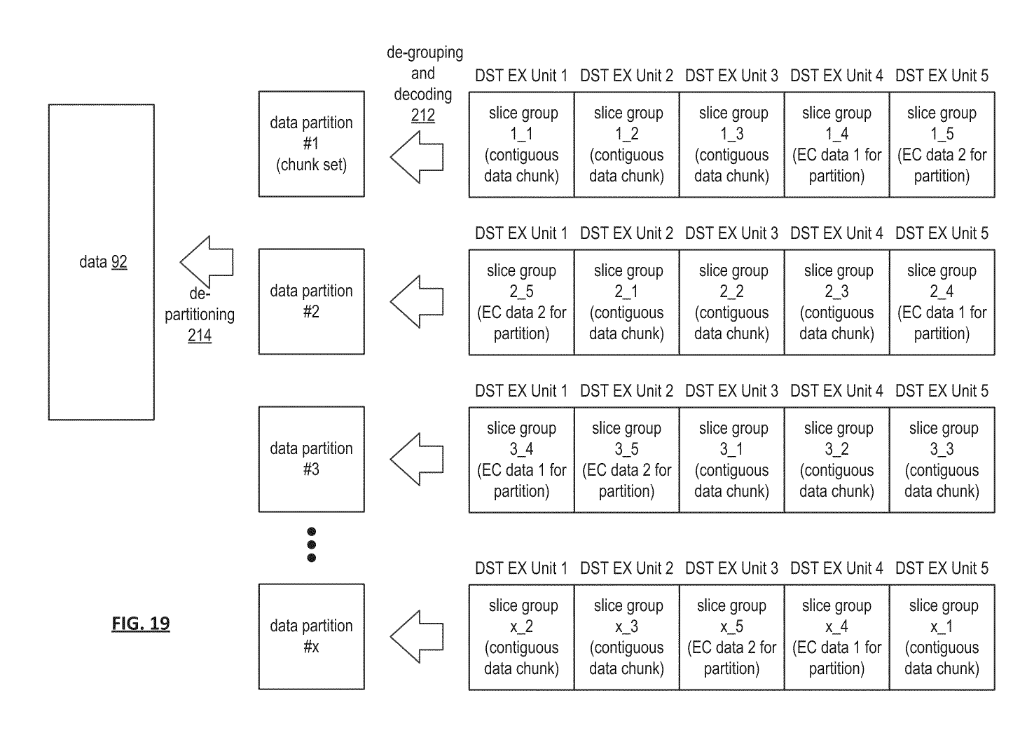

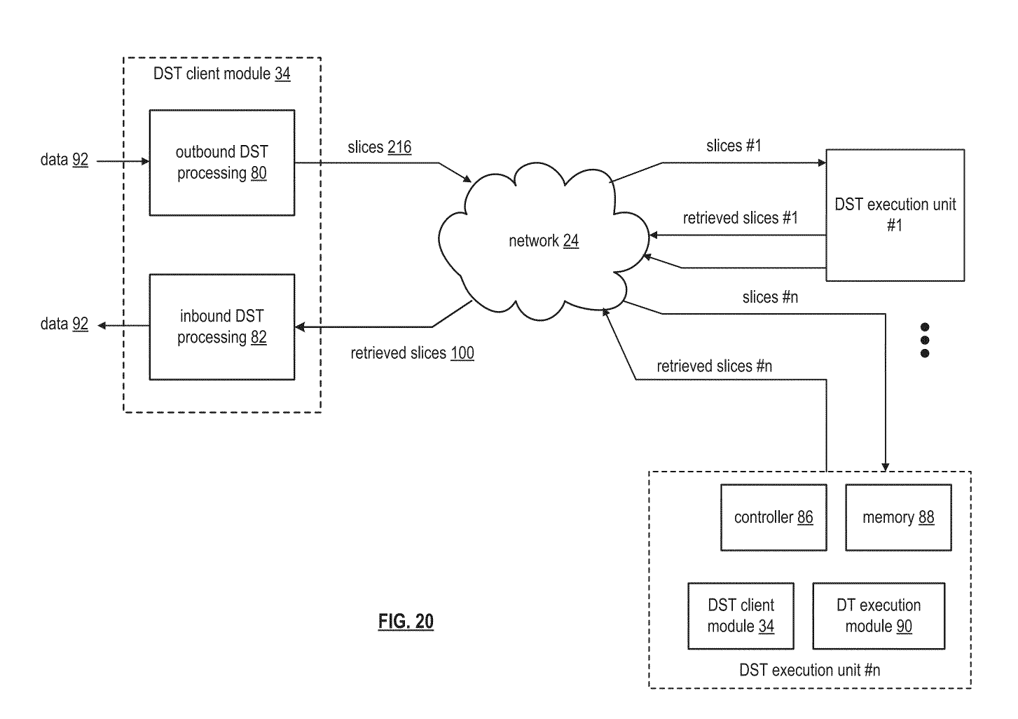

The distributed computing system 10 is operable to support dispersed storage (DS) error encoded data storage and retrieval, to support distributed task processing on received data, and/or to support distributed task processing on stored data. In general and with respect to DS error encoded data storage and retrieval, the distributed computing system 10 supports three primary operations: storage management, data storage and retrieval (an example of which will be discussed with reference to FIGS. 20-26), and data storage integrity verification. In accordance with these three primary functions, data can be encoded, distributedly stored in physically different locations, and subsequently retrieved in a reliable and secure manner. Such a system is tolerant of a significant number of failures (e.g., up to a failure level, which may be greater than or equal to a pillar width minus a decode threshold minus one) that may result from individual storage device failures and/or network equipment failures without loss of data and without the need for a redundant or backup copy. Further, the system allows the data to be stored for an indefinite period of time without data loss and does so in a secure manner (e.g., the system is very resistant to attempts at hacking the data).

The second primary function (i.e., distributed data storage and retrieval) begins and ends with a user device 12-14. For instance, if a second type of user device 14 has data 40 to store in the DSTN module 22, it sends the data 40 to the DST processing unit 16 via its interface 30. The interface 30 functions to mimic a conventional operating system (OS) file system interface (e.g., network file system (NFS), flash file system (FFS), disk file system (DFS), file transfer protocol (FTP), web-based distributed authoring and versioning (WebDAV), etc.) and/or a block memory interface (e.g., small computer system interface (SCSI), internet small computer system interface (iSCSI), etc.). In addition, the interface 30 may attach a user identification code (ID) to the data 40.

To support storage management, the DSTN managing unit 18 performs DS management services. One such DS management service includes the DSTN managing unit 18 establishing distributed data storage parameters (e.g., vault creation, distributed storage parameters, security parameters, billing information, user profile information, etc.) for a user device 12-14 individually or as part of a group of user devices. For example, the DSTN managing unit 18 coordinates creation of a vault (e.g., a virtual memory block) within memory of the DSTN module 22 for a user device, a group of devices, or for public access and establishes per vault dispersed storage (DS) error encoding parameters for a vault. The DSTN managing unit 18 may facilitate storage of DS error encoding parameters for each vault of a plurality of vaults by updating registry information for the distributed computing system 10. The facilitating includes storing updated registry information in one or more of the DSTN module 22, the user device 12, the DST processing unit 16, and the DST integrity processing unit 20.

The DS error encoding parameters (e.g., or dispersed storage error coding parameters) include data segmenting information (e.g., how many segments data (e.g., a file, a group of files, a data block, etc.) is divided into), segment security information (e.g., per segment encryption, compression, integrity checksum, etc.), error coding information (e.g., pillar width, decode threshold, read threshold, write threshold, etc.), slicing information (e.g., the number of encoded data slices that will be created for each data segment); and slice security information (e.g., per encoded data slice encryption, compression, integrity checksum, etc.).

The DSTN managing module 18 creates and stores user profile information (e.g., an access control list (ACL)) in local memory and/or within memory of the DSTN module 22. The user profile information includes authentication information, permissions, and/or the security parameters. The security parameters may include encryption/decryption scheme, one or more encryption keys, key generation scheme, and/or data encoding/decoding scheme.

The DSTN managing unit 18 creates billing information for a particular user, a user group, a vault access, public vault access, etc. For instance, the DSTN managing unit 18 tracks the number of times a user accesses a private vault and/or public vaults, which can be used to generate a per-access billing information. In another instance, the DSTN managing unit 18 tracks the amount of data stored and/or retrieved by a user device and/or a user group, which can be used to generate a per-data-amount billing information.

Another DS management service includes the DSTN managing unit 18 performing network operations, network administration, and/or network maintenance. Network operations includes authenticating user data allocation requests (e.g., read and/or write requests), managing creation of vaults, establishing authentication credentials for user devices, adding/deleting components (e.g., user devices, DST execution units, and/or DST processing units) from the distributed computing system 10, and/or establishing authentication credentials for DST execution units 36. Network administration includes monitoring devices and/or units for failures, maintaining vault information, determining device and/or unit activation status, determining device and/or unit loading, and/or determining any other system level operation that affects the performance level of the system 10. Network maintenance includes facilitating replacing, upgrading, repairing, and/or expanding a device and/or unit of the system 10.

To support data storage integrity verification within the distributed computing system 10, the DST integrity processing unit 20 performs rebuilding of ‘bad’ or missing encoded data slices. At a high level, the DST integrity processing unit 20 performs rebuilding by periodically attempting to retrieve/list encoded data slices, and/or slice names of the encoded data slices, from the DSTN module 22. For retrieved encoded slices, they are checked for errors due to data corruption, outdated version, etc. If a slice includes an error, it is flagged as a ‘bad’ slice. For encoded data slices that were not received and/or not listed, they are flagged as missing slices. Bad and/or missing slices are subsequently rebuilt using other retrieved encoded data slices that are deemed to be good slices to produce rebuilt slices. The rebuilt slices are stored in memory of the DSTN module 22. Note that the DST integrity processing unit 20 may be a separate unit as shown, it may be included in the DSTN module 22, it may be included in the DST processing unit 16, and/or distributed among the DST execution units 36.

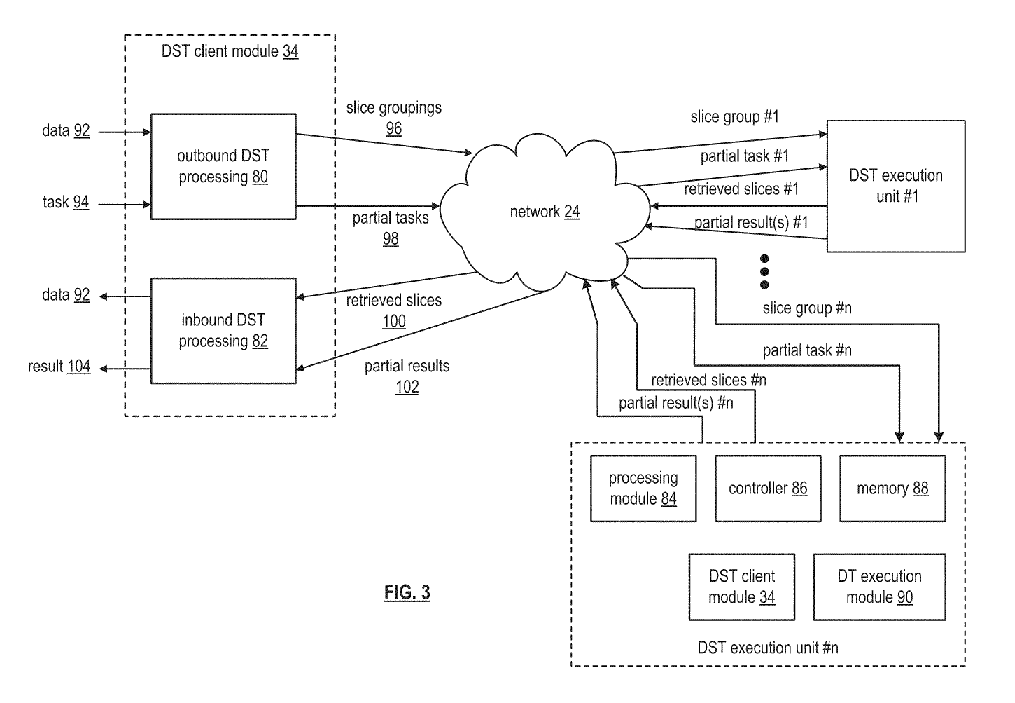

To support distributed task processing on received data, the distributed computing system 10 has two primary operations: DST (distributed storage and/or task processing) management and DST execution on received data (an example of which will be discussed with reference to FIGS. 3-19). With respect to the storage portion of the DST management, the DSTN managing unit 18 functions as previously described. With respect to the tasking processing of the DST management, the DSTN managing unit 18 performs distributed task processing (DTP) management services. One such DTP management service includes the DSTN managing unit 18 establishing DTP parameters (e.g., user-vault affiliation information, billing information, user-task information, etc.) for a user device 12-14 individually or as part of a group of user devices.

Another DTP management service includes the DSTN managing unit 18 performing DTP network operations, network administration (which is essentially the same as described above), and/or network maintenance (which is essentially the same as described above). Network operations includes, but is not limited to, authenticating user task processing requests (e.g., valid request, valid user, etc.), authenticating results and/or partial results, establishing DTP authentication credentials for user devices, adding/deleting components (e.g., user devices, DST execution units, and/or DST processing units) from the distributed computing system, and/or establishing DTP authentication credentials for DST execution units.

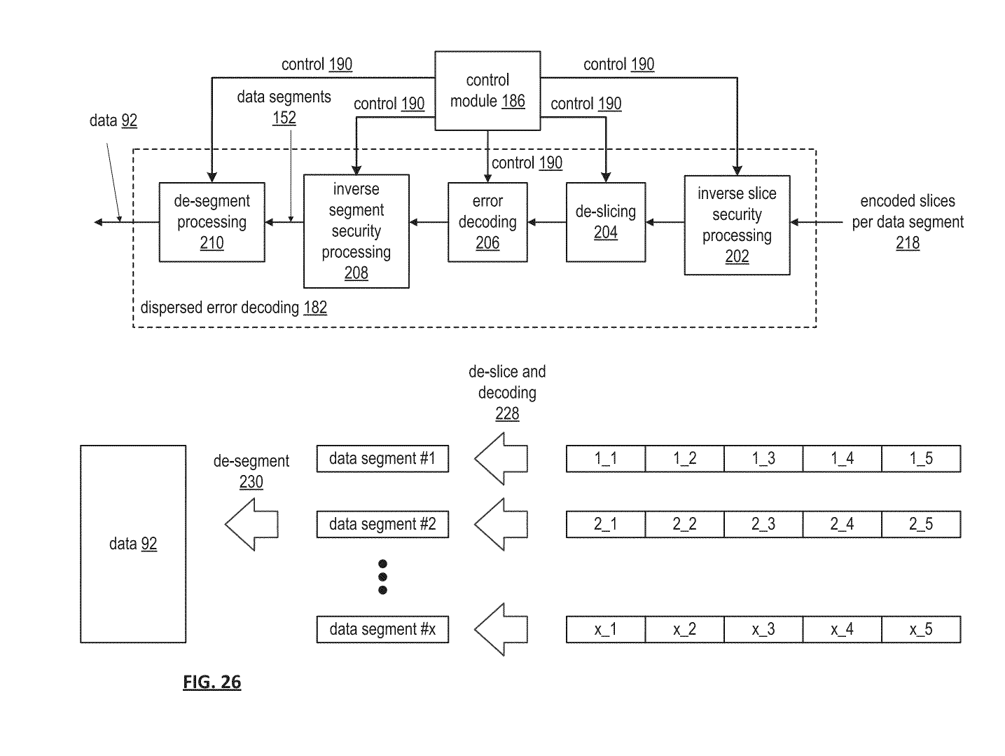

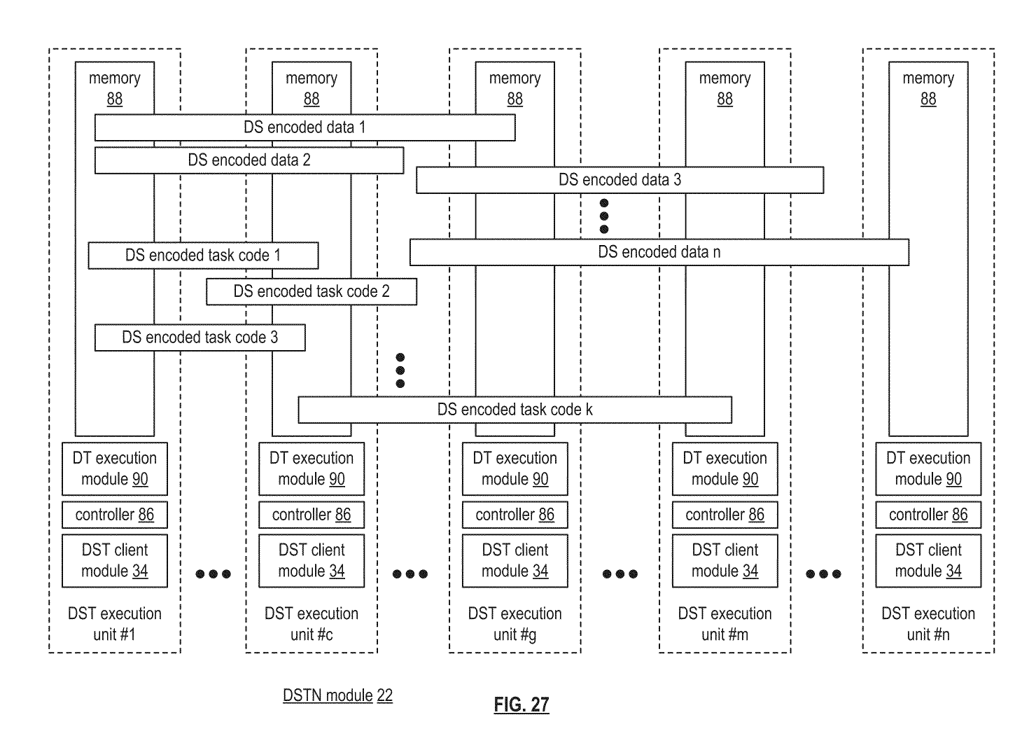

To support distributed task processing on stored data, the distributed computing system 10 has two primary operations: DST (distributed storage and/or task) management and DST execution on stored data. With respect to the DST execution on stored data, if the second type of user device 14 has a task request 38 for execution by the DSTN module 22, it sends the task request 38 to the DST processing unit 16 via its interface 30. An example of DST execution on stored data will be discussed in greater detail with reference to FIGS. 27-39. With respect to the DST management, it is substantially similar to the DST management to support distributed task processing on received data.

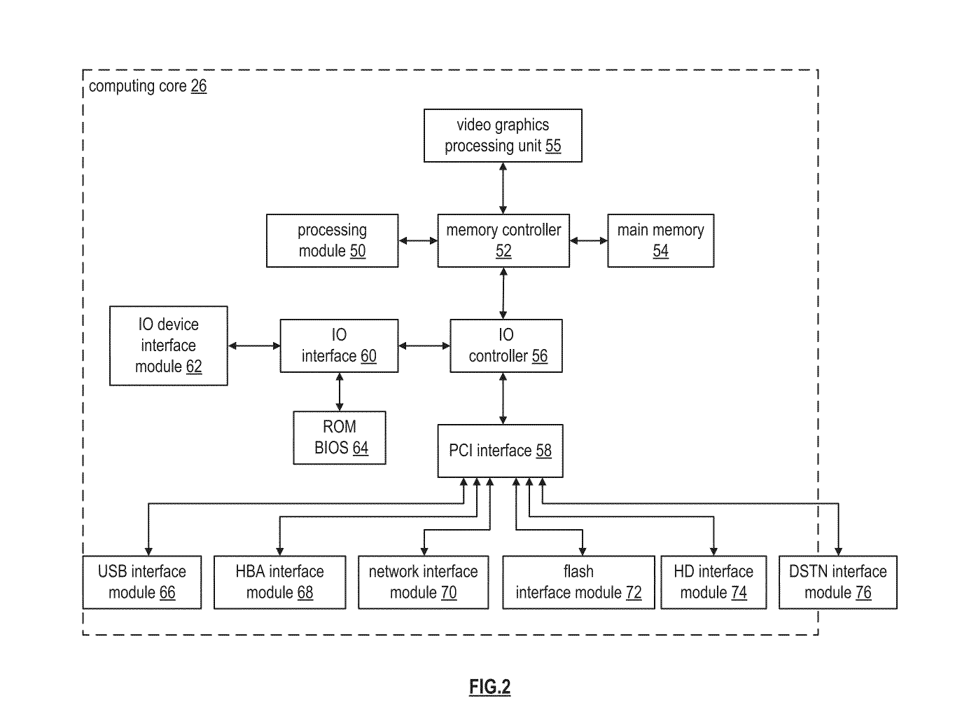

FIG. 2 is a schematic block diagram of an embodiment of a computing core 26 that includes a processing module 50, a memory controller 52, main memory 54, a video graphics processing unit 55, an input/output (IO) controller 56, a peripheral component interconnect (PCI) interface 58, an IO interface module 60, at least one IO device interface module 62, a read only memory (ROM) basic input output system (BIOS) 64, and one or more memory interface modules. The one or more memory interface module(s) includes one or more of a universal serial bus (USB) interface module 66, a host bus adapter (HBA) interface module 68, a network interface module 70, a flash interface module 72, a hard drive interface module 74, and a DSTN interface module 76.

The DSTN interface module 76 functions to mimic a conventional operating system (OS) file system interface (e.g., network file system (NFS), flash file system (FFS), disk file system (DFS), file transfer protocol (FTP), web-based distributed authoring and versioning (WebDAV), etc.) and/or a block memory interface (e.g., small computer system interface (SCSI), internet small computer system interface (iSCSI), etc.). The DSTN interface module 76 and/or the network interface module 70 may function as the interface 30 of the user device 14 of FIG. 1. Further note that the IO device interface module 62 and/or the memory interface modules may be collectively or individually referred to as IO ports.

FIG. 3 is a diagram of an example of the distributed computing system performing a distributed storage and task processing operation. The distributed computing system includes a DST (distributed storage and/or task) client module 34 (which may be in user device 14 and/or in DST processing unit 16 of FIG. 1), a network 24, a plurality of DST execution units 1-n that includes two or more DST execution units 36 of FIG. 1 (which form at least a portion of DSTN module 22 of FIG. 1), a DST managing module (not shown), and a DST integrity verification module (not shown). The DST client module 34 includes an outbound DST processing section 80 and an inbound DST processing section 82. Each of the DST execution units 1-n includes a controller 86, a processing module 84, memory 88, a DT (distributed task) execution module 90, and a DST client module 34.

In an example of operation, the DST client module 34 receives data 92 and one or more tasks 94 to be performed upon the data 92. The data 92 may be of any size and of any content, where, due to the size (e.g., greater than a few Terra-Bytes), the content (e.g., secure data, etc.), and/or task(s) (e.g., MIPS intensive), distributed processing of the task(s) on the data is desired. For example, the data 92 may be one or more digital books, a copy of a company's emails, a large-scale Internet search, a video security file, one or more entertainment video files (e.g., television programs, movies, etc.), data files, and/or any other large amount of data (e.g., greater than a few Terra-Bytes).

Within the DST client module 34, the outbound DST processing section 80 receives the data 92 and the task(s) 94. The outbound DST processing section 80 processes the data 92 to produce slice groupings 96. As an example of such processing, the outbound DST processing section 80 partitions the data 92 into a plurality of data partitions. For each data partition, the outbound DST processing section 80 dispersed storage (DS) error encodes the data partition to produce encoded data slices and groups the encoded data slices into a slice grouping 96. In addition, the outbound DST processing section 80 partitions the task 94 into partial tasks 98, where the number of partial tasks 98 may correspond to the number of slice groupings 96.

The outbound DST processing section 80 then sends, via the network 24, the slice groupings 96 and the partial tasks 98 to the DST execution units 1-n of the DSTN module 22 of FIG. 1. For example, the outbound DST processing section 80 sends slice group 1 and partial task 1 to DST execution unit 1. As another example, the outbound DST processing section 80 sends slice group #n and partial task #n to DST execution unit #n.

Each DST execution unit performs its partial task 98 upon its slice group 96 to produce partial results 102. For example, DST execution unit #1 performs partial task #1 on slice group #1 to produce a partial result #1, for results. As a more specific example, slice group #1 corresponds to a data partition of a series of digital books and the partial task #1 corresponds to searching for specific phrases, recording where the phrase is found, and establishing a phrase count. In this more specific example, the partial result #1 includes information as to where the phrase was found and includes the phrase count.

Upon completion of generating their respective partial results 102, the DST execution units send, via the network 24, their partial results 102 to the inbound DST processing section 82 of the DST client module 34. The inbound DST processing section 82 processes the received partial results 102 to produce a result 104. Continuing with the specific example of the preceding paragraph, the inbound DST processing section 82 combines the phrase count from each of the DST execution units 36 to produce a total phrase count. In addition, the inbound DST processing section 82 combines the ‘where the phrase was found’ information from each of the DST execution units 36 within their respective data partitions to produce ‘where the phrase was found’ information for the series of digital books.

In another example of operation, the DST client module 34 requests retrieval of stored data within the memory of the DST execution units 36 (e.g., memory of the DSTN module). In this example, the task 94 is retrieve data stored in the memory of the DSTN module. Accordingly, the outbound DST processing section 80 converts the task 94 into a plurality of partial tasks 98 and sends the partial tasks 98 to the respective DST execution units 1-n.

In response to the partial task 98 of retrieving stored data, a DST execution unit 36 identifies the corresponding encoded data slices 100 and retrieves them. For example, DST execution unit #1 receives partial task #1 and retrieves, in response thereto, retrieved slices #1. The DST execution units 36 send their respective retrieved slices 100 to the inbound DST processing section 82 via the network 24.

The inbound DST processing section 82 converts the retrieved slices 100 into data 92. For example, the inbound DST processing section 82 de-groups the retrieved slices 100 to produce encoded slices per data partition. The inbound DST processing section 82 then DS error decodes the encoded slices per data partition to produce data partitions. The inbound DST processing section 82 de-partitions the data partitions to recapture the data 92.

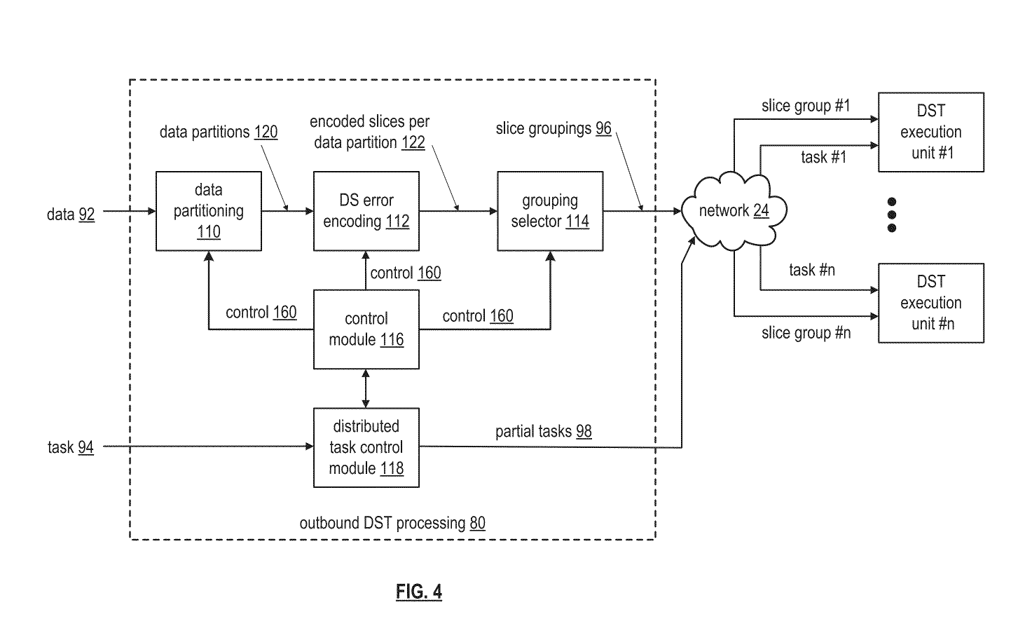

FIG. 4 is a schematic block diagram of an embodiment of an outbound distributed storage and/or task (DST) processing section 80 of a DST client module 34 FIG. 1 coupled to a DSTN module 22 of a FIG. 1 (e.g., a plurality of n DST execution units 36) via a network 24. The outbound DST processing section 80 includes a data partitioning module 110, a dispersed storage (DS) error encoding module 112, a grouping selector module 114, a control module 116, and a distributed task control module 118.

In an example of operation, the data partitioning module 110 partitions data 92 into a plurality of data partitions 120. The number of partitions and the size of the partitions may be selected by the control module 116 via control 160 based on the data 92 (e.g., its size, its content, etc.), a corresponding task 94 to be performed (e.g., simple, complex, single step, multiple steps, etc.), DS encoding parameters (e.g., pillar width, decode threshold, write threshold, segment security parameters, slice security parameters, etc.), capabilities of the DST execution units 36 (e.g., processing resources, availability of processing recourses, etc.), and/or as may be inputted by a user, system administrator, or other operator (human or automated). For example, the data partitioning module 110 partitions the data 92 (e.g., 100 Terra-Bytes) into 100,000 data segments, each being 1 Giga-Byte in size. Alternatively, the data partitioning module 110 partitions the data 92 into a plurality of data segments, where some of data segments are of a different size, are of the same size, or a combination thereof.

The DS error encoding module 112 receives the data partitions 120 in a serial manner, a parallel manner, and/or a combination thereof. For each data partition 120, the DS error encoding module 112 DS error encodes the data partition 120 in accordance with control information 160 from the control module 116 to produce encoded data slices 122. The DS error encoding includes segmenting the data partition into data segments, segment security processing (e.g., encryption, compression, watermarking, integrity check (e.g., CRC), etc.), error encoding, slicing, and/or per slice security processing (e.g., encryption, compression, watermarking, integrity check (e.g., CRC), etc.). The control information 160 indicates which steps of the DS error encoding are active for a given data partition and, for active steps, indicates the parameters for the step. For example, the control information 160 indicates that the error encoding is active and includes error encoding parameters (e.g., pillar width, decode threshold, write threshold, read threshold, type of error encoding, etc.).

The group selecting module 114 groups the encoded slices 122 of a data partition into a set of slice groupings 96. The number of slice groupings corresponds to the number of DST execution units 36 identified for a particular task 94. For example, if five DST execution units 36 are identified for the particular task 94, the group selecting module groups the encoded slices 122 of a data partition into five slice groupings 96. The group selecting module 114 outputs the slice groupings 96 to the corresponding DST execution units 36 via the network 24.

The distributed task control module 118 receives the task 94 and converts the task 94 into a set of partial tasks 98. For example, the distributed task control module 118 receives a task to find where in the data (e.g., a series of books) a phrase occurs and a total count of the phrase usage in the data. In this example, the distributed task control module 118 replicates the task 94 for each DST execution unit 36 to produce the partial tasks 98. In another example, the distributed task control module 118 receives a task to find where in the data a first phrase occurs, wherein in the data a second phrase occurs, and a total count for each phrase usage in the data. In this example, the distributed task control module 118 generates a first set of partial tasks 98 for finding and counting the first phase and a second set of partial tasks for finding and counting the second phrase. The distributed task control module 118 sends respective first and/or second partial tasks 98 to each DST execution unit 36.

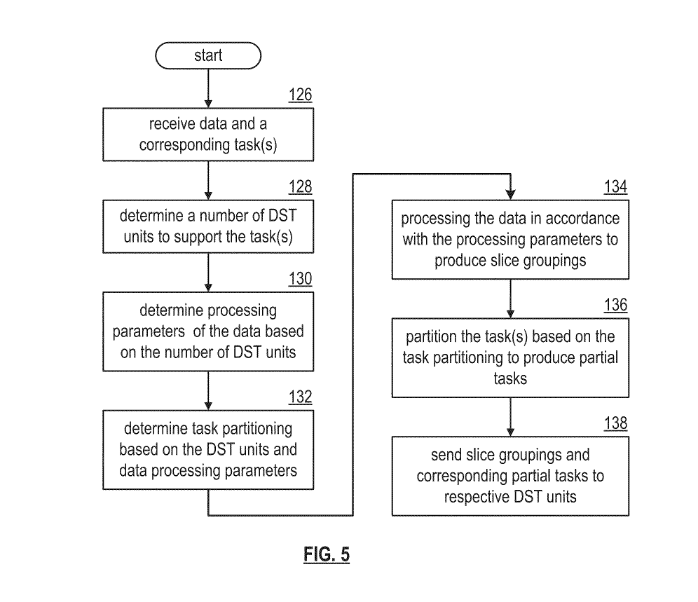

FIG. 5 is a logic diagram of an example of a method for outbound distributed storage and task (DST) processing that begins at step 126 where a DST client module receives data and one or more corresponding tasks. The method continues at step 128 where the DST client module determines a number of DST units to support the task for one or more data partitions. For example, the DST client module may determine the number of DST units to support the task based on the size of the data, the requested task, the content of the data, a predetermined number (e.g., user indicated, system administrator determined, etc.), available DST units, capability of the DST units, and/or any other factor regarding distributed task processing of the data. The DST client module may select the same DST units for each data partition, may select different DST units for the data partitions, or a combination thereof.

The method continues at step 130 where the DST client module determines processing parameters of the data based on the number of DST units selected for distributed task processing. The processing parameters include data partitioning information, DS encoding parameters, and/or slice grouping information. The data partitioning information includes a number of data partitions, size of each data partition, and/or organization of the data partitions (e.g., number of data blocks in a partition, the size of the data blocks, and arrangement of the data blocks). The DS encoding parameters include segmenting information, segment security information, error encoding information (e.g., dispersed storage error encoding function parameters including one or more of pillar width, decode threshold, write threshold, read threshold, generator matrix), slicing information, and/or per slice security information. The slice grouping information includes information regarding how to arrange the encoded data slices into groups for the selected DST units. As a specific example, if the DST client module determines that five DST units are needed to support the task, then it determines that the error encoding parameters include a pillar width of five and a decode threshold of three.

The method continues at step 132 where the DST client module determines task partitioning information (e.g., how to partition the tasks) based on the selected DST units and data processing parameters. The data processing parameters include the processing parameters and DST unit capability information. The DST unit capability information includes the number of DT (distributed task) execution units, execution capabilities of each DT execution unit (e.g., MIPS capabilities, processing resources (e.g., quantity and capability of microprocessors, CPUs, digital signal processors, co-processor, microcontrollers, arithmetic logic circuitry, and/or and the other analog and/or digital processing circuitry), availability of the processing resources, memory information (e.g., type, size, availability, etc.)), and/or any information germane to executing one or more tasks.

The method continues at step 134 where the DST client module processes the data in accordance with the processing parameters to produce slice groupings. The method continues at step 136 where the DST client module partitions the task based on the task partitioning information to produce a set of partial tasks. The method continues at step 138 where the DST client module sends the slice groupings and the corresponding partial tasks to respective DST units.

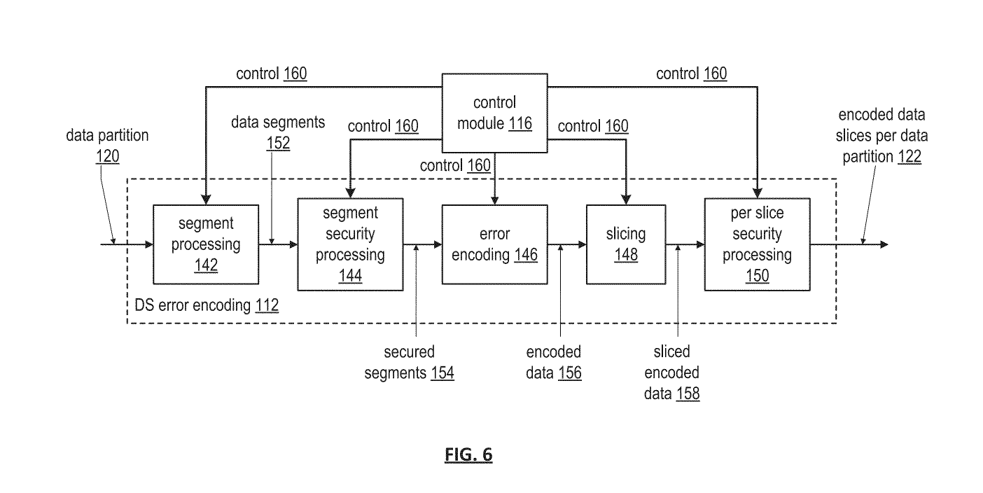

FIG. 6 is a schematic block diagram of an embodiment of the dispersed storage (DS) error encoding module 112 of an outbound distributed storage and task (DST) processing section. The DS error encoding module 112 includes a segment processing module 142, a segment security processing module 144, an error encoding module 146, a slicing module 148, and a per slice security processing module 150. Each of these modules is coupled to a control module 116 to receive control information 160 therefrom.

In an example of operation, the segment processing module 142 receives a data partition 120 from a data partitioning module and receives segmenting information as the control information 160 from the control module 116. The segmenting information indicates how the segment processing module 142 is to segment the data partition 120. For example, the segmenting information indicates how many rows to segment the data based on a decode threshold of an error encoding scheme, indicates how many columns to segment the data into based on a number and size of data blocks within the data partition 120, and indicates how many columns to include in a data segment 152. The segment processing module 142 segments the data 120 into data segments 152 in accordance with the segmenting information.

The segment security processing module 144, when enabled by the control module 116, secures the data segments 152 based on segment security information received as control information 160 from the control module 116. The segment security information includes data compression, encryption, watermarking, integrity check (e.g., cyclic redundancy check (CRC), etc.), and/or any other type of digital security. For example, when the segment security processing module 144 is enabled, it may compress a data segment 152, encrypt the compressed data segment, and generate a CRC value for the encrypted data segment to produce a secure data segment 154. When the segment security processing module 144 is not enabled, it passes the data segments 152 to the error encoding module 146 or is bypassed such that the data segments 152 are provided to the error encoding module 146.

The error encoding module 146 encodes the secure data segments 154 in accordance with error correction encoding parameters received as control information 160 from the control module 116. The error correction encoding parameters (e.g., also referred to as dispersed storage error coding parameters) include identifying an error correction encoding scheme (e.g., forward error correction algorithm, a Reed-Solomon based algorithm, an online coding algorithm, an information dispersal algorithm, etc.), a pillar width, a decode threshold, a read threshold, a write threshold, etc. For example, the error correction encoding parameters identify a specific error correction encoding scheme, specifies a pillar width of five, and specifies a decode threshold of three. From these parameters, the error encoding module 146 encodes a data segment 154 to produce an encoded data segment 156.

The slicing module 148 slices the encoded data segment 156 in accordance with the pillar width of the error correction encoding parameters received as control information 160. For example, if the pillar width is five, the slicing module 148 slices an encoded data segment 156 into a set of five encoded data slices. As such, for a plurality of data segments 156 for a given data partition, the slicing module outputs a plurality of sets of encoded data slices 158.

The per slice security processing module 150, when enabled by the control module 116, secures each encoded data slice 158 based on slice security information received as control information 160 from the control module 116. The slice security information includes data compression, encryption, watermarking, integrity check (e.g., CRC, etc.), and/or any other type of digital security. For example, when the per slice security processing module 150 is enabled, it compresses an encoded data slice 158, encrypts the compressed encoded data slice, and generates a CRC value for the encrypted encoded data slice to produce a secure encoded data slice 122. When the per slice security processing module 150 is not enabled, it passes the encoded data slices 158 or is bypassed such that the encoded data slices 158 are the output of the DS error encoding module 112. Note that the control module 116 may be omitted and each module stores its own parameters.

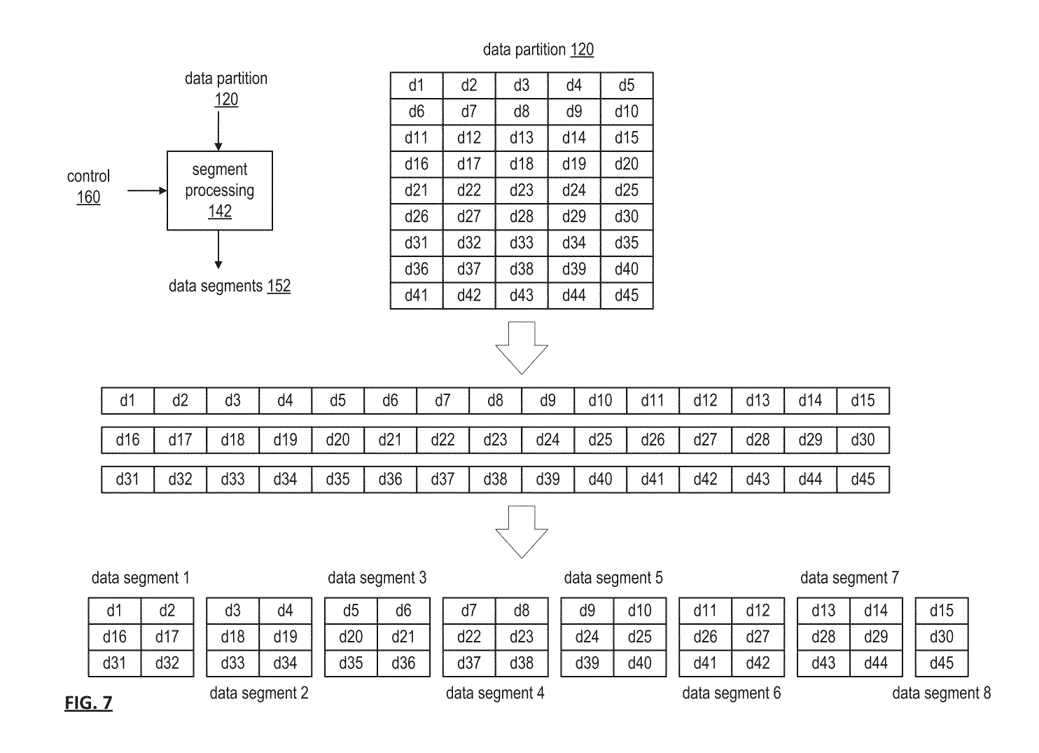

FIG. 7 is a diagram of an example of a segment processing of a dispersed storage (DS) error encoding module. In this example, a segment processing module 142 receives a data partition 120 that includes 45 data blocks (e.g., d1-d45), receives segmenting information (i.e., control information 160) from a control module, and segments the data partition 120 in accordance with the control information 160 to produce data segments 152. Each data block may be of the same size as other data blocks or of a different size. In addition, the size of each data block may be a few bytes to megabytes of data. As previously mentioned, the segmenting information indicates how many rows to segment the data partition into, indicates how many columns to segment the data partition into, and indicates how many columns to include in a data segment.

In this example, the decode threshold of the error encoding scheme is three; as such the number of rows to divide the data partition into is three. The number of columns for each row is set to 15, which is based on the number and size of data blocks. The data blocks of the data partition are arranged in rows and columns in a sequential order (i.e., the first row includes the first 15 data blocks; the second row includes the second 15 data blocks; and the third row includes the last 15 data blocks).

With the data blocks arranged into the desired sequential order, they are divided into data segments based on the segmenting information. In this example, the data partition is divided into 8 data segments; the first 7 include 2 columns of three rows and the last includes 1 column of three rows. Note that the first row of the 8 data segments is in sequential order of the first 15 data blocks; the second row of the 8 data segments in sequential order of the second 15 data blocks; and the third row of the 8 data segments in sequential order of the last 15 data blocks. Note that the number of data blocks, the grouping of the data blocks into segments, and size of the data blocks may vary to accommodate the desired distributed task processing function.

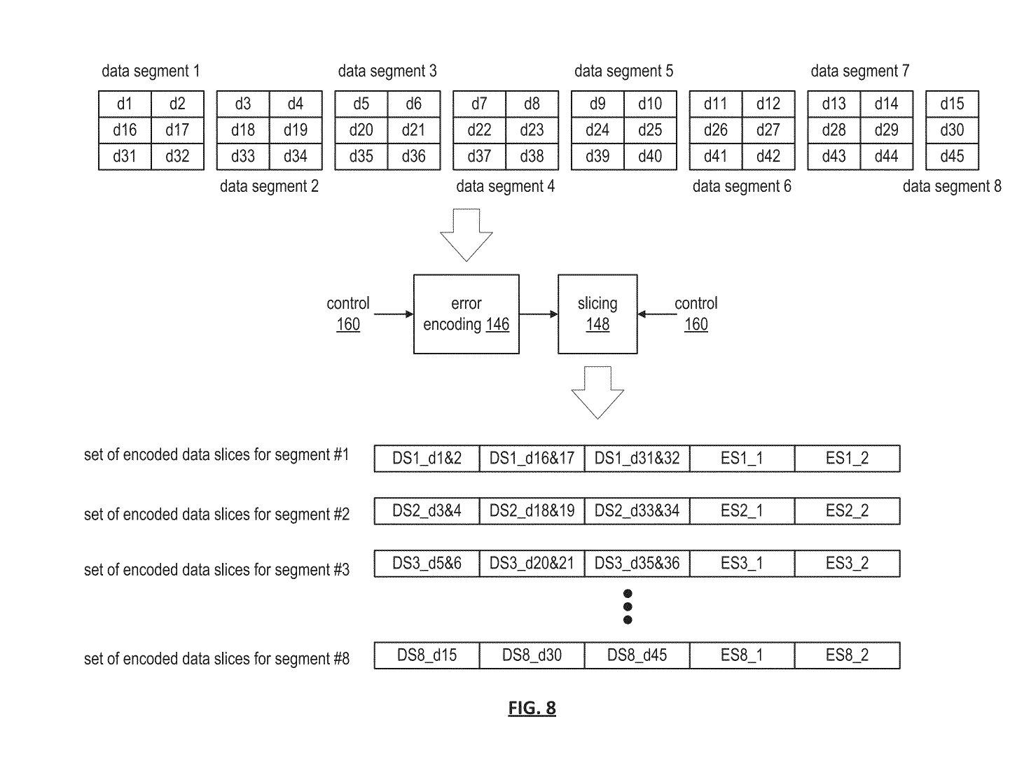

FIG. 8 is a diagram of an example of error encoding and slicing processing of the dispersed error encoding processing the data segments of FIG. 7. In this example, data segment 1 includes 3 rows with each row being treated as one word for encoding. As such, data segment 1 includes three words for encoding: word 1 including data blocks d1 and d2, word 2 including data blocks d16 and d17, and word 3 including data blocks d31 and d32. Each of data segments 2-7 includes three words where each word includes two data blocks. Data segment 8 includes three words where each word includes a single data block (e.g., d15, d30, and d45).

In operation, an error encoding module 146 and a slicing module 148 convert each data segment into a set of encoded data slices in accordance with error correction encoding parameters as control information 160. More specifically, when the error correction encoding parameters indicate a unity matrix Reed-Solomon based encoding algorithm, 5 pillars, and decode threshold of 3, the first three encoded data slices of the set of encoded data slices for a data segment are substantially similar to the corresponding word of the data segment. For instance, when the unity matrix Reed-Solomon based encoding algorithm is applied to data segment 1, the content of the first encoded data slice (DS1_d1&2) of the first set of encoded data slices (e.g., corresponding to data segment 1) is substantially similar to content of the first word (e.g., d1 & d2); the content of the second encoded data slice (DS1_d16&17) of the first set of encoded data slices is substantially similar to content of the second word (e.g., d16 & d17); and the content of the third encoded data slice (DS1_d31&32) of the first set of encoded data slices is substantially similar to content of the third word (e.g., d31 & d32).

The content of the fourth and fifth encoded data slices (e.g., ES1_{—}1 and ES1_{—}2) of the first set of encoded data slices include error correction data based on the first-third words of the first data segment. With such an encoding and slicing scheme, retrieving any three of the five encoded data slices allows the data segment to be accurately reconstructed.

The encoding and slices of data segments 2-7 yield sets of encoded data slices similar to the set of encoded data slices of data segment 1. For instance, the content of the first encoded data slice (DS2_d3&4) of the second set of encoded data slices (e.g., corresponding to data segment 2) is substantially similar to content of the first word (e.g., d3 & d4); the content of the second encoded data slice (DS2_d18&19) of the second set of encoded data slices is substantially similar to content of the second word (e.g., d18 & d19); and the content of the third encoded data slice (DS2_d33&34) of the second set of encoded data slices is substantially similar to content of the third word (e.g., d33 & d34). The content of the fourth and fifth encoded data slices (e.g., ES1_{—}1 and ES1_{—}2) of the second set of encoded data slices includes error correction data based on the first-third words of the second data segment.

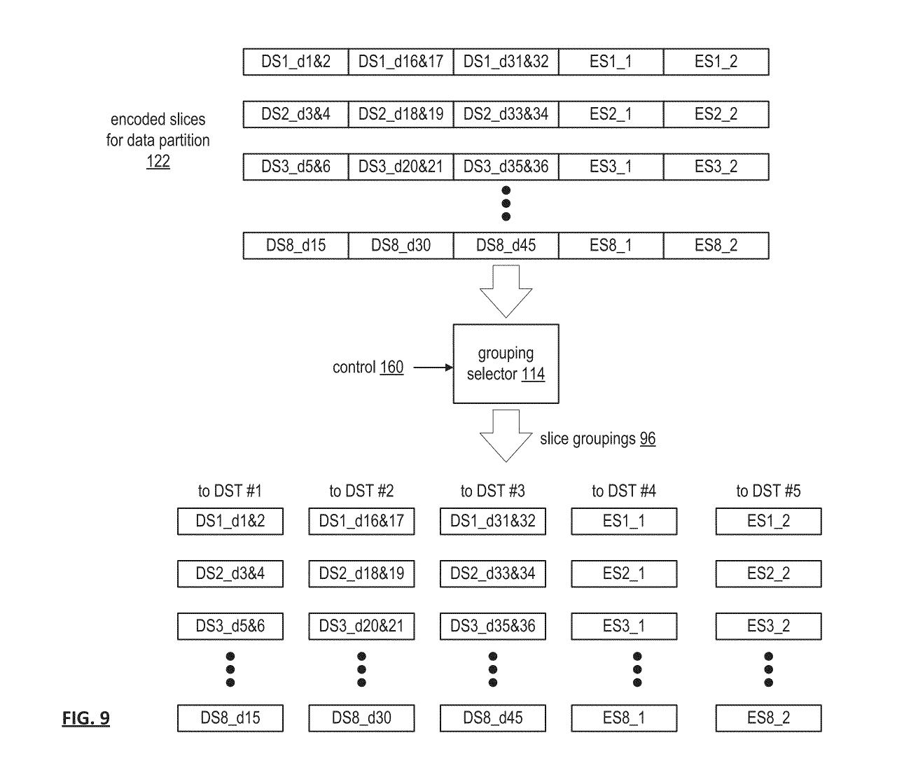

FIG. 9 is a diagram of an example of grouping selection processing of an outbound distributed storage and task (DST) processing in accordance with group selection information as control information 160 from a control module. Encoded slices for data partition 122 are grouped in accordance with the control information 160 to produce slice groupings 96. In this example, a grouping selection module 114 organizes the encoded data slices into five slice groupings (e.g., one for each DST execution unit of a distributed storage and task network (DSTN) module). As a specific example, the grouping selection module 114 creates a first slice grouping for a DST execution unit #1, which includes first encoded slices of each of the sets of encoded slices. As such, the first DST execution unit receives encoded data slices corresponding to data blocks 1-15 (e.g., encoded data slices of contiguous data).

The grouping selection module 114 also creates a second slice grouping for a DST execution unit #2, which includes second encoded slices of each of the sets of encoded slices. As such, the second DST execution unit receives encoded data slices corresponding to data blocks 16-30. The grouping selection module 114 further creates a third slice grouping for DST execution unit #3, which includes third encoded slices of each of the sets of encoded slices. As such, the third DST execution unit receives encoded data slices corresponding to data blocks 31-45.

The grouping selection module 114 creates a fourth slice grouping for DST execution unit #4, which includes fourth encoded slices of each of the sets of encoded slices. As such, the fourth DST execution unit receives encoded data slices corresponding to first error encoding information (e.g., encoded data slices of error coding (EC) data). The grouping selection module 114 further creates a fifth slice grouping for DST execution unit #5, which includes fifth encoded slices of each of the sets of encoded slices. As such, the fifth DST execution unit receives encoded data slices corresponding to second error encoding information.

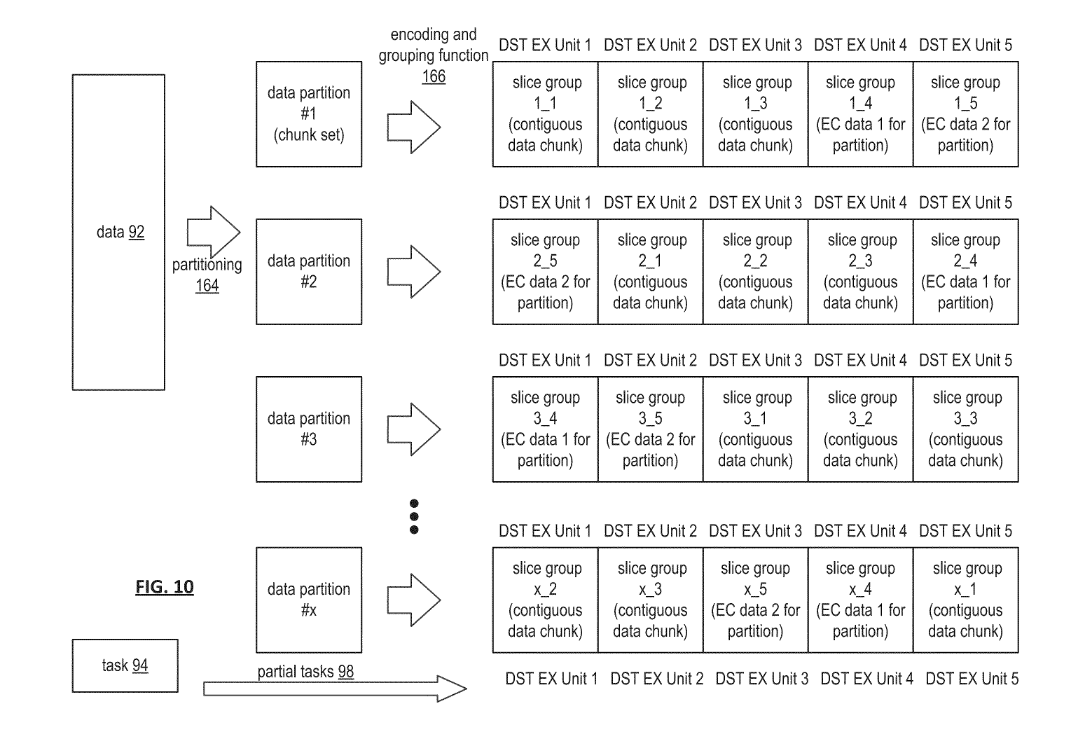

FIG. 10 is a diagram of an example of converting data 92 into slice groups that expands on the preceding figures. As shown, the data 92 is partitioned in accordance with a partitioning function 164 into a plurality of data partitions (1-x, where x is an integer greater than 4). Each data partition (or chunkset of data) is encoded and grouped into slice groupings as previously discussed by an encoding and grouping function 166. For a given data partition, the slice groupings are sent to distributed storage and task (DST) execution units. From data partition to data partition, the ordering of the slice groupings to the DST execution units may vary.

For example, the slice groupings of data partition #1 is sent to the DST execution units such that the first DST execution receives first encoded data slices of each of the sets of encoded data slices, which corresponds to a first continuous data chunk of the first data partition (e.g., refer to FIG. 9), a second DST execution receives second encoded data slices of each of the sets of encoded data slices, which corresponds to a second continuous data chunk of the first data partition, etc.

For the second data partition, the slice groupings may be sent to the DST execution units in a different order than it was done for the first data partition. For instance, the first slice grouping of the second data partition (e.g., slice group 2_{—}1) is sent to the second DST execution unit; the second slice grouping of the second data partition (e.g., slice group 2_{—}2) is sent to the third DST execution unit; the third slice grouping of the second data partition (e.g., slice group 2_{—}3) is sent to the fourth DST execution unit; the fourth slice grouping of the second data partition (e.g., slice group 2_{—}4, which includes first error coding information) is sent to the fifth DST execution unit; and the fifth slice grouping of the second data partition (e.g., slice group 2_{—}5, which includes second error coding information) is sent to the first DST execution unit.

The pattern of sending the slice groupings to the set of DST execution units may vary in a predicted pattern, a random pattern, and/or a combination thereof from data partition to data partition. In addition, from data partition to data partition, the set of DST execution units may change. For example, for the first data partition, DST execution units 1-5 may be used; for the second data partition, DST execution units 6-10 may be used; for the third data partition, DST execution units 3-7 may be used; etc. As is also shown, the task is divided into partial tasks that are sent to the DST execution units in conjunction with the slice groupings of the data partitions.

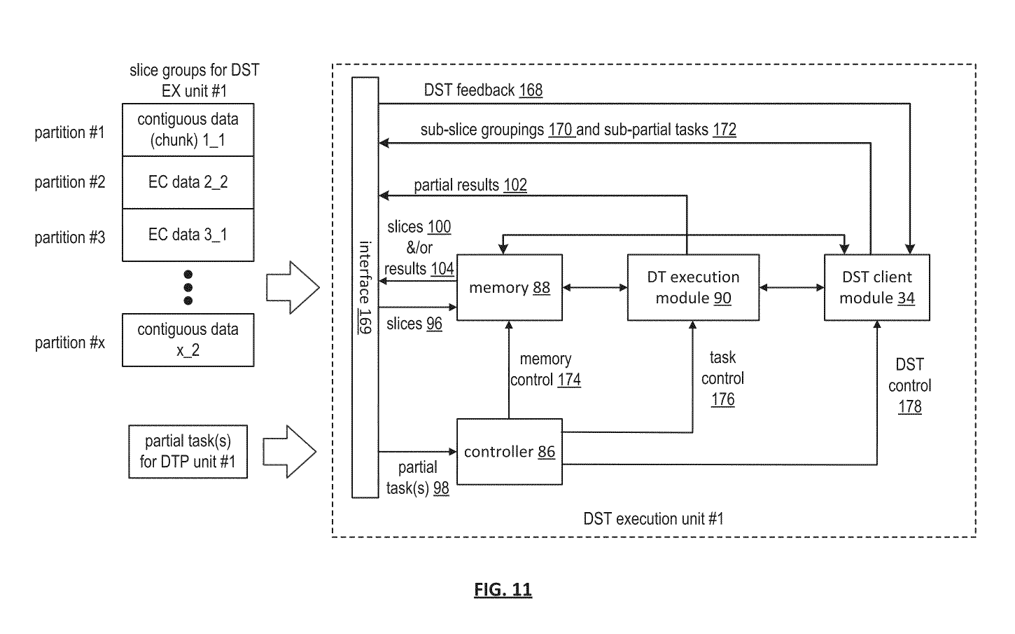

FIG. 11 is a schematic block diagram of an embodiment of a DST (distributed storage and/or task) execution unit that includes an interface 169, a controller 86, memory 88, one or more DT (distributed task) execution modules 90, and a DST client module 34. The memory 88 is of sufficient size to store a significant number of encoded data slices (e.g., thousands of slices to hundreds-of-millions of slices) and may include one or more hard drives and/or one or more solid-state memory devices (e.g., flash memory, DRAM, etc.).

In an example of storing a slice group, the DST execution module receives a slice grouping 96 (e.g., slice group #1) via interface 169. The slice grouping 96 includes, per partition, encoded data slices of contiguous data or encoded data slices of error coding (EC) data. For slice group #1, the DST execution module receives encoded data slices of contiguous data for partitions #1 and #x (and potentially others between 3 and x) and receives encoded data slices of EC data for partitions #2 and #3 (and potentially others between 3 and x). Examples of encoded data slices of contiguous data and encoded data slices of error coding (EC) data are discussed with reference to FIG. 9. The memory 88 stores the encoded data slices of slice groupings 96 in accordance with memory control information 174 it receives from the controller 86.

The controller 86 (e.g., a processing module, a CPU, etc.) generates the memory control information 174 based on a partial task(s) 98 and distributed computing information (e.g., user information (e.g., user ID, distributed computing permissions, data access permission, etc.), vault information (e.g., virtual memory assigned to user, user group, temporary storage for task processing, etc.), task validation information, etc.). For example, the controller 86 interprets the partial task(s) 98 in light of the distributed computing information to determine whether a requestor is authorized to perform the task 98, is authorized to access the data, and/or is authorized to perform the task on this particular data. When the requestor is authorized, the controller 86 determines, based on the task 98 and/or another input, whether the encoded data slices of the slice grouping 96 are to be temporarily stored or permanently stored. Based on the foregoing, the controller 86 generates the memory control information 174 to write the encoded data slices of the slice grouping 96 into the memory 88 and to indicate whether the slice grouping 96 is permanently stored or temporarily stored.

With the slice grouping 96 stored in the memory 88, the controller 86 facilitates execution of the partial task(s) 98. In an example, the controller 86 interprets the partial task 98 in light of the capabilities of the DT execution module(s) 90. The capabilities include one or more of MIPS capabilities, processing resources (e.g., quantity and capability of microprocessors, CPUs, digital signal processors, co-processor, microcontrollers, arithmetic logic circuitry, and/or and the other analog and/or digital processing circuitry), availability of the processing resources, etc. If the controller 86 determines that the DT execution module(s) 90 have sufficient capabilities, it generates task control information 176.

The task control information 176 may be a generic instruction (e.g., perform the task on the stored slice grouping) or a series of operational codes. In the former instance, the DT execution module 90 includes a co-processor function specifically configured (fixed or programmed) to perform the desired task 98. In the latter instance, the DT execution module 90 includes a general processor topology where the controller stores an algorithm corresponding to the particular task 98. In this instance, the controller 86 provides the operational codes (e.g., assembly language, source code of a programming language, object code, etc.) of the algorithm to the DT execution module 90 for execution.

Depending on the nature of the task 98, the DT execution module 90 may generate intermediate partial results 102 that are stored in the memory 88 or in a cache memory (not shown) within the DT execution module 90. In either case, when the DT execution module 90 completes execution of the partial task 98, it outputs one or more partial results 102. The partial results may 102 also be stored in memory 88.

If, when the controller 86 is interpreting whether capabilities of the DT execution module(s) 90 can support the partial task 98, the controller 86 determines that the DT execution module(s) 90 cannot adequately support the task 98 (e.g., does not have the right resources, does not have sufficient available resources, available resources would be too slow, etc.), it then determines whether the partial task 98 should be fully offloaded or partially offloaded.

If the controller 86 determines that the partial task 98 should be fully offloaded, it generates DST control information 178 and provides it to the DST client module 34. The DST control information 178 includes the partial task 98, memory storage information regarding the slice grouping 96, and distribution instructions. The distribution instructions instruct the DST client module 34 to divide the partial task 98 into sub-partial tasks 172, to divide the slice grouping 96 into sub-slice groupings 170, and identity of other DST execution units. The DST client module 34 functions in a similar manner as the DST client module 34 of FIGS. 3-10 to produce the sub-partial tasks 172 and the sub-slice groupings 170 in accordance with the distribution instructions.

The DST client module 34 receives DST feedback 168 (e.g., sub-partial results), via the interface 169, from the DST execution units to which the task was offloaded. The DST client module 34 provides the sub-partial results to the DST execution unit, which processes the sub-partial results to produce the partial result(s) 102.

If the controller 86 determines that the partial task 98 should be partially offloaded, it determines what portion of the task 98 and/or slice grouping 96 should be processed locally and what should be offloaded. For the portion that is being locally processed, the controller 86 generates task control information 176 as previously discussed. For the portion that is being offloaded, the controller 86 generates DST control information 178 as previously discussed.

When the DST client module 34 receives DST feedback 168 (e.g., sub-partial results) from the DST executions units to which a portion of the task was offloaded, it provides the sub-partial results to the DT execution module 90. The DT execution module 90 processes the sub-partial results with the sub-partial results it created to produce the partial result(s) 102.

The memory 88 may be further utilized to retrieve one or more of stored slices 100, stored results 104, partial results 102 when the DT execution module 90 stores partial results 102 and/or results 104 and the memory 88. For example, when the partial task 98 includes a retrieval request, the controller 86 outputs the memory control 174 to the memory 88 to facilitate retrieval of slices 100 and/or results 104.

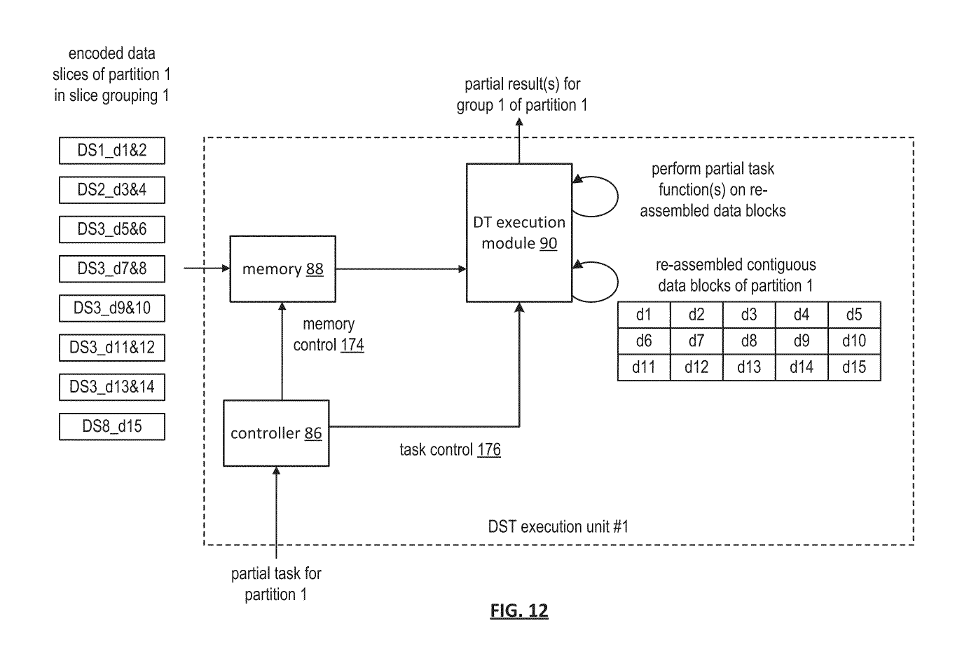

FIG. 12 is a schematic block diagram of an example of operation of a distributed storage and task (DST) execution unit storing encoded data slices and executing a task thereon. To store the encoded data slices of a partition 1 of slice grouping 1, a controller 86 generates write commands as memory control information 174 such that the encoded slices are stored in desired locations (e.g., permanent or temporary) within memory 88.

Once the encoded slices are stored, the controller 86 provides task control information 176 to a distributed task (DT) execution module 90. As a first step executing the task in accordance with the task control information 176, the DT execution module 90 retrieves the encoded slices from memory 88. The DT execution module 90 then reconstructs contiguous data blocks of a data partition. As shown for this example, reconstructed contiguous data blocks of data partition 1 include data blocks 1-15 (e.g., d1-d15).

With the contiguous data blocks reconstructed, the DT execution module 90 performs the task on the reconstructed contiguous data blocks. For example, the task may be to search the reconstructed contiguous data blocks for a particular word or phrase, identify where in the reconstructed contiguous data blocks the particular word or phrase occurred, and/or count the occurrences of the particular word or phrase on the reconstructed contiguous data blocks. The DST execution unit continues in a similar manner for the encoded data slices of other partitions in slice grouping 1. Note that with using the unity matrix error encoding scheme previously discussed, if the encoded data slices of contiguous data are uncorrupted, the decoding of them is a relatively straightforward process of extracting the data.

If, however, an encoded data slice of contiguous data is corrupted (or missing), it can be rebuilt by accessing other DST execution units that are storing the other encoded data slices of the set of encoded data slices of the corrupted encoded data slice. In this instance, the DST execution unit having the corrupted encoded data slices retrieves at least three encoded data slices (of contiguous data and of error coding data) in the set from the other DST execution units (recall for this example, the pillar width is 5 and the decode threshold is 3). The DST execution unit decodes the retrieved data slices using the DS error encoding parameters to recapture the corresponding data segment. The DST execution unit then re-encodes the data segment using the DS error encoding parameters to rebuild the corrupted encoded data slice. Once the encoded data slice is rebuilt, the DST execution unit functions as previously described.

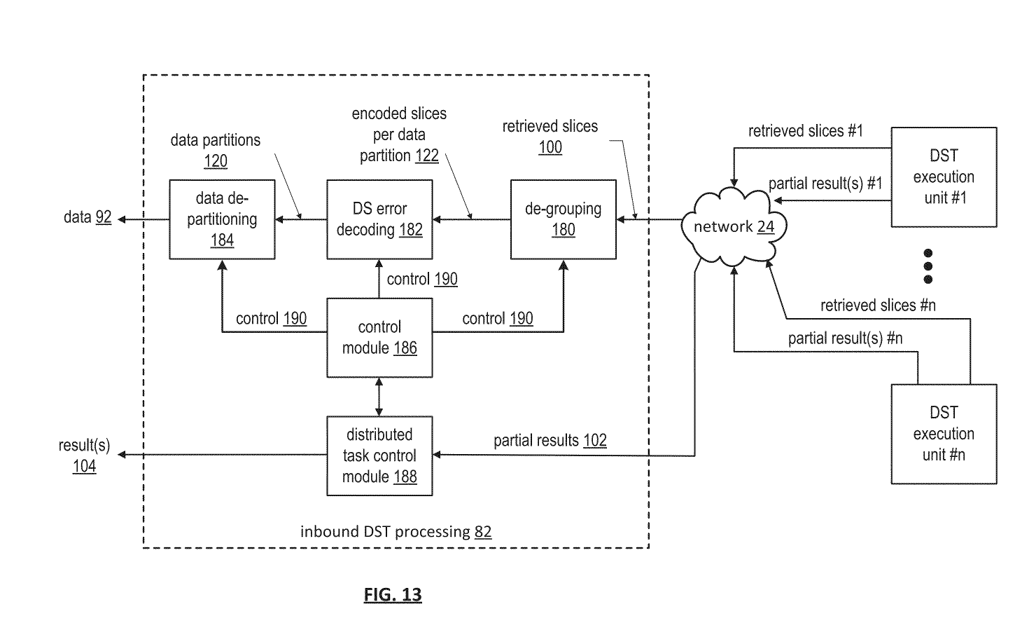

FIG. 13 is a schematic block diagram of an embodiment of an inbound distributed storage and/or task (DST) processing section 82 of a DST client module coupled to DST execution units of a distributed storage and task network (DSTN) module via a network 24. The inbound DST processing section 82 includes a de-grouping module 180, a DS (dispersed storage) error decoding module 182, a data de-partitioning module 184, a control module 186, and a distributed task control module 188. Note that the control module 186 and/or the distributed task control module 188 may be separate modules from corresponding ones of outbound DST processing section or may be the same modules.

In an example of operation, the DST execution units have completed execution of corresponding partial tasks on the corresponding slice groupings to produce partial results 102. The inbounded DST processing section 82 receives the partial results 102 via the distributed task control module 188. The inbound DST processing section 82 then processes the partial results 102 to produce a final result, or results 104. For example, if the task was to find a specific word or phrase within data, the partial results 102 indicate where in each of the prescribed portions of the data the corresponding DST execution units found the specific word or phrase. The distributed task control module 188 combines the individual partial results 102 for the corresponding portions of the data into a final result 104 for the data as a whole.

In another example of operation, the inbound DST processing section 82 is retrieving stored data from the DST execution units (i.e., the DSTN module). In this example, the DST execution units output encoded data slices 100 corresponding to the data retrieval requests. The de-grouping module 180 receives retrieved slices 100 and de-groups them to produce encoded data slices per data partition 122. The DS error decoding module 182 decodes, in accordance with DS error encoding parameters, the encoded data slices per data partition 122 to produce data partitions 120.

The data de-partitioning module 184 combines the data partitions 120 into the data 92. The control module 186 controls the conversion of retrieve slices 100 into the data 92 using control signals 190 to each of the modules. For instance, the control module 186 provides de-grouping information to the de-grouping module 180, provides the DS error encoding parameters to the DS error decoding module 182, and provides de-partitioning information to the data de-partitioning module 184.

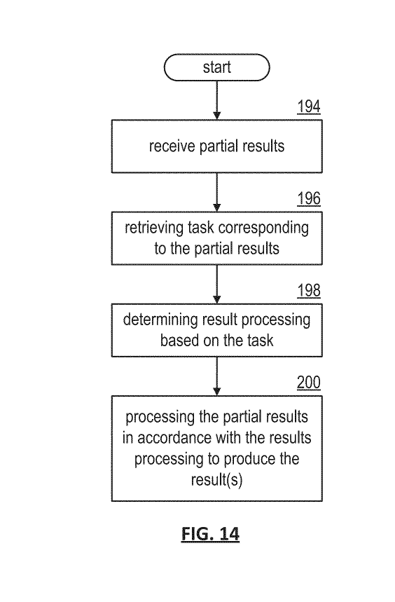

FIG. 14 is a logic diagram of an example of a method that is executable by distributed storage and task (DST) client module regarding inbound DST processing. The method begins at step 194 where the DST client module receives partial results. The method continues at step 196 where the DST client module retrieves the task corresponding to the partial results. For example, the partial results include header information that identifies the requesting entity, which correlates to the requested task.

The method continues at step 198 where the DST client module determines result processing information based on the task. For example, if the task were to identify a particular word or phrase within the data, the result processing information would indicate to aggregate the partial results for the corresponding portions of the data to produce the final result. As another example, if the task were to count the occurrences of a particular word or phrase within the data, results of processing the information would indicate to add the partial results to produce the final results. The method continues at step 200 where the DST client module processes the partial results in accordance with the result processing information to produce the final result or results.

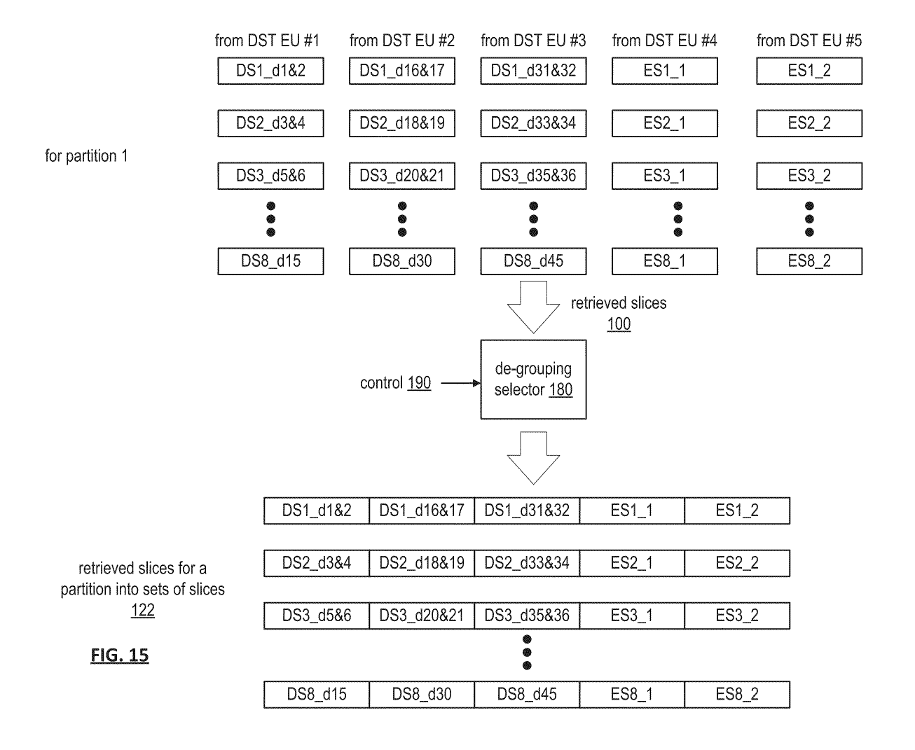

FIG. 15 is a diagram of an example of de-grouping selection processing of an inbound distributed storage and task (DST) processing section of a DST client module. In general, this is an inverse process of the grouping module of the outbound DST processing section of FIG. 9. Accordingly, for each data partition (e.g., partition #1), the de-grouping module retrieves the corresponding slice grouping from the DST execution units (EU) (e.g., DST 1-5).

As shown, DST execution unit #1 provides a first slice grouping, which includes the first encoded slices of each of the sets of encoded slices (e.g., encoded data slices of contiguous data of data blocks 1-15); DST execution unit #2 provides a second slice grouping, which includes the second encoded slices of each of the sets of encoded slices (e.g., encoded data slices of contiguous data of data blocks 16-30); DST execution unit #3 provides a third slice grouping, which includes the third encoded slices of each of the sets of encoded slices (e.g., encoded data slices of contiguous data of data blocks 31-45); DST execution unit #4 provides a fourth slice grouping, which includes the fourth encoded slices of each of the sets of encoded slices (e.g., first encoded data slices of error coding (EC) data); and DST execution unit #5 provides a fifth slice grouping, which includes the fifth encoded slices of each of the sets of encoded slices (e.g., first encoded data slices of error coding (EC) data).

The de-grouping module de-groups the slice groupings (e.g., received slices 100) using a de-grouping selector 180 controlled by a control signal 190 as shown in the example to produce a plurality of sets of encoded data slices (e.g., retrieved slices for a partition into sets of slices 122). Each set corresponding to a data segment of the data partition.

FIG. 16 is a schematic block diagram of an embodiment of a dispersed storage (DS) error decoding module 182 of an inbound distributed storage and task (DST) processing section. The DS error decoding module 182 includes an inverse per slice security processing module 202, a de-slicing module 204, an error decoding module 206, an inverse segment security module 208, a de-segmenting processing module 210, and a control module 186.

In an example of operation, the inverse per slice security processing module 202, when enabled by the control module 186, unsecures each encoded data slice 122 based on slice de-security information received as control information 190 (e.g., the compliment of the slice security information discussed with reference to FIG. 6) received from the control module 186. The slice security information includes data decompression, decryption, de-watermarking, integrity check (e.g., CRC verification, etc.), and/or any other type of digital security. For example, when the inverse per slice security processing module 202 is enabled, it verifies integrity information (e.g., a CRC value) of each encoded data slice 122, it decrypts each verified encoded data slice, and decompresses each decrypted encoded data slice to produce slice encoded data 158. When the inverse per slice security processing module 202 is not enabled, it passes the encoded data slices 122 as the sliced encoded data 158 or is bypassed such that the retrieved encoded data slices 122 are provided as the sliced encoded data 158.

The de-slicing module 204 de-slices the sliced encoded data 158 into encoded data segments 156 in accordance with a pillar width of the error correction encoding parameters received as control information 190 from the control module 186. For example, if the pillar width is five, the de-slicing module 204 de-slices a set of five encoded data slices into an encoded data segment 156. The error decoding module 206 decodes the encoded data segments 156 in accordance with error correction decoding parameters received as control information 190 from the control module 186 to produce secure data segments 154. The error correction decoding parameters include identifying an error correction encoding scheme (e.g., forward error correction algorithm, a Reed-Solomon based algorithm, an information dispersal algorithm, etc.), a pillar width, a decode threshold, a read threshold, a write threshold, etc. For example, the error correction decoding parameters identify a specific error correction encoding scheme, specify a pillar width of five, and specify a decode threshold of three.

The inverse segment security processing module 208, when enabled by the control module 186, unsecures the secured data segments 154 based on segment security information received as control information 190 from the control module 186. The segment security information includes data decompression, decryption, de-watermarking, integrity check (e.g., CRC, etc.) verification, and/or any other type of digital security. For example, when the inverse segment security processing module 208 is enabled, it verifies integrity information (e.g., a CRC value) of each secure data segment 154, it decrypts each verified secured data segment, and decompresses each decrypted secure data segment to produce a data segment 152. When the inverse segment security processing module 208 is not enabled, it passes the decoded data segment 154 as the data segment 152 or is bypassed.

The de-segment processing module 210 receives the data segments 152 and receives de-segmenting information as control information 190 from the control module 186. The de-segmenting information indicates how the de-segment processing module 210 is to de-segment the data segments 152 into a data partition 120. For example, the de-segmenting information indicates how the rows and columns of data segments are to be rearranged to yield the data partition 120.

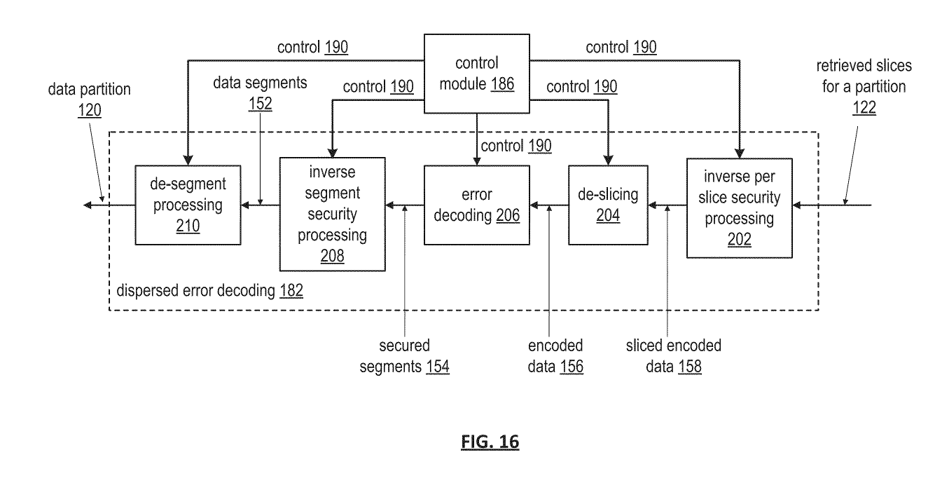

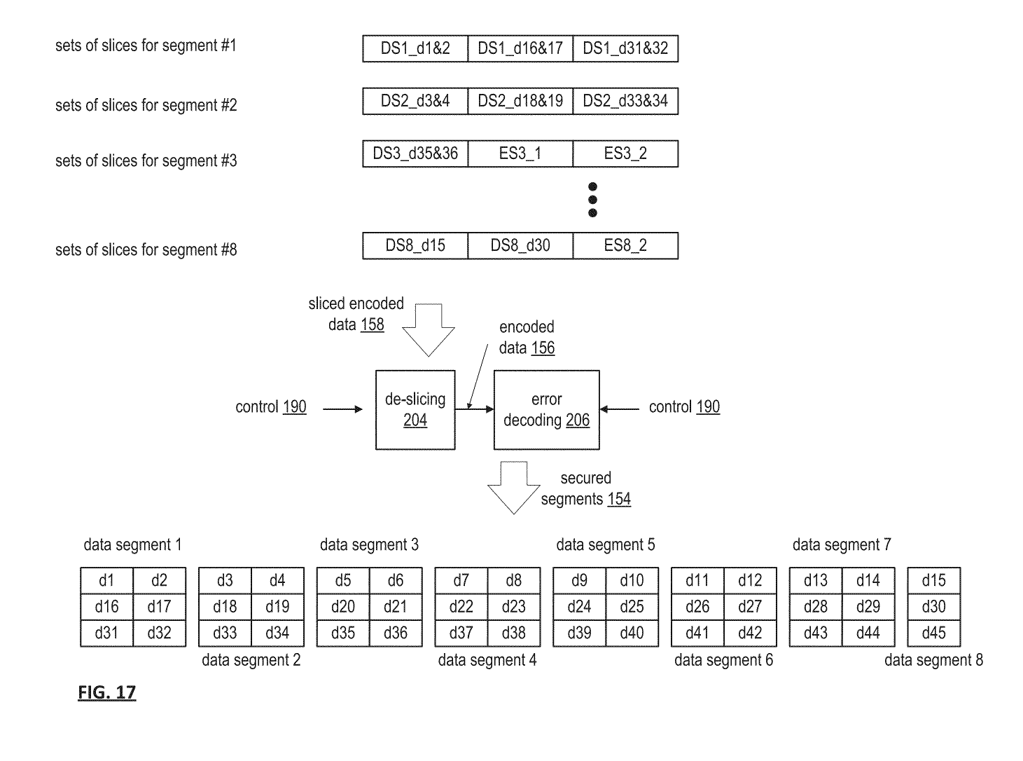

FIG. 17 is a diagram of an example of de-slicing and error decoding processing of a dispersed error decoding module. A de-slicing module 204 receives at least a decode threshold number of encoded data slices 158 for each data segment in accordance with control information 190 and provides encoded data 156. In this example, a decode threshold is three. As such, each set of encoded data slices 158 is shown to have three encoded data slices per data segment. The de-slicing module 204 may receive three encoded data slices per data segment because an associated distributed storage and task (DST) client module requested retrieving only three encoded data slices per segment or selected three of the retrieved encoded data slices per data segment. As shown, which is based on the unity matrix encoding previously discussed with reference to FIG. 8, an encoded data slice may be a data-based encoded data slice (e.g., DS1_d1&d2) or an error code based encoded data slice (e.g., ES3_{—}1).

An error decoding module 206 decodes the encoded data 156 of each data segment in accordance with the error correction decoding parameters of control information 190 to produce secured segments 154. In this example, data segment 1 includes 3 rows with each row being treated as one word for encoding. As such, data segment 1 includes three words: word 1 including data blocks d1 and d2, word 2 including data blocks d16 and d17, and word 3 including data blocks d31 and d32. Each of data segments 2-7 includes three words where each word includes two data blocks. Data segment 8 includes three words where each word includes a single data block (e.g., d15, d30, and d45).

FIG. 18 is a diagram of an example of a de-segment processing of an inbound distributed storage and task (DST) processing. In this example, a de-segment processing module 210 receives data segments 152 (e.g., 1-8) and rearranges the data blocks of the data segments into rows and columns in accordance with de-segmenting information of control information 190 to produce a data partition 120. Note that the number of rows is based on the decode threshold (e.g., 3 in this specific example) and the number of columns is based on the number and size of the data blocks.

The de-segmenting module 210 converts the rows and columns of data blocks into the data partition 120. Note that each data block may be of the same size as other data blocks or of a different size. In addition, the size of each data block may be a few bytes to megabytes of data.

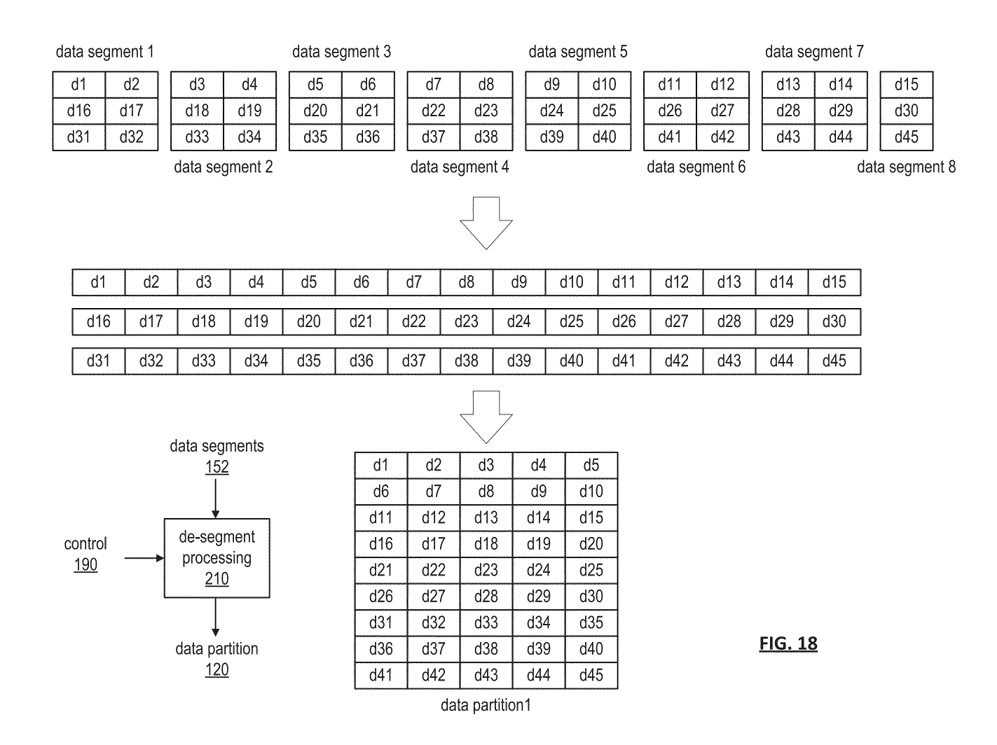

FIG. 19 is a diagram of an example of converting slice groups into data 92 within an inbound distributed storage and task (DST) processing section. As shown, the data 92 is reconstructed from a plurality of data partitions (1-x, where x is an integer greater than 4). Each data partition (or chunk set of data) is decoded and re-grouped using a de-grouping and decoding function 212 and a de-partition function 214 from slice groupings as previously discussed. For a given data partition, the slice groupings (e.g., at least a decode threshold per data segment of encoded data slices) are received from DST execution units. From data partition to data partition, the ordering of the slice groupings received from the DST execution units may vary as discussed with reference to FIG. 10.

FIG. 20 is a diagram of an example of a distributed storage and/or retrieval within the distributed computing system. The distributed computing system includes a plurality of distributed storage and/or task (DST) processing client modules 34 (one shown) coupled to a distributed storage and/or task processing network (DSTN) module, or multiple DSTN modules, via a network 24. The DST client module 34 includes an outbound DST processing section 80 and an inbound DST processing section 82. The DSTN module includes a plurality of DST execution units. Each DST execution unit includes a controller 86, memory 88, one or more distributed task (DT) execution modules 90, and a DST client module 34.

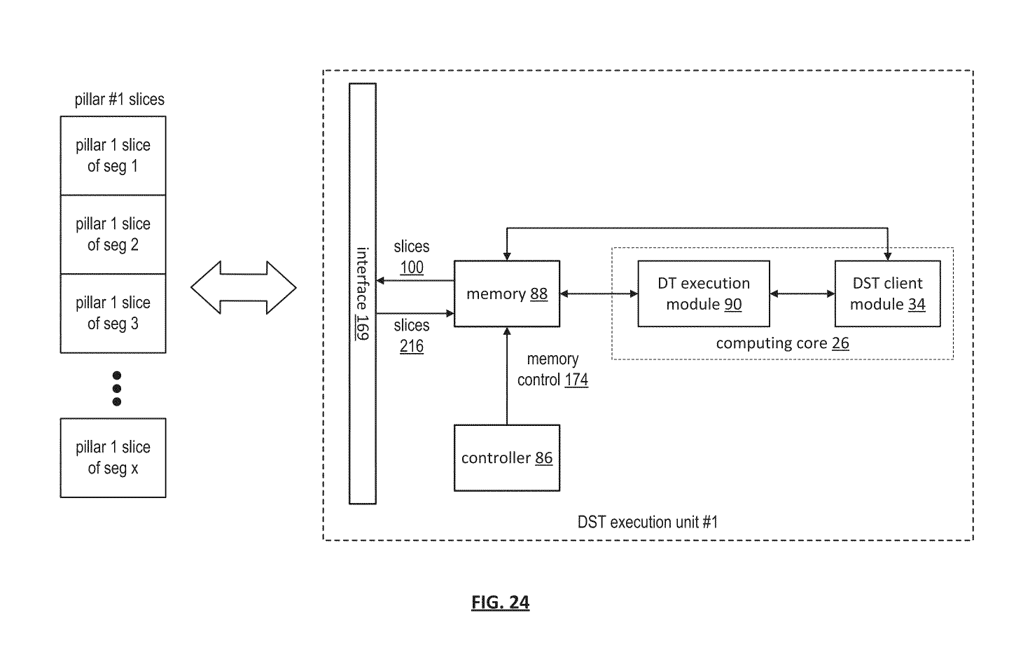

In an example of data storage, the DST client module 34 has data 92 that it desires to store in the DSTN module. The data 92 may be a file (e.g., video, audio, text, graphics, etc.), a data object, a data block, an update to a file, an update to a data block, etc. In this instance, the outbound DST processing module 80 converts the data 92 into encoded data slices 216 as will be further described with reference to FIGS. 21-23. The outbound DST processing module 80 sends, via the network 24, to the DST execution units for storage as further described with reference to FIG. 24.

In an example of data retrieval, the DST client module 34 issues a retrieve request to the DST execution units for the desired data 92. The retrieve request may address each DST executions units storing encoded data slices of the desired data, address a decode threshold number of DST execution units, address a read threshold number of DST execution units, or address some other number of DST execution units. In response to the request, each addressed DST execution unit retrieves its encoded data slices 100 of the desired data and sends them to the inbound DST processing section 82, via the network 24.

When, for each data segment, the inbound DST processing section 82 receives at least a decode threshold number of encoded data slices 100, it converts the encoded data slices 100 into a data segment. The inbound DST processing section 82 aggregates the data segments to produce the retrieved data 92.

FIG. 21 is a schematic block diagram of an embodiment of an outbound distributed storage and/or task (DST) processing section 80 of a DST client module coupled to a distributed storage and task network (DSTN) module (e.g., a plurality of DST execution units) via a network 24. The outbound DST processing section 80 includes a data partitioning module 110, a dispersed storage (DS) error encoding module 112, a group selection module 114, a control module 116, and a distributed task control module 118.

In an example of operation, the data partitioning module 110 is by-passed such that data 92 is provided directly to the DS error encoding module 112. The control module 116 coordinates the by-passing of the data partitioning module 110 by outputting a bypass 220 message to the data partitioning module 110.

The DS error encoding module 112 receives the data 92 in a serial manner, a parallel manner, and/or a combination thereof. The DS error encoding module 112 DS error encodes the data in accordance with control information 160 from the control module 116 to produce encoded data slices 218. The DS error encoding includes segmenting the data 92 into data segments, segment security processing (e.g., encryption, compression, watermarking, integrity check (e.g., CRC, etc.)), error encoding, slicing, and/or per slice security processing (e.g., encryption, compression, watermarking, integrity check (e.g., CRC, etc.)). The control information 160 indicates which steps of the DS error encoding are active for the data 92 and, for active steps, indicates the parameters for the step. For example, the control information 160 indicates that the error encoding is active and includes error encoding parameters (e.g., pillar width, decode threshold, write threshold, read threshold, type of error encoding, etc.).

The group selecting module 114 groups the encoded slices 218 of the data segments into pillars of slices 216. The number of pillars corresponds to the pillar width of the DS error encoding parameters. In this example, the distributed task control module 118 facilitates the storage request.

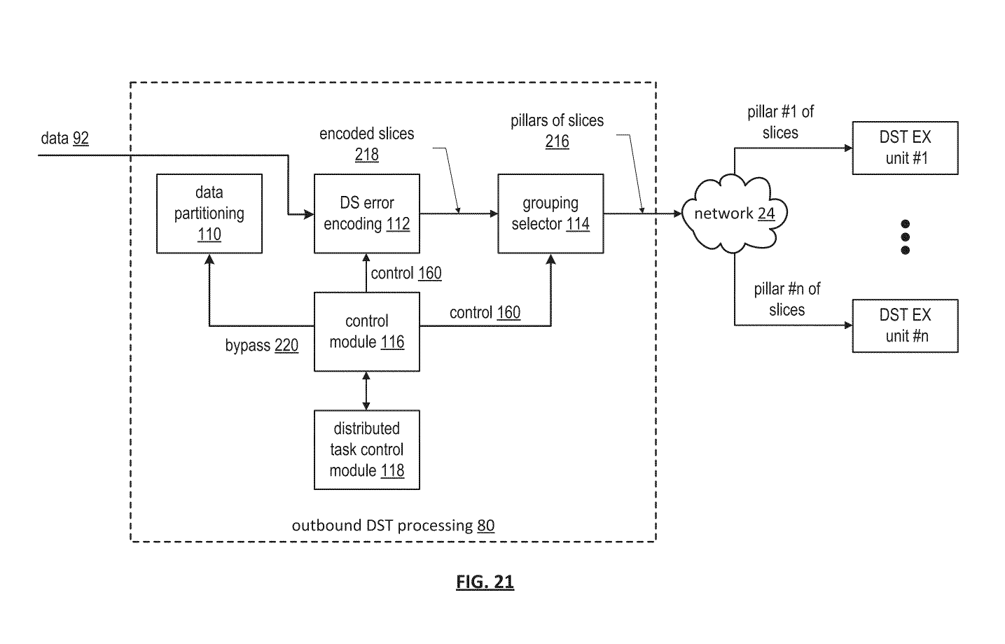

FIG. 22 is a schematic block diagram of an example of a dispersed storage (DS) error encoding module 112 for the example of FIG. 21. The DS error encoding module 112 includes a segment processing module 142, a segment security processing module 144, an error encoding module 146, a slicing module 148, and a per slice security processing module 150. Each of these modules is coupled to a control module 116 to receive control information 160 therefrom.

In an example of operation, the segment processing module 142 receives data 92 and receives segmenting information as control information 160 from the control module 116. The segmenting information indicates how the segment processing module is to segment the data. For example, the segmenting information indicates the size of each data segment. The segment processing module 142 segments the data 92 into data segments 152 in accordance with the segmenting information.

The segment security processing module 144, when enabled by the control module 116, secures the data segments 152 based on segment security information received as control information 160 from the control module 116. The segment security information includes data compression, encryption, watermarking, integrity check (e.g., CRC, etc.), and/or any other type of digital security. For example, when the segment security processing module 144 is enabled, it compresses a data segment 152, encrypts the compressed data segment, and generates a CRC value for the encrypted data segment to produce a secure data segment. When the segment security processing module 144 is not enabled, it passes the data segments 152 to the error encoding module 146 or is bypassed such that the data segments 152 are provided to the error encoding module 146.

The error encoding module 146 encodes the secure data segments in accordance with error correction encoding parameters received as control information 160 from the control module 116. The error correction encoding parameters include identifying an error correction encoding scheme (e.g., forward error correction algorithm, a Reed-Solomon based algorithm, an information dispersal algorithm, etc.), a pillar width, a decode threshold, a read threshold, a write threshold, etc. For example, the error correction encoding parameters identify a specific error correction encoding scheme, specifies a pillar width of five, and specifies a decode threshold of three. From these parameters, the error encoding module 146 encodes a data segment to produce an encoded data segment.

The slicing module 148 slices the encoded data segment in accordance with a pillar width of the error correction encoding parameters. For example, if the pillar width is five, the slicing module slices an encoded data segment into a set of five encoded data slices. As such, for a plurality of data segments, the slicing module 148 outputs a plurality of sets of encoded data slices as shown within encoding and slicing function 222 as described.

The per slice security processing module 150, when enabled by the control module 116, secures each encoded data slice based on slice security information received as control information 160 from the control module 116. The slice security information includes data compression, encryption, watermarking, integrity check (e.g., CRC, etc.), and/or any other type of digital security. For example, when the per slice security processing module 150 is enabled, it may compress an encoded data slice, encrypt the compressed encoded data slice, and generate a CRC value for the encrypted encoded data slice to produce a secure encoded data slice tweaking. When the per slice security processing module 150 is not enabled, it passes the encoded data slices or is bypassed such that the encoded data slices 218 are the output of the DS error encoding module 112.

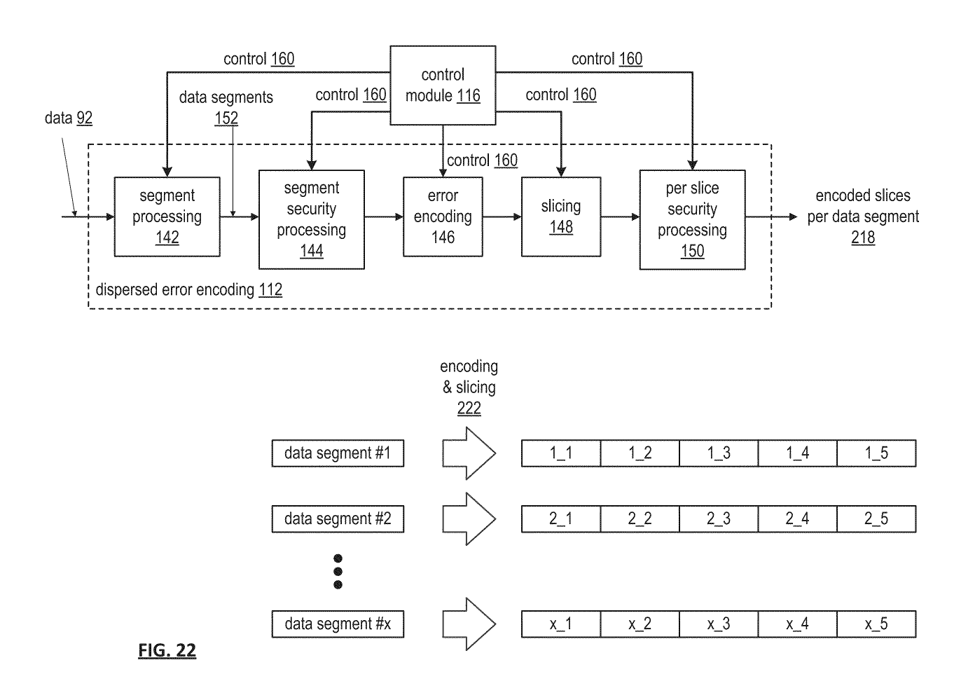

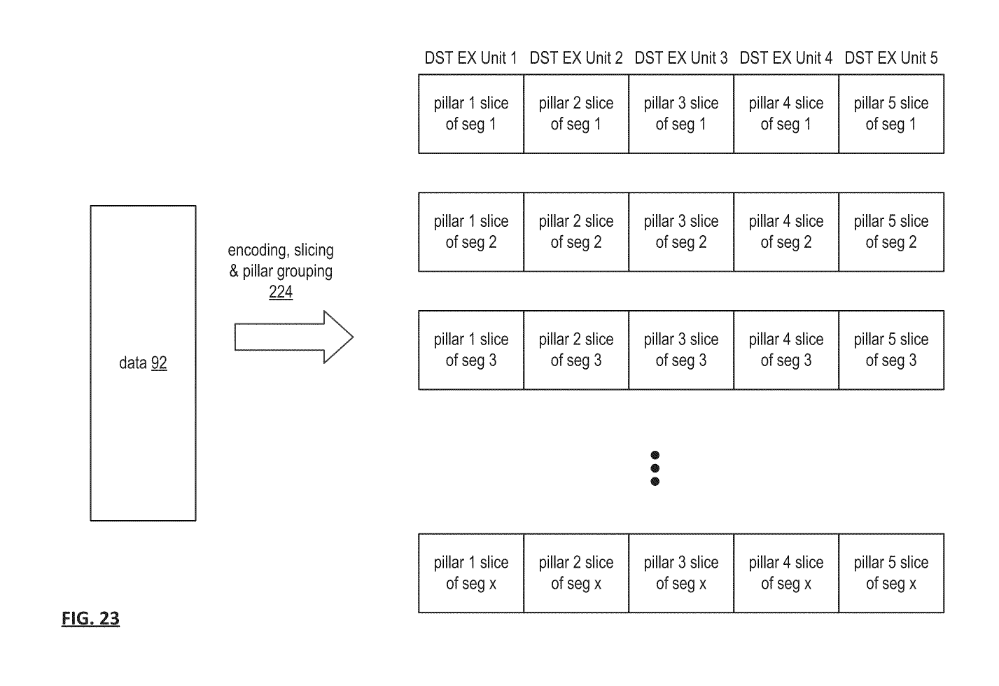

FIG. 23 is a diagram of an example of converting data 92 into pillar slice groups utilizing encoding, slicing and pillar grouping function 224 for storage in memory of a distributed storage and task network (DSTN) module. As previously discussed the data 92 is encoded and sliced into a plurality of sets of encoded data slices; one set per data segment. The grouping selection module organizes the sets of encoded data slices into pillars of data slices. In this example, the DS error encoding parameters include a pillar width of 5 and a decode threshold of 3. As such, for each data segment, 5 encoded data slices are created.

The grouping selection module takes the first encoded data slice of each of the sets and forms a first pillar, which may be sent to the first DST execution unit. Similarly, the grouping selection module creates the second pillar from the second slices of the sets; the third pillar from the third slices of the sets; the fourth pillar from the fourth slices of the sets; and the fifth pillar from the fifth slices of the set.

FIG. 24 is a schematic block diagram of an embodiment of a distributed storage and/or task (DST) execution unit that includes an interface 169, a controller 86, memory 88, one or more distributed task (DT) execution modules 90, and a DST client module 34. A computing core 26 may be utilized to implement the one or more DT execution modules 90 and the DST client module 34. The memory 88 is of sufficient size to store a significant number of encoded data slices (e.g., thousands of slices to hundreds-of-millions of slices) and may include one or more hard drives and/or one or more solid-state memory devices (e.g., flash memory, DRAM, etc.).

In an example of storing a pillar of slices 216, the DST execution unit receives, via interface 169, a pillar of slices 216 (e.g., pillar #1 slices). The memory 88 stores the encoded data slices 216 of the pillar of slices in accordance with memory control information 174 it receives from the controller 86. The controller 86 (e.g., a processing module, a CPU, etc.) generates the memory control information 174 based on distributed storage information (e.g., user information (e.g., user ID, distributed storage permissions, data access permission, etc.), vault information (e.g., virtual memory assigned to user, user group, etc.), etc.). Similarly, when retrieving slices, the DST execution unit receives, via interface 169, a slice retrieval request. The memory 88 retrieves the slice in accordance with memory control information 174 it receives from the controller 86. The memory 88 outputs the slice 100, via the interface 169, to a requesting entity.

FIG. 25 is a schematic block diagram of an example of operation of an inbound distributed storage and/or task (DST) processing section 82 for retrieving dispersed error encoded data 92. The inbound DST processing section 82 includes a de-grouping module 180, a dispersed storage (DS) error decoding module 182, a data de-partitioning module 184, a control module 186, and a distributed task control module 188. Note that the control module 186 and/or the distributed task control module 188 may be separate modules from corresponding ones of an outbound DST processing section or may be the same modules.

In an example of operation, the inbound DST processing section 82 is retrieving stored data 92 from the DST execution units (i.e., the DSTN module). In this example, the DST execution units output encoded data slices corresponding to data retrieval requests from the distributed task control module 188. The de-grouping module 180 receives pillars of slices 100 and de-groups them in accordance with control information 190 from the control module 186 to produce sets of encoded data slices 218. The DS error decoding module 182 decodes, in accordance with the DS error encoding parameters received as control information 190 from the control module 186, each set of encoded data slices 218 to produce data segments, which are aggregated into retrieved data 92. The data de-partitioning module 184 is by-passed in this operational mode via a bypass signal 226 of control information 190 from the control module 186.

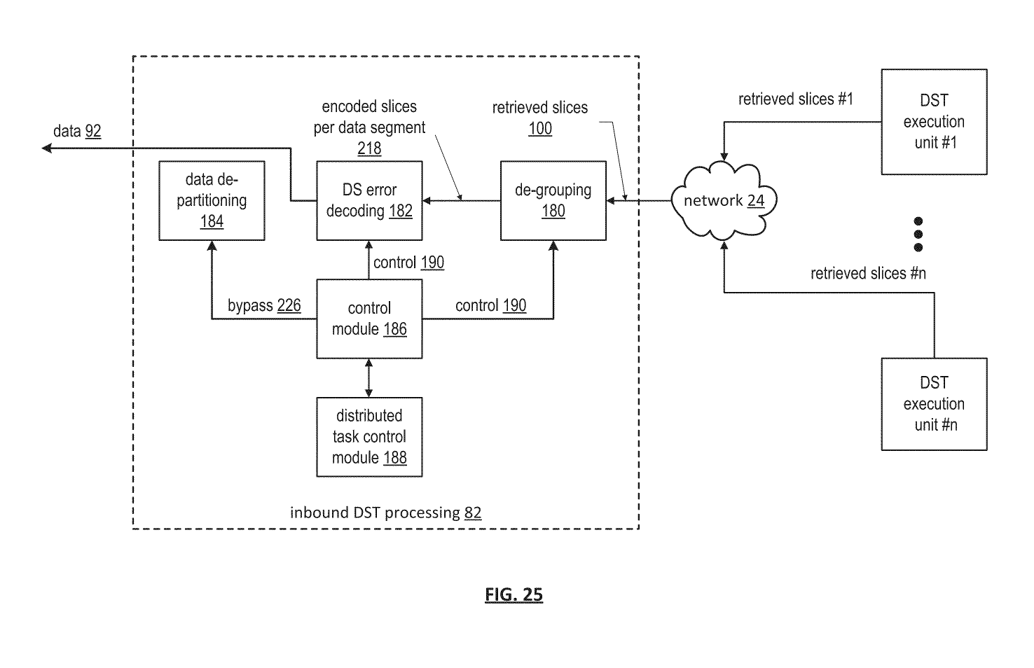

FIG. 26 is a schematic block diagram of an embodiment of a dispersed storage (DS) error decoding module 182 of an inbound distributed storage and task (DST) processing section. The DS error decoding module 182 includes an inverse per slice security processing module 202, a de-slicing module 204, an error decoding module 206, an inverse segment security module 208, and a de-segmenting processing module 210. The dispersed error decoding module 182 is operable to de-slice and decode encoded slices per data segment 218 utilizing a de-slicing and decoding function 228 to produce a plurality of data segments that are de-segmented utilizing a de-segment function 230 to recover data 92.

In an example of operation, the inverse per slice security processing module 202, when enabled by the control module 186 via control information 190, unsecures each encoded data slice 218 based on slice de-security information (e.g., the compliment of the slice security information discussed with reference to FIG. 6) received as control information 190 from the control module 186. The slice de-security information includes data decompression, decryption, de-watermarking, integrity check (e.g., CRC verification, etc.), and/or any other type of digital security. For example, when the inverse per slice security processing module 202 is enabled, it verifies integrity information (e.g., a CRC value) of each encoded data slice 218, it decrypts each verified encoded data slice, and decompresses each decrypted encoded data slice to produce slice encoded data. When the inverse per slice security processing module 202 is not enabled, it passes the encoded data slices 218 as the sliced encoded data or is bypassed such that the retrieved encoded data slices 218 are provided as the sliced encoded data.

The de-slicing module 204 de-slices the sliced encoded data into encoded data segments in accordance with a pillar width of the error correction encoding parameters received as control information 190 from a control module 186. For example, if the pillar width is five, the de-slicing module de-slices a set of five encoded data slices into an encoded data segment. Alternatively, the encoded data segment may include just three encoded data slices (e.g., when the decode threshold is 3).

The error decoding module 206 decodes the encoded data segments in accordance with error correction decoding parameters received as control information 190 from the control module 186 to produce secure data segments. The error correction decoding parameters include identifying an error correction encoding scheme (e.g., forward error correction algorithm, a Reed-Solomon based algorithm, an information dispersal algorithm, etc.), a pillar width, a decode threshold, a read threshold, a write threshold, etc. For example, the error correction decoding parameters identify a specific error correction encoding scheme, specify a pillar width of five, and specify a decode threshold of three.

The inverse segment security processing module 208, when enabled by the control module 186, unsecures the secured data segments based on segment security information received as control information 190 from the control module 186. The segment security information includes data decompression, decryption, de-watermarking, integrity check (e.g., CRC, etc.) verification, and/or any other type of digital security. For example, when the inverse segment security processing module is enabled, it verifies integrity information (e.g., a CRC value) of each secure data segment, it decrypts each verified secured data segment, and decompresses each decrypted secure data segment to produce a data segment 152. When the inverse segment security processing module 208 is not enabled, it passes the decoded data segment 152 as the data segment or is bypassed. The de-segmenting processing module 210 aggregates the data segments 152 into the data 92 in accordance with control information 190 from the control module 186.

FIG. 27 is a schematic block diagram of an example of a distributed storage and task processing network (DSTN) module that includes a plurality of distributed storage and task (DST) execution units (#1 through #n, where, for example, n is an integer greater than or equal to three). Each of the DST execution units includes a DST client module 34, a controller 86, one or more DT (distributed task) execution modules 90, and memory 88.

In this example, the DSTN module stores, in the memory of the DST execution units, a plurality of DS (dispersed storage) encoded data (e.g., 1 through n, where n is an integer greater than or equal to two) and stores a plurality of DS encoded task codes (e.g., 1 through k, where k is an integer greater than or equal to two). The DS encoded data may be encoded in accordance with one or more examples described with reference to FIGS. 3-19 (e.g., organized in slice groupings) or encoded in accordance with one or more examples described with reference to FIGS. 20-26 (e.g., organized in pillar groups). The data that is encoded into the DS encoded data may be of any size and/or of any content. For example, the data may be one or more digital books, a copy of a company's emails, a large-scale Internet search, a video security file, one or more entertainment video files (e.g., television programs, movies, etc.), data files, and/or any other large amount of data (e.g., greater than a few Terra-Bytes).

The tasks that are encoded into the DS encoded task code may be a simple function (e.g., a mathematical function, a logic function, an identify function, a find function, a search engine function, a replace function, etc.), a complex function (e.g., compression, human and/or computer language translation, text-to-voice conversion, voice-to-text conversion, etc.), multiple simple and/or complex functions, one or more algorithms, one or more applications, etc. The tasks may be encoded into the DS encoded task code in accordance with one or more examples described with reference to FIGS. 3-19 (e.g., organized in slice groupings) or encoded in accordance with one or more examples described with reference to FIGS. 20-26 (e.g., organized in pillar groups).

In an example of operation, a DST client module of a user device or of a DST processing unit issues a DST request to the DSTN module. The DST request may include a request to retrieve stored data, or a portion thereof, may include a request to store data that is included with the DST request, may include a request to perform one or more tasks on stored data, may include a request to perform one or more tasks on data included with the DST request, etc. In the cases where the DST request includes a request to store data or to retrieve data, the client module and/or the DSTN module processes the request as previously discussed with reference to one or more of FIGS. 3-19 (e.g., slice groupings) and/or 20-26 (e.g., pillar groupings). In the case where the DST request includes a request to perform one or more tasks on data included with the DST request, the DST client module and/or the DSTN module process the DST request as previously discussed with reference to one or more of FIGS. 3-19.

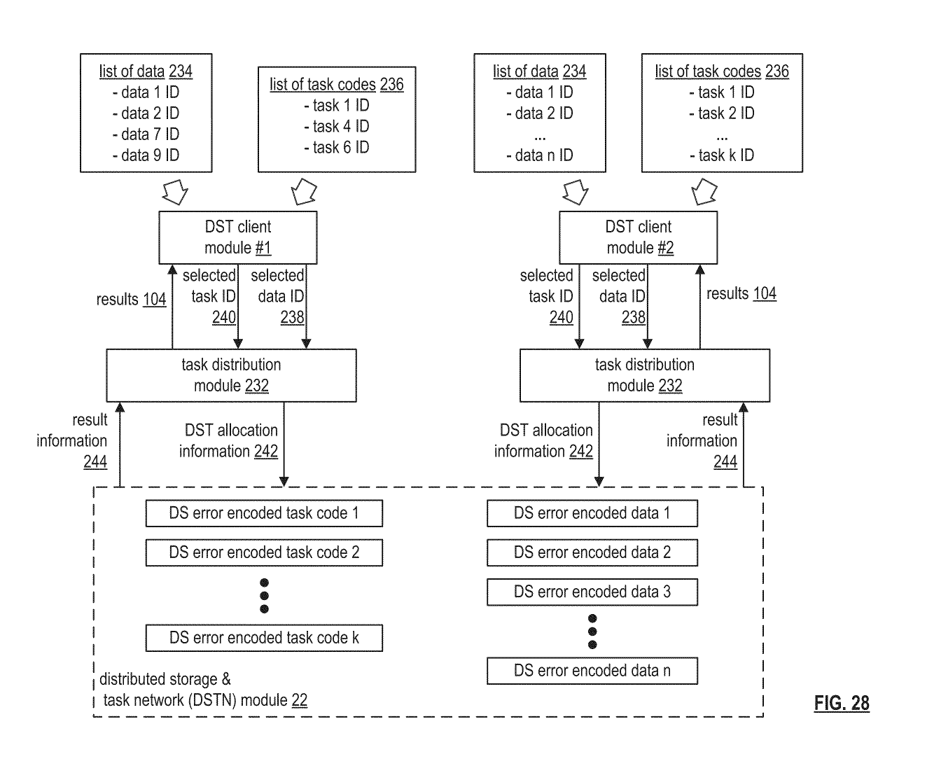

In the case where the DST request includes a request to perform one or more tasks on stored data, the DST client module and/or the DSTN module processes the DST request as will be described with reference to one or more of FIGS. 28-39. In general, the DST client module identifies data and one or more tasks for the DSTN module to execute upon the identified data. The DST request may be for a one-time execution of the task or for an on-going execution of the task. As an example of the latter, as a company generates daily emails, the DST request may be to daily search new emails for inappropriate content and, if found, record the content, the email sender(s), the email recipient(s), email routing information, notify human resources of the identified email, etc.

FIG. 28 is a schematic block diagram of an example of a distributed computing system performing tasks on stored data. In this example, two distributed storage and task (DST) client modules 1-2 are shown: the first may be associated with a user device and the second may be associated with a DST processing unit or a high priority user device (e.g., high priority clearance user, system administrator, etc.). Each DST client module includes a list of stored data 234 and a list of tasks codes 236. The list of stored data 234 includes one or more entries of data identifying information, where each entry identifies data stored in the DSTN module 22. The data identifying information (e.g., data ID) includes one or more of a data file name, a data file directory listing, DSTN addressing information of the data, a data object identifier, etc. The list of tasks 236 includes one or more entries of task code identifying information, when each entry identifies task codes stored in the DSTN module 22. The task code identifying information (e.g., task ID) includes one or more of a task file name, a task file directory listing, DSTN addressing information of the task, another type of identifier to identify the task, etc.

As shown, the list of data 234 and the list of tasks 236 are each smaller in number of entries for the first DST client module than the corresponding lists of the second DST client module. This may occur because the user device associated with the first DST client module has fewer privileges in the distributed computing system than the device associated with the second DST client module. Alternatively, this may occur because the user device associated with the first DST client module serves fewer users than the device associated with the second DST client module and is restricted by the distributed computing system accordingly. As yet another alternative, this may occur through no restraints by the distributed computing system, it just occurred because the operator of the user device associated with the first DST client module has selected fewer data and/or fewer tasks than the operator of the device associated with the second DST client module.

In an example of operation, the first DST client module selects one or more data entries 238 and one or more tasks 240 from its respective lists (e.g., selected data ID and selected task ID). The first DST client module sends its selections to a task distribution module 232. The task distribution module 232 may be within a stand-alone device of the distributed computing system, may be within the user device that contains the first DST client module, or may be within the DSTN module 22.

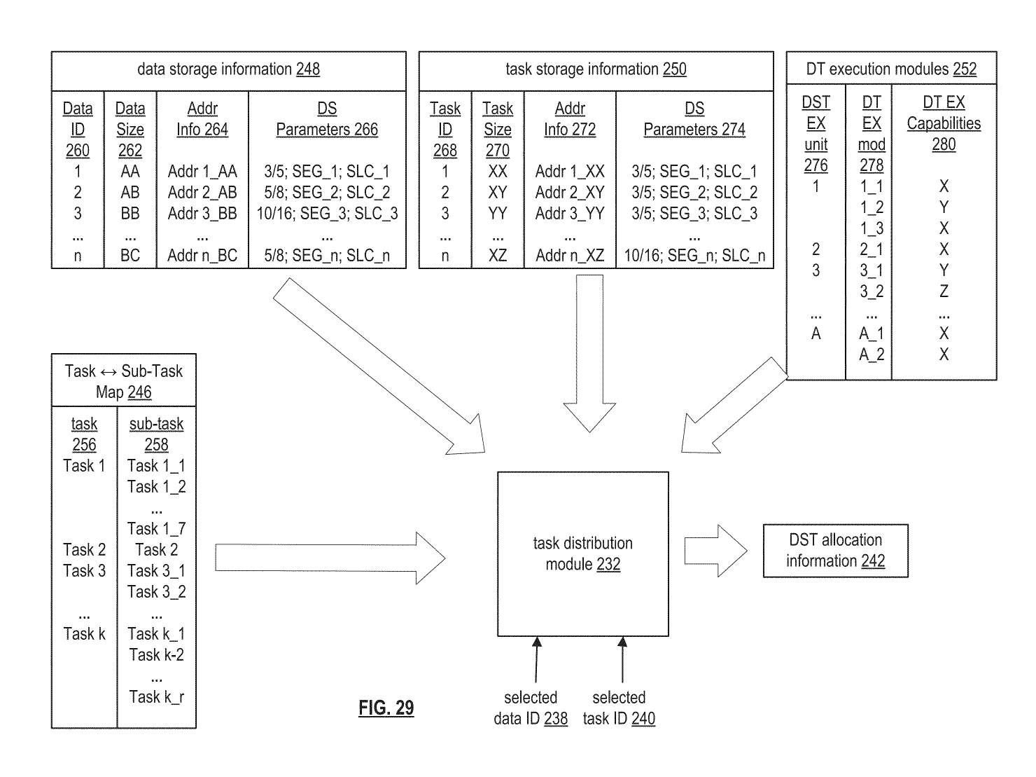

Regardless of the task distributions modules location, it generates DST allocation information 242 from the selected task ID 240 and the selected data ID 238. The DST allocation information 242 includes data partitioning information, task execution information, and/or intermediate result information. The task distribution module 232 sends the DST allocation information 242 to the DSTN module 22. Note that one or more examples of the DST allocation information will be discussed with reference to one or more of FIGS. 29-39.

The DSTN module 22 interprets the DST allocation information 242 to identify the stored DS encoded data (e.g., DS error encoded data 2) and to identify the stored DS error encoded task code (e.g., DS error encoded task code 1). In addition, the DSTN module 22 interprets the DST allocation information 242 to determine how the data is to be partitioned and how the task is to be partitioned. The DSTN module 22 also determines whether the selected DS error encoded data 238 needs to be converted from pillar grouping to slice grouping. If so, the DSTN module 22 converts the selected DS error encoded data into slice groupings and stores the slice grouping DS error encoded data by overwriting the pillar grouping DS error encoded data or by storing it in a different location in the memory of the DSTN module 22 (i.e., does not overwrite the pillar grouping DS encoded data).

The DSTN module 22 partitions the data and the task as indicated in the DST allocation information 242 and sends the portions to selected DST execution units of the DSTN module 22. Each of the selected DST execution units performs its partial task(s) on its slice groupings to produce partial results. The DSTN module 22 collects the partial results from the selected DST execution units and provides them, as result information 244, to the task distribution module. The result information 244 may be the collected partial results, one or more final results as produced by the DSTN module 22 from processing the partial results in accordance with the DST allocation information 242, or one or more intermediate results as produced by the DSTN module 22 from processing the partial results in accordance with the DST allocation information 242.

The task distribution module 232 receives the result information 244 and provides one or more final results 104 therefrom to the first DST client module. The final result(s) 104 may be result information 244 or a result(s) of the task distribution module's processing of the result information 244.

In concurrence with processing the selected task of the first DST client module, the distributed computing system may process the selected task(s) of the second DST client module on the selected data(s) of the second DST client module. Alternatively, the distributed computing system may process the second DST client module's request subsequent to, or preceding, that of the first DST client module. Regardless of the ordering and/or parallel processing of the DST client module requests, the second DST client module provides its selected data 238 and selected task 240 to a task distribution module 232. If the task distribution module 232 is a separate device of the distributed computing system or within the DSTN module, the task distribution modules 232 coupled to the first and second DST client modules may be the same module. The task distribution module 232 processes the request of the second DST client module in a similar manner as it processed the request of the first DST client module.

FIG. 29 is a schematic block diagram of an embodiment of a task distribution module 232 facilitating the example of FIG. 28. The task distribution module 232 includes a plurality of tables it uses to generate distributed storage and task (DST) allocation information 242 for selected data and selected tasks received from a DST client module. The tables include data storage information 248, task storage information 250, distributed task (DT) execution module information 252, and task [symbol] sub-task mapping information 246.

The data storage information table 248 includes a data identification (ID) field 260, a data size field 262, an addressing information field 264, distributed storage (DS) information 266, and may further include other information regarding the data, how it is stored, and/or how it can be processed. For example, DS encoded data #1 has a data ID of 1, a data size of AA (e.g., a byte size of a few terra-bytes or more), addressing information of Addr_{—}1_AA, and DS parameters of ⅗; SEG_{—}1; and SLC_{—}1. In this example, the addressing information may be a virtual address corresponding to the virtual address of the first storage word (e.g., one or more bytes) of the data and information on how to calculate the other addresses, may be a range of virtual addresses for the storage words of the data, physical addresses of the first storage word or the storage words of the data, may be a list of slice names of the encoded data slices of the data, etc. The DS parameters may include identity of an error encoding scheme, decode threshold/pillar width (e.g., ⅗ for the first data entry), segment security information (e.g., SEG_{—}1), per slice security information (e.g., SLC_{—}1), and/or any other information regarding how the data was encoded into data slices.

The task storage information table 250 includes a task identification (ID) field 268, a task size field 270, an addressing information field 272, distributed storage (DS) information 274, and may further include other information regarding the task, how it is stored, and/or how it can be used to process data. For example, DS encoded task #2 has a task ID of 2, a task size of XY, addressing information of Addr_{—}2_XY, and DS parameters of ⅗; SEG_{—}2; and SLC_{—}2. In this example, the addressing information may be a virtual address corresponding to the virtual address of the first storage word (e.g., one or more bytes) of the task and information on how to calculate the other addresses, may be a range of virtual addresses for the storage words of the task, physical addresses of the first storage word or the storage words of the task, may be a list of slices names of the encoded slices of the task code, etc. The DS parameters may include identity of an error encoding scheme, decode threshold/pillar width (e.g., ⅗ for the first data entry), segment security information (e.g., SEG_{—}2), per slice security information (e.g., SLC_{—}2), and/or any other information regarding how the task was encoded into encoded task slices. Note that the segment and/or the per-slice security information include a type of encryption (if enabled), a type of compression (if enabled), watermarking information (if enabled), and/or an integrity check scheme (if enabled).

The task [symbol] sub-task mapping information table 246 includes a task field 256 and a sub-task field 258. The task field 256 identifies a task stored in the memory of a distributed storage and task network (DSTN) module and the corresponding sub-task fields 258 indicates whether the task includes sub-tasks and, if so, how many and if any of the sub-tasks are ordered. In this example, the task [symbol] sub-task mapping information table 246 includes an entry for each task stored in memory of the DSTN module (e.g., task 1 through task k). In particular, this example indicates that task 1 includes 7 sub-tasks; task 2 does not include sub-tasks, and task k includes r number of sub-tasks (where r is an integer greater than or equal to two).

The DT execution module table 252 includes a DST execution unit ID field 276, a DT execution module ID field 278, and a DT execution module capabilities field 280. The DST execution unit ID field 276 includes the identity of DST units in the DSTN module. The DT execution module ID field 278 includes the identity of each DT execution unit in each DST unit. For example, DST unit 1 includes three DT executions modules (e.g., 1_{—}1, 1_{—}2, and 1_{—}3). The DT execution capabilities field 280 includes identity of the capabilities of the corresponding DT execution unit. For example, DT execution module 1_{—}1 includes capabilities X, where X includes one or more of MIPS capabilities, processing resources (e.g., quantity and capability of microprocessors, CPUs, digital signal processors, co-processor, microcontrollers, arithmetic logic circuitry, and/or and other analog and/or digital processing circuitry), availability of the processing resources, memory information (e.g., type, size, availability, etc.), and/or any information germane to executing one or more tasks.

From these tables, the task distribution module 232 generates the DST allocation information 242 to indicate where the data is stored, how to partition the data, where the task is stored, how to partition the task, which DT execution units should perform which partial task on which data partitions, where and how intermediate results are to be stored, etc. If multiple tasks are being performed on the same data or different data, the task distribution module factors such information into its generation of the DST allocation information.

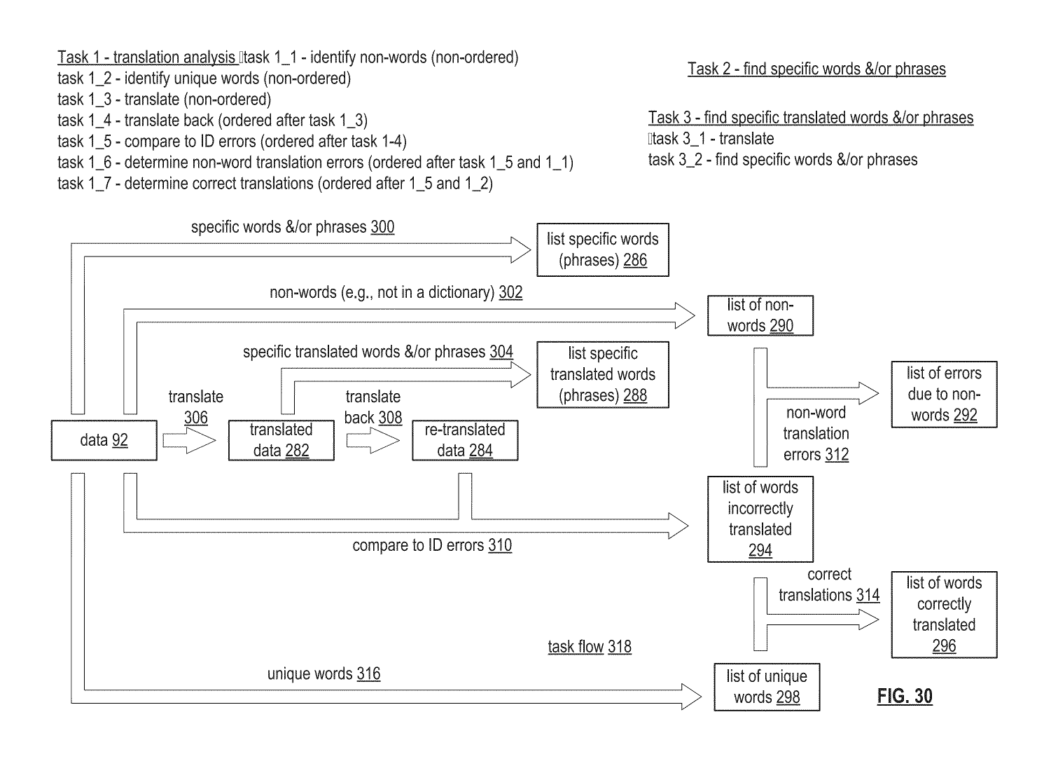

FIG. 30 is a diagram of a specific example of a distributed computing system performing tasks on stored data as a task flow 318. In this example, selected data 92 is data 2 and selected tasks are tasks 1, 2, and 3. Task 1 corresponds to analyzing translation of data from one language to another (e.g., human language or computer language); task 2 corresponds to finding specific words and/or phrases in the data; and task 3 corresponds to finding specific translated words or/or phrases in translated data.

In this example, task 1 includes 7 sub-tasks: task 1_{—}1—identify non-words (non-ordered); task 1_{—}2—identify unique words (non-ordered); task 1_{—}3—translate (non-ordered); task 1_{—}4—translate back (ordered after task 1_{—}3); task 1_{—}5—compare to ID errors (ordered after task 1-4); task 1_{—}6—determine non-word translation errors (ordered after task 1_{—}5 and 1_{—}1); and task 1_{—}7—determine correct translations (ordered after 1_{—}5 and 1_{—}2). The sub-task further indicates whether they are an ordered task (i.e., are dependent on the outcome of another task) or non-order (i.e., are independent of the outcome of another task). Task 2 does not include sub-tasks and task 3 includes two sub-tasks: task 3_{—}1 translate; and task 3_{—}2 find specific word or phrase in translated data.

In general, the three tasks collectively are selected to analyze data for translation accuracies, translation errors, translation anomalies, occurrence of specific words or phrases in the data, and occurrence of specific words or phrases on the translated data. Graphically, the data 92 is translated 306 into translated data 282; is analyzed for specific words and/or phrases 300 to produce a list of specific words and/or phrases 286; is analyzed for non-words 302 (e.g., not in a reference dictionary) to produce a list of non-words 290; and is analyzed for unique words 316 included in the data 92 (i.e., how many different words are included in the data) to produce a list of unique words 298. Each of these tasks is independent of each other and can therefore be processed in parallel if desired.

The translated data 282 is analyzed (e.g., sub-task 3_{—}2) for specific translated words and/or phrases 304 to produce a list of specific translated words and/or phrases. The translated data 282 is translated back 308 (e.g., sub-task 1_{—}4) into the language of the original data to produce re-translated data 284. These two tasks are dependent on the translate task (e.g., task 1_{—}3) and thus must be ordered after the translation task, which may be in a pipelined ordering or a serial ordering. The re-translated data 284 is then compared 310 with the original data 92 to find words and/or phrases that did not translate (one way and/or the other) properly to produce a list of incorrectly translated words 294. As such, the comparing task (e.g., sub-task 1_{—}5) 310 is ordered after the translation 306 and re-translation tasks 308 (e.g., sub-tasks 1_{—}3 and 1_{—}4).

The list of words incorrectly translated 294 is compared 312 to the list of non-words 290 to identify words that were not properly translated because the words are non-words to produce a list of errors due to non-words 292. In addition, the list of words incorrectly translated 294 is compared 314 to the list of unique words 298 to identify unique words that were properly translated to produce a list of correctly translated words 296. The comparison may also identify unique words that were not properly translated to produce a list of unique words that were not properly translated. Note that each list of words (e.g., specific words and/or phrases, non-words, unique words, translated words and/or phrases, etc.,) may include the word and/or phrase, how many times it is used, where in the data it is used, and/or any other information requested regarding a word and/or phrase.

FIG. 31 is a schematic block diagram of an example of a distributed storage and task processing network (DSTN) module storing data and task codes for the example of FIG. 30. As shown, DS encoded data 2 is stored as encoded data slices across the memory (e.g., stored in memories 88) of DST execution units 1-5; the DS encoded task code 1 (of task 1) and DS encoded task 3 are stored as encoded task slices across the memory of DST execution units 1-5; and DS encoded task code 2 (of task 2) is stored as encoded task slices across the memory of DST execution units 3-7. As indicated in the data storage information table and the task storage information table of FIG. 29, the respective data/task has DS parameters of ⅗ for their decode threshold/pillar width; hence spanning the memory of five DST execution units.

FIG. 32 is a diagram of an example of distributed storage and task (DST) allocation information 242 for the example of FIG. 30. The DST allocation information 242 includes data partitioning information 320, task execution information 322, and intermediate result information 324. The data partitioning information 320 includes the data identifier (ID), the number of partitions to split the data into, address information for each data partition, and whether the DS encoded data has to be transformed from pillar grouping to slice grouping. The task execution information 322 includes tabular information having a task identification field 326, a task ordering field 328, a data partition field ID 330, and a set of DT execution modules 332 to use for the distributed task processing per data partition. The intermediate result information 324 includes tabular information having a name ID field 334, an ID of the DST execution unit assigned to process the corresponding intermediate result 336, a scratch pad storage field 338, and an intermediate result storage field 340.

Continuing with the example of FIG. 30, where tasks 1-3 are to be distributedly performed on data 2, the data partitioning information includes the ID of data 2. In addition, the task distribution module determines whether the DS encoded data 2 is in the proper format for distributed computing (e.g., was stored as slice groupings). If not, the task distribution module indicates that the DS encoded data 2 format needs to be changed from the pillar grouping format to the slice grouping format, which will be done the by DSTN module. In addition, the task distribution module determines the number of partitions to divide the data into (e.g., 2_{—}1 through 2_z) and addressing information for each partition.

The task distribution module generates an entry in the task execution information section for each sub-task to be performed. For example, task 1_{—}1 (e.g., identify non-words on the data) has no task ordering (i.e., is independent of the results of other sub-tasks), is to be performed on data partitions 2_{—}1 through 2_z by DT execution modules 1_{—}1, 2_{—}1, 3_{—}1, 4_{—}1, and 5_{—}1. For instance, DT execution modules 1_{—}1, 2_{—}1, 3_{—}1, 4_{—}1, and 5_{—}1 search for non-words in data partitions 2_{—}1 through 2_z to produce task 1_{—}1 intermediate results (R1-1, which is a list of non-words). Task 1_{—}2 (e.g., identify unique words) has similar task execution information as task 1_{—}1 to produce task 1_{—}2 intermediate results (R1-2, which is the list of unique words).

Task 1_{—}3 (e.g., translate) includes task execution information as being non-ordered (i.e., is independent), having DT execution modules 1_{—}1, 2_{—}1, 3_{—}1, 4_{—}1, and 5_{—}1 translate data partitions 2_{—}1 through 2_{—}4 and having DT execution modules 1_{—}2, 2_{—}2, 3_{—}2, 4_{—}2, and 5_{—}2 translate data partitions 2_{—}5 through 2_z to produce task 1_{—}3 intermediate results (R1-3, which is the translated data). In this example, the data partitions are grouped, where different sets of DT execution modules perform a distributed sub-task (or task) on each data partition group, which allows for further parallel processing.

Task 1_{—}4 (e.g., translate back) is ordered after task 1_{—}3 and is to be executed on task 1_{—}3's intermediate result (e.g., R1-3_{—}1) (e.g., the translated data). DT execution modules 1_{—}1, 2_{—}1, 3_{—}1, 4_{—}1, and 5_{—}1 are allocated to translate back task 1_{—}3 intermediate result partitions R1-3_{—}1 through R1-3_{—}4 and DT execution modules 1_{—}2, 2_{—}2, 6_{—}1, 7_{—}1, and 7_{—}2 are allocated to translate back task 1_{—}3 intermediate result partitions R1-3_{—}5 through R1-3_z to produce task 1-4 intermediate results (R1-4, which is the translated back data).

Task 1_{—}5 (e.g., compare data and translated data to identify translation errors) is ordered after task 1_{—}4 and is to be executed on task 1_{—}4's intermediate results (R4-1) and on the data. DT execution modules 1_{—}1, 2_{—}1, 3_{—}1, 4_{—}1, and 5_{—}1 are allocated to compare the data partitions (2_{—}1 through 2_z) with partitions of task 1-4 intermediate results partitions R1-4_{—}1 through R1-4_z to produce task 1_{—}5 intermediate results (R1-5, which is the list words translated incorrectly).

Task 1_{—}6 (e.g., determine non-word translation errors) is ordered after tasks 1_{—}1 and 1_{—}5 and is to be executed on tasks 1_{—}1's and 1_{—}5's intermediate results (R1-1 and R1-5). DT execution modules 1_{—}1, 2_{—}1, 3_{—}1, 4_{—}1, and 5_{—}1 are allocated to compare the partitions of task 1_{—}1 intermediate results (R1-1_{—}1 through R1-1_z) with partitions of task 1-5 intermediate results partitions (R1-5_{—}1 through R1-5_z) to produce task 1_{—}6 intermediate results (R1-6, which is the list translation errors due to non-words).

Task 1_{—}7 (e.g., determine words correctly translated) is ordered after tasks 1_{—}2 and 1_{—}5 and is to be executed on tasks 1_{—}2's and 1_{—}5's intermediate results (R1-1 and R1-5). DT execution modules 1_{—}2, 2_{—}2, 3_{—}2, 4_{—}2, and 5_{—}2 are allocated to compare the partitions of task 1_{—}2 intermediate results (R1-2_{—}1 through R1-2_z) with partitions of task 1-5 intermediate results partitions (R1-5_{—}1 through R1-5_z) to produce task 1_{—}7 intermediate results (R1-7, which is the list of correctly translated words).

Task 2 (e.g., find specific words and/or phrases) has no task ordering (i.e., is independent of the results of other sub-tasks), is to be performed on data partitions 2_{—}1 through 2_z by DT execution modules 3_{—}1, 4_{—}1, 5_{—}1, 6_{—}1, and 7_{—}1. For instance, DT execution modules 3_{—}1, 4_{—}1, 5_{—}1, 6_{—}1, and 7_{—}1 search for specific words and/or phrases in data partitions 2_{—}1 through 2_z to produce task 2 intermediate results (R2, which is a list of specific words and/or phrases).

Task 3_{—}2 (e.g., find specific translated words and/or phrases) is ordered after task 1_{—}3 (e.g., translate) is to be performed on partitions R1-3_{—}1 through R1-3_z by DT execution modules 1_{—}2, 2_{—}2, 3_{—}2, 4_{—}2, and 5_{—}2. For instance, DT execution modules 1_{—}2, 2_{—}2, 3_{—}2, 4_{—}2, and 5_{—}2 search for specific translated words and/or phrases in the partitions of the translated data (R1-3_{—}1 through R1-3_z) to produce task 3_{—}2 intermediate results (R3-2, which is a list of specific translated words and/or phrases).

For each task, the intermediate result information indicates which DST unit is responsible for overseeing execution of the task and, if needed, processing the partial results generated by the set of allocated DT execution units. In addition, the intermediate result information indicates a scratch pad memory for the task and where the corresponding intermediate results are to be stored. For example, for intermediate result R1-1 (the intermediate result of task 1_{—}1), DST unit 1 is responsible for overseeing execution of the task 1_{—}1 and coordinates storage of the intermediate result as encoded intermediate result slices stored in memory of DST execution units 1-5. In general, the scratch pad is for storing non-DS encoded intermediate results and the intermediate result storage is for storing DS encoded intermediate results.

FIGS. 33-38 are schematic block diagrams of the distributed storage and task network (DSTN) module performing the example of FIG. 30. In FIG. 33, the DSTN module accesses the data 92 and partitions it into a plurality of partitions 1-z in accordance with distributed storage and task network (DST) allocation information. For each data partition, the DSTN identifies a set of its DT (distributed task) execution modules 90 to perform the task (e.g., identify non-words (i.e., not in a reference dictionary) within the data partition) in accordance with the DST allocation information. From data partition to data partition, the set of DT execution modules 90 may be the same, different, or a combination thereof (e.g., some data partitions use the same set while other data partitions use different sets).

For the first data partition, the first set of DT execution modules (e.g., 1_{—}1, 2_{—}1, 3_{—}1, 4_{—}1, and 5_{—}1 per the DST allocation information of FIG. 32) executes task 1_{—}1 to produce a first partial result 102 of non-words found in the first data partition. The second set of DT execution modules (e.g., 1_{—}1, 2_{—}1, 3_{—}1, 4_{—}1, and 5_{—}1 per the DST allocation information of FIG. 32) executes task 1_{—}1 to produce a second partial result 102 of non-words found in the second data partition. The sets of DT execution modules (as per the DST allocation information) perform task 1_{—}1 on the data partitions until the “z” set of DT execution modules performs task 1_{—}1 on the “zth” data partition to produce a “zth” partial result 102 of non-words found in the “zth” data partition.

As indicated in the DST allocation information of FIG. 32, DST execution unit 1 is assigned to process the first through “zth” partial results to produce the first intermediate result (R1-1), which is a list of non-words found in the data. For instance, each set of DT execution modules 90 stores its respective partial result in the scratchpad memory of DST execution unit 1 (which is identified in the DST allocation or may be determined by DST execution unit 1). A processing module of DST execution 1 is engaged to aggregate the first through “zth” partial results to produce the first intermediate result (e.g., R1_{—}1). The processing module stores the first intermediate result as non-DS error encoded data in the scratchpad memory or in another section of memory of DST execution unit 1.

DST execution unit 1 engages its DST client module to slice grouping based DS error encode the first intermediate result (e.g., the list of non-words). To begin the encoding, the DST client module determines whether the list of non-words is of a sufficient size to partition (e.g., greater than a Terra-Byte). If yes, it partitions the first intermediate result (R1-1) into a plurality of partitions (e.g., R1-1_{—}1 through R1-1_m). If the first intermediate result is not of sufficient size to partition, it is not partitioned.

For each partition of the first intermediate result, or for the first intermediate result, the DST client module uses the DS error encoding parameters of the data (e.g., DS parameters of data 2, which includes ⅗ decode threshold/pillar width ratio) to produce slice groupings. The slice groupings are stored in the intermediate result memory (e.g., allocated memory in the memories of DST execution units 1-5).

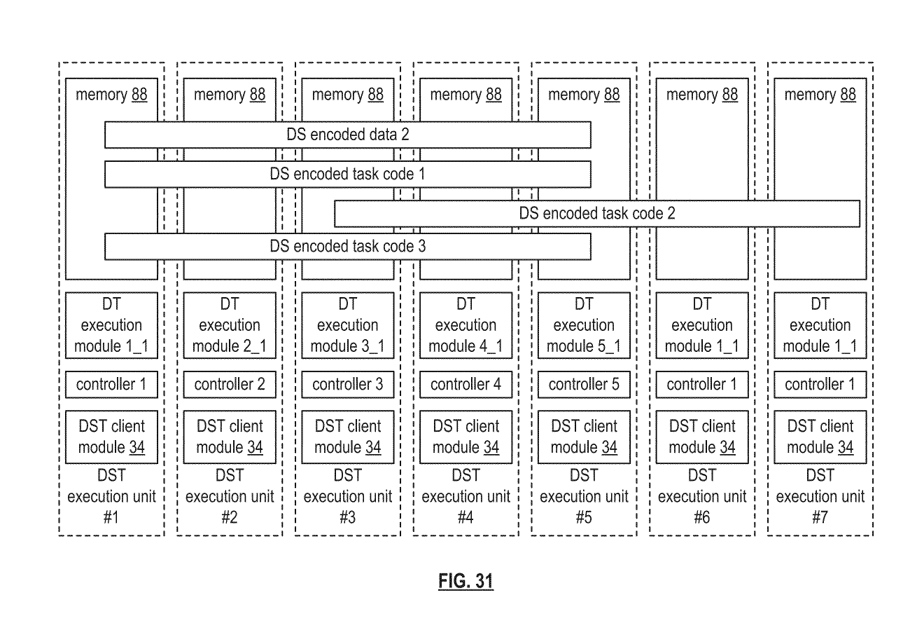

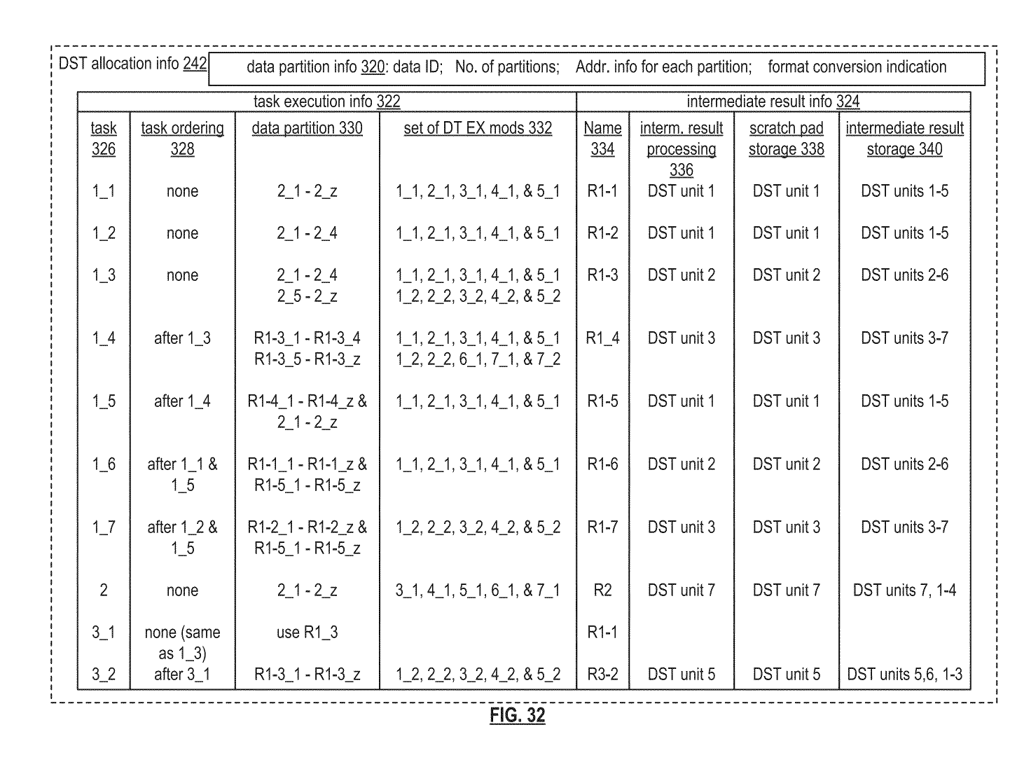

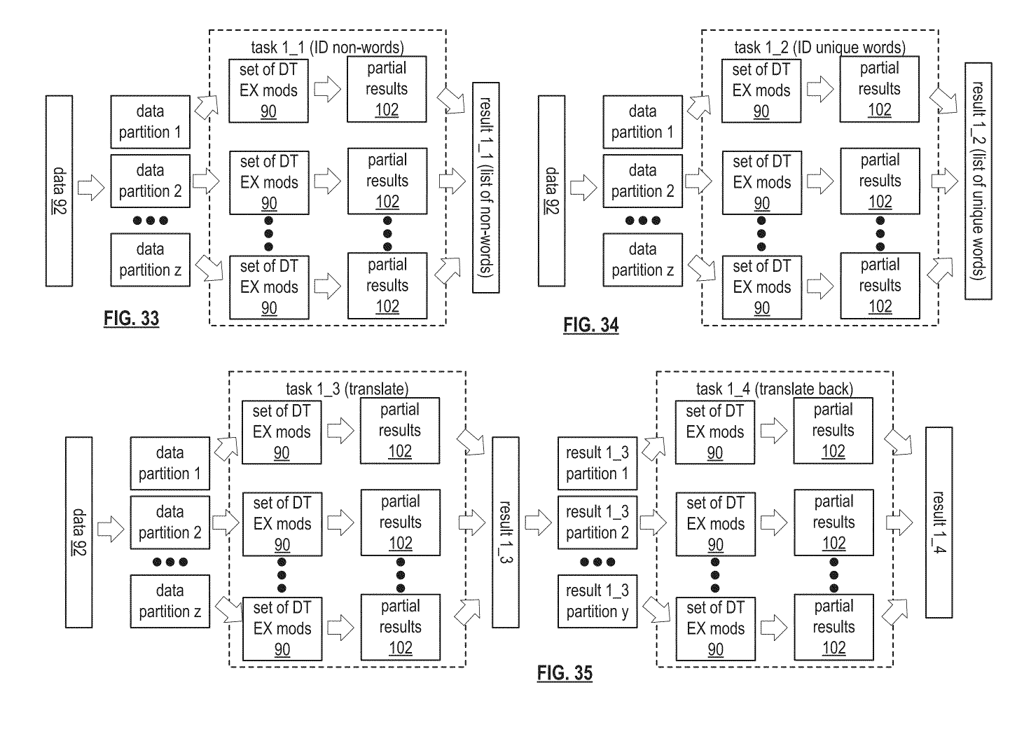

In FIG. 34, the DSTN module is performing task 1_{—}2 (e.g., find unique words) on the data 92. To begin, the DSTN module accesses the data 92 and partitions it into a plurality of partitions 1-z in accordance with the DST allocation information or it may use the data partitions of task 1_{—}1 if the partitioning is the same. For each data partition, the DSTN identifies a set of its DT execution modules to perform task 1_{—}2 in accordance with the DST allocation information. From data partition to data partition, the set of DT execution modules may be the same, different, or a combination thereof. For the data partitions, the allocated set of DT execution modules executes task 1_{—}2 to produce a partial results (e.g., 1^{st} through “zth”) of unique words found in the data partitions.

As indicated in the DST allocation information of FIG. 32, DST execution unit 1 is assigned to process the first through “zth” partial results 102 of task 1_{—}2 to produce the second intermediate result (R1-2), which is a list of unique words found in the data 92. The processing module of DST execution 1 is engaged to aggregate the first through “zth” partial results of unique words to produce the second intermediate result. The processing module stores the second intermediate result as non-DS error encoded data in the scratchpad memory or in another section of memory of DST execution unit 1.

DST execution unit 1 engages its DST client module to slice grouping based DS error encode the second intermediate result (e.g., the list of non-words). To begin the encoding, the DST client module determines whether the list of unique words is of a sufficient size to partition (e.g., greater than a Terra-Byte). If yes, it partitions the second intermediate result (R1-2) into a plurality of partitions (e.g., R1-2_{—}1 through R1-2_m). If the second intermediate result is not of sufficient size to partition, it is not partitioned.

For each partition of the second intermediate result, or for the second intermediate results, the DST client module uses the DS error encoding parameters of the data (e.g., DS parameters of data 2, which includes ⅗ decode threshold/pillar width ratio) to produce slice groupings. The slice groupings are stored in the intermediate result memory (e.g., allocated memory in the memories of DST execution units 1-5).

In FIG. 35, the DSTN module is performing task 1_{—}3 (e.g., translate) on the data 92. To begin, the DSTN module accesses the data 92 and partitions it into a plurality of partitions 1-z in accordance with the DST allocation information or it may use the data partitions of task 1_{—}1 if the partitioning is the same. For each data partition, the DSTN identifies a set of its DT execution modules to perform task 1_{—}3 in accordance with the DST allocation information (e.g., DT execution modules 1_{—}1, 2_{—}1, 3_{—}1, 4_{—}1, and 5_{—}1 translate data partitions 2_{—}1 through 2_{—}4 and DT execution modules 1_{—}2, 2_{—}2, 3_{—}2, 4_{—}2, and 5_{—}2 translate data partitions 2_{—}5 through 2_z). For the data partitions, the allocated set of DT execution modules 90 executes task 1_{—}3 to produce partial results 102 (e.g., 1^{st} through “zth”) of translated data.

As indicated in the DST allocation information of FIG. 32, DST execution unit 2 is assigned to process the first through “zth” partial results of task 1_{—}3 to produce the third intermediate result (R1-3), which is translated data. The processing module of DST execution 2 is engaged to aggregate the first through “zth” partial results of translated data to produce the third intermediate result. The processing module stores the third intermediate result as non-DS error encoded data in the scratchpad memory or in another section of memory of DST execution unit 2.

DST execution unit 2 engages its DST client module to slice grouping based DS error encode the third intermediate result (e.g., translated data). To begin the encoding, the DST client module partitions the third intermediate result (R1-3) into a plurality of partitions (e.g., R1-3_{—}1 through R1-3_y). For each partition of the third intermediate result, the DST client module uses the DS error encoding parameters of the data (e.g., DS parameters of data 2, which includes ⅗ decode threshold/pillar width ratio) to produce slice groupings. The slice groupings are stored in the intermediate result memory (e.g., allocated memory in the memories of DST execution units 2-6 per the DST allocation information).

As is further shown in FIG. 35, the DSTN module is performing task 1_{—}4 (e.g., retranslate) on the translated data of the third intermediate result. To begin, the DSTN module accesses the translated data (from the scratchpad memory or from the intermediate result memory and decodes it) and partitions it into a plurality of partitions in accordance with the DST allocation information. For each partition of the third intermediate result, the DSTN identifies a set of its DT execution modules 90 to perform task 1_{—}4 in accordance with the DST allocation information (e.g., DT execution modules 1_{—}1, 2_{—}1, 3_{—}1, 4_{—}1, and 5_{—}1 are allocated to translate back partitions R1-3_{—}1 through R1-3_{—}4 and DT execution modules 1_{—}2, 2_{—}2, 6_{—}1, 7_{—}1, and 7_{—}2 are allocated to translate back partitions R1-3_{—}5 through R1-3_z). For the partitions, the allocated set of DT execution modules executes task 1_{—}4 to produce partial results 102 (e.g., 1^{st} through “zth”) of re-translated data.

As indicated in the DST allocation information of FIG. 32, DST execution unit 3 is assigned to process the first through “zth” partial results of task 1_{—}4 to produce the fourth intermediate result (R1-4), which is retranslated data. The processing module of DST execution 3 is engaged to aggregate the first through “zth” partial results of retranslated data to produce the fourth intermediate result. The processing module stores the fourth intermediate result as non-DS error encoded data in the scratchpad memory or in another section of memory of DST execution unit 3.

DST execution unit 3 engages its DST client module to slice grouping based DS error encode the fourth intermediate result (e.g., retranslated data). To begin the encoding, the DST client module partitions the fourth intermediate result (R1-4) into a plurality of partitions (e.g., R1-4_{—}1 through R1-4_z). For each partition of the fourth intermediate result, the DST client module uses the DS error encoding parameters of the data (e.g., DS parameters of data 2, which includes ⅗ decode threshold/pillar width ratio) to produce slice groupings. The slice groupings are stored in the intermediate result memory (e.g., allocated memory in the memories of DST execution units 3-7 per the DST allocation information).

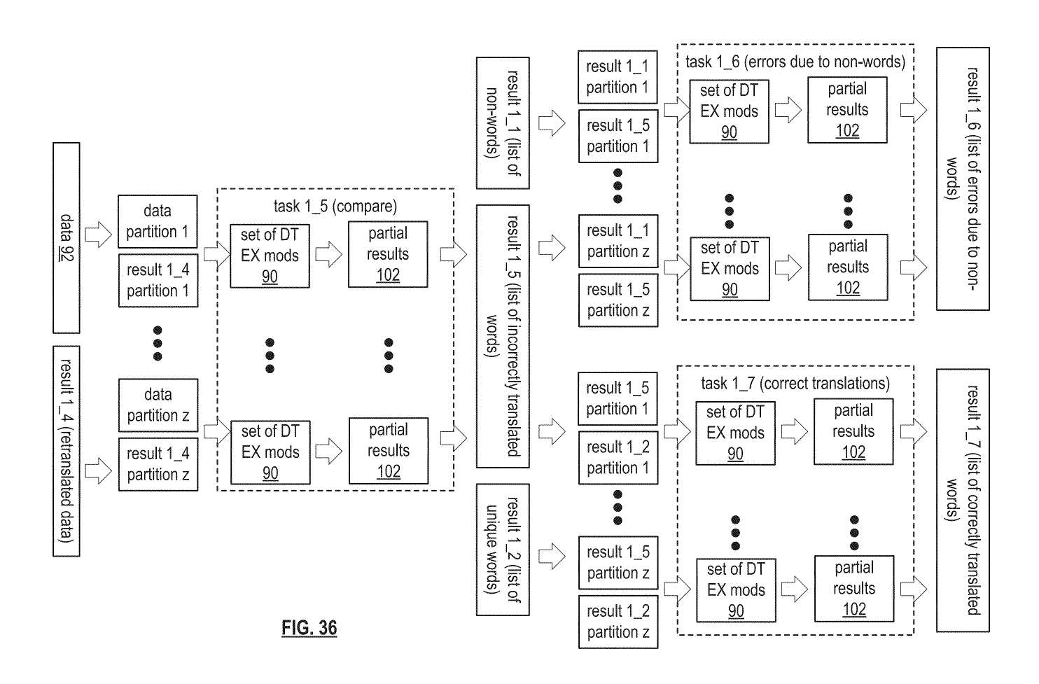

In FIG. 36, a distributed storage and task network (DSTN) module is performing task 1_{—}5 (e.g., compare) on data 92 and retranslated data of FIG. 35. To begin, the DSTN module accesses the data 92 and partitions it into a plurality of partitions in accordance with the DST allocation information or it may use the data partitions of task 1_{—}1 if the partitioning is the same. The DSTN module also accesses the retranslated data from the scratchpad memory, or from the intermediate result memory and decodes it, and partitions it into a plurality of partitions in accordance with the DST allocation information. The number of partitions of the retranslated data corresponds to the number of partitions of the data.

For each pair of partitions (e.g., data partition 1 and retranslated data partition 1), the DSTN identifies a set of its DT execution modules 90 to perform task 1_{—}5 in accordance with the DST allocation information (e.g., DT execution modules 1_{—}1, 2_{—}1, 3_{—}1, 4_{—}1, and 5_{—}1). For each pair of partitions, the allocated set of DT execution modules executes task 1_{—}5 to produce partial results 102 (e.g., 1^{st} through “zth”) of a list of incorrectly translated words and/or phrases.

As indicated in the DST allocation information of FIG. 32, DST execution unit 1 is assigned to process the first through “zth” partial results of task 1_{—}5 to produce the fifth intermediate result (R1-5), which is the list of incorrectly translated words and/or phrases. In particular, the processing module of DST execution 1 is engaged to aggregate the first through “zth” partial results of the list of incorrectly translated words and/or phrases to produce the fifth intermediate result. The processing module stores the fifth intermediate result as non-DS error encoded data in the scratchpad memory or in another section of memory of DST execution unit 1.

DST execution unit 1 engages its DST client module to slice grouping based DS error encode the fifth intermediate result. To begin the encoding, the DST client module partitions the fifth intermediate result (R1-5) into a plurality of partitions (e.g., R1-5_{—}1 through R1-5_z). For each partition of the fifth intermediate result, the DST client module uses the DS error encoding parameters of the data (e.g., DS parameters of data 2, which includes ⅗ decode threshold/pillar width ratio) to produce slice groupings. The slice groupings are stored in the intermediate result memory (e.g., allocated memory in the memories of DST execution units 1-5 per the DST allocation information).

As is further shown in FIG. 36, the DSTN module is performing task 1_{—}6 (e.g., translation errors due to non-words) on the list of incorrectly translated words and/or phrases (e.g., the fifth intermediate result R1-5) and the list of non-words (e.g., the first intermediate result R1-1). To begin, the DSTN module accesses the lists and partitions them into a corresponding number of partitions.

For each pair of partitions (e.g., partition R1-1_{—}1 and partition R1-5_{—}1), the DSTN identifies a set of its DT execution modules 90 to perform task 1_{—}6 in accordance with the DST allocation information (e.g., DT execution modules 1_{—}1, 2_{—}1, 3_{—}1, 4_{—}1, and 5_{—}1). For each pair of partitions, the allocated set of DT execution modules executes task 1_{—}6 to produce partial results 102 (e.g., 1^{st} through “zth”) of a list of incorrectly translated words and/or phrases due to non-words.

As indicated in the DST allocation information of FIG. 32, DST execution unit 2 is assigned to process the first through “zth” partial results of task 1_{—}6 to produce the sixth intermediate result (R1-6), which is the list of incorrectly translated words and/or phrases due to non-words. In particular, the processing module of DST execution 2 is engaged to aggregate the first through “zth” partial results of the list of incorrectly translated words and/or phrases due to non-words to produce the sixth intermediate result. The processing module stores the sixth intermediate result as non-DS error encoded data in the scratchpad memory or in another section of memory of DST execution unit 2.

DST execution unit 2 engages its DST client module to slice grouping based DS error encode the sixth intermediate result. To begin the encoding, the DST client module partitions the sixth intermediate result (R1-6) into a plurality of partitions (e.g., R1-6_{—}1 through R1-6_z). For each partition of the sixth intermediate result, the DST client module uses the DS error encoding parameters of the data (e.g., DS parameters of data 2, which includes ⅗ decode threshold/pillar width ratio) to produce slice groupings. The slice groupings are stored in the intermediate result memory (e.g., allocated memory in the memories of DST execution units 2-6 per the DST allocation information).

As is still further shown in FIG. 36, the DSTN module is performing task 1_{—}7 (e.g., correctly translated words and/or phrases) on the list of incorrectly translated words and/or phrases (e.g., the fifth intermediate result R1-5) and the list of unique words (e.g., the second intermediate result R1-2). To begin, the DSTN module accesses the lists and partitions them into a corresponding number of partitions.

For each pair of partitions (e.g., partition R1-2_{—}1 and partition R1-5_{—}1), the DSTN identifies a set of its DT execution modules 90 to perform task 1_{—}7 in accordance with the DST allocation information (e.g., DT execution modules 1_{—}2, 2_{—}2, 3_{—}2, 4_{—}2, and 5_{—}2). For each pair of partitions, the allocated set of DT execution modules executes task 1_{—}7 to produce partial results 102 (e.g., 1^{st} through “zth”) of a list of correctly translated words and/or phrases.

As indicated in the DST allocation information of FIG. 32, DST execution unit 3 is assigned to process the first through “zth” partial results of task 1_{—}7 to produce the seventh intermediate result (R1-7), which is the list of correctly translated words and/or phrases. In particular, the processing module of DST execution 3 is engaged to aggregate the first through “zth” partial results of the list of correctly translated words and/or phrases to produce the seventh intermediate result. The processing module stores the seventh intermediate result as non-DS error encoded data in the scratchpad memory or in another section of memory of DST execution unit 3.

DST execution unit 3 engages its DST client module to slice grouping based DS error encode the seventh intermediate result. To begin the encoding, the DST client module partitions the seventh intermediate result (R1-7) into a plurality of partitions (e.g., R1-7_{—}1 through R1-7_z). For each partition of the seventh intermediate result, the DST client module uses the DS error encoding parameters of the data (e.g., DS parameters of data 2, which includes ⅗ decode threshold/pillar width ratio) to produce slice groupings. The slice groupings are stored in the intermediate result memory (e.g., allocated memory in the memories of DST execution units 3-7 per the DST allocation information).

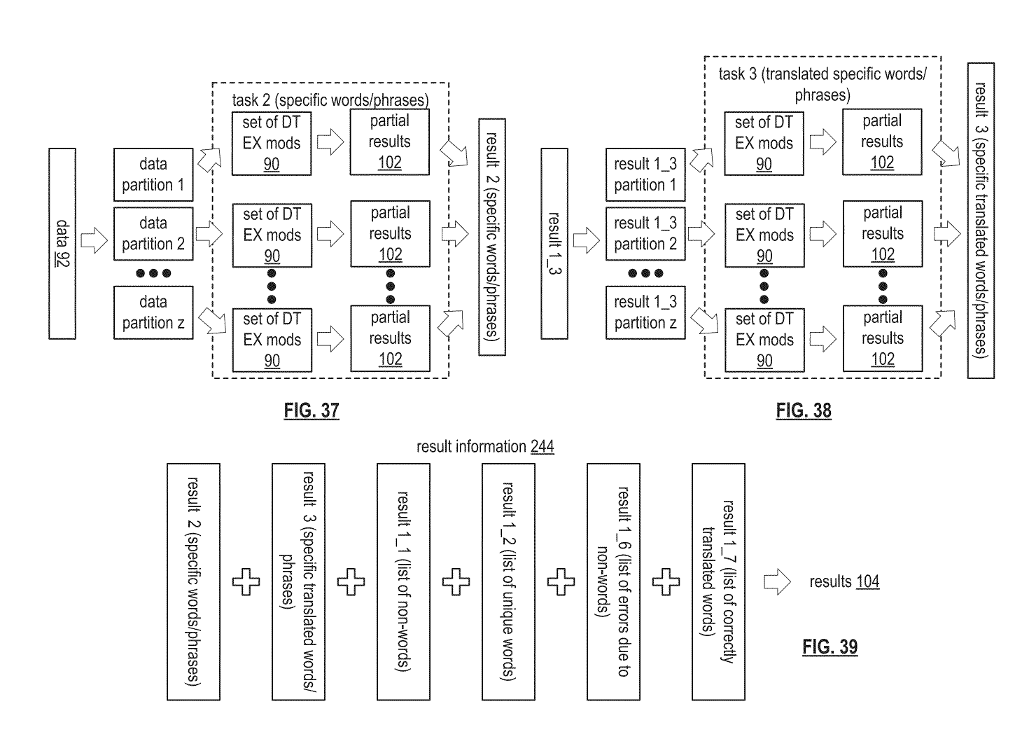

In FIG. 37, the distributed storage and task network (DSTN) module is performing task 2 (e.g., find specific words and/or phrases) on the data 92. To begin, the DSTN module accesses the data and partitions it into a plurality of partitions 1-z in accordance with the DST allocation information or it may use the data partitions of task 1_{—}1 if the partitioning is the same. For each data partition, the DSTN identifies a set of its DT execution modules 90 to perform task 2 in accordance with the DST allocation information. From data partition to data partition, the set of DT execution modules may be the same, different, or a combination thereof. For the data partitions, the allocated set of DT execution modules executes task 2 to produce partial results 102 (e.g., 1^{st} through “zth”) of specific words and/or phrases found in the data partitions.

As indicated in the DST allocation information of FIG. 32, DST execution unit 7 is assigned to process the first through “zth” partial results of task 2 to produce task 2 intermediate result (R2), which is a list of specific words and/or phrases found in the data. The processing module of DST execution 7 is engaged to aggregate the first through “zth” partial results of specific words and/or phrases to produce the task 2 intermediate result. The processing module stores the task 2 intermediate result as non-DS error encoded data in the scratchpad memory or in another section of memory of DST execution unit 7.

DST execution unit 7 engages its DST client module to slice grouping based DS error encode the task 2 intermediate result. To begin the encoding, the DST client module determines whether the list of specific words and/or phrases is of a sufficient size to partition (e.g., greater than a Terra-Byte). If yes, it partitions the task 2 intermediate result (R2) into a plurality of partitions (e.g., R2_{—}1 through R2_m). If the task 2 intermediate result is not of sufficient size to partition, it is not partitioned.

For each partition of the task 2 intermediate result, or for the task 2 intermediate results, the DST client module uses the DS error encoding parameters of the data (e.g., DS parameters of data 2, which includes ⅗ decode threshold/pillar width ratio) to produce slice groupings. The slice groupings are stored in the intermediate result memory (e.g., allocated memory in the memories of DST execution units 1-4, and 7).

In FIG. 38, the distributed storage and task network (DSTN) module is performing task 3 (e.g., find specific translated words and/or phrases) on the translated data (R1-3). To begin, the DSTN module accesses the translated data (from the scratchpad memory or from the intermediate result memory and decodes it) and partitions it into a plurality of partitions in accordance with the DST allocation information. For each partition, the DSTN identifies a set of its DT execution modules to perform task 3 in accordance with the DST allocation information. From partition to partition, the set of DT execution modules may be the same, different, or a combination thereof. For the partitions, the allocated set of DT execution modules 90 executes task 3 to produce partial results 102 (e.g., 1^{st} through “zth”) of specific translated words and/or phrases found in the data partitions.

As indicated in the DST allocation information of FIG. 32, DST execution unit 5 is assigned to process the first through “zth” partial results of task 3 to produce task 3 intermediate result (R3), which is a list of specific translated words and/or phrases found in the translated data. In particular, the processing module of DST execution 5 is engaged to aggregate the first through “zth” partial results of specific translated words and/or phrases to produce the task 3 intermediate result. The processing module stores the task 3 intermediate result as non-DS error encoded data in the scratchpad memory or in another section of memory of DST execution unit 7.

DST execution unit 5 engages its DST client module to slice grouping based DS error encode the task 3 intermediate result. To begin the encoding, the DST client module determines whether the list of specific translated words and/or phrases is of a sufficient size to partition (e.g., greater than a Terra-Byte). If yes, it partitions the task 3 intermediate result (R3) into a plurality of partitions (e.g., R3_{—}1 through R3_m). If the task 3 intermediate result is not of sufficient size to partition, it is not partitioned.

For each partition of the task 3 intermediate result, or for the task 3 intermediate results, the DST client module uses the DS error encoding parameters of the data (e.g., DS parameters of data 2, which includes ⅗ decode threshold/pillar width ratio) to produce slice groupings. The slice groupings are stored in the intermediate result memory (e.g., allocated memory in the memories of DST execution units 1-4, 5, and 7).

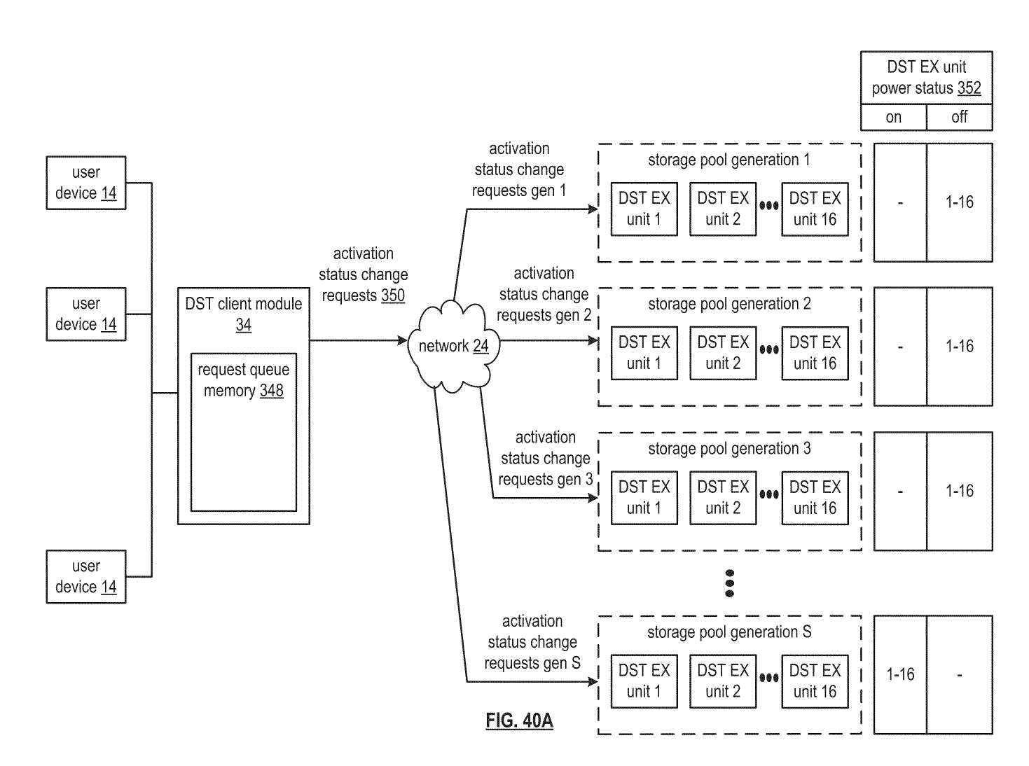

FIG. 39 is a diagram of an example of combining result information into final results 104 for the example of FIG. 30. In this example, the result information includes the list of specific words and/or phrases found in the data (task 2 intermediate result), the list of specific translated words and/or phrases found in the data (task 3 intermediate result), the list of non-words found in the data (task 1 first intermediate result R1-1), the list of unique words found in the data (task 1 second intermediate result R1-2), the list of translation errors due to non-words (task 1 sixth intermediate result R1-6), and the list of correctly translated words and/or phrases (task 1 seventh intermediate result R1-7). The task distribution module provides the result information to the requesting DST client module as the results 104.

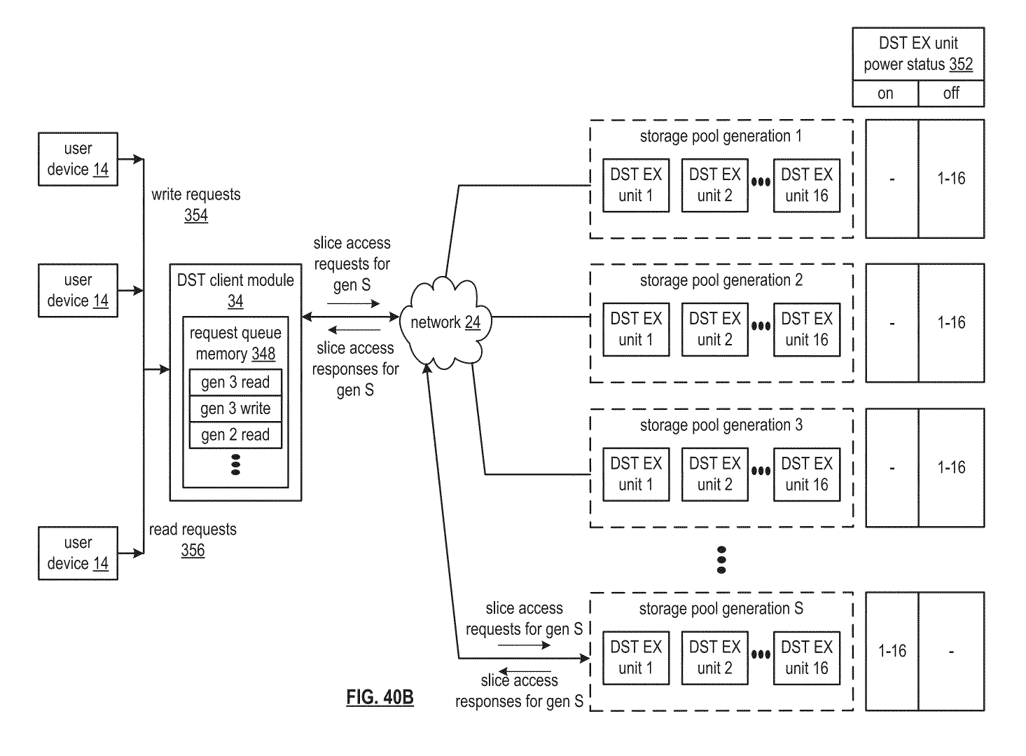

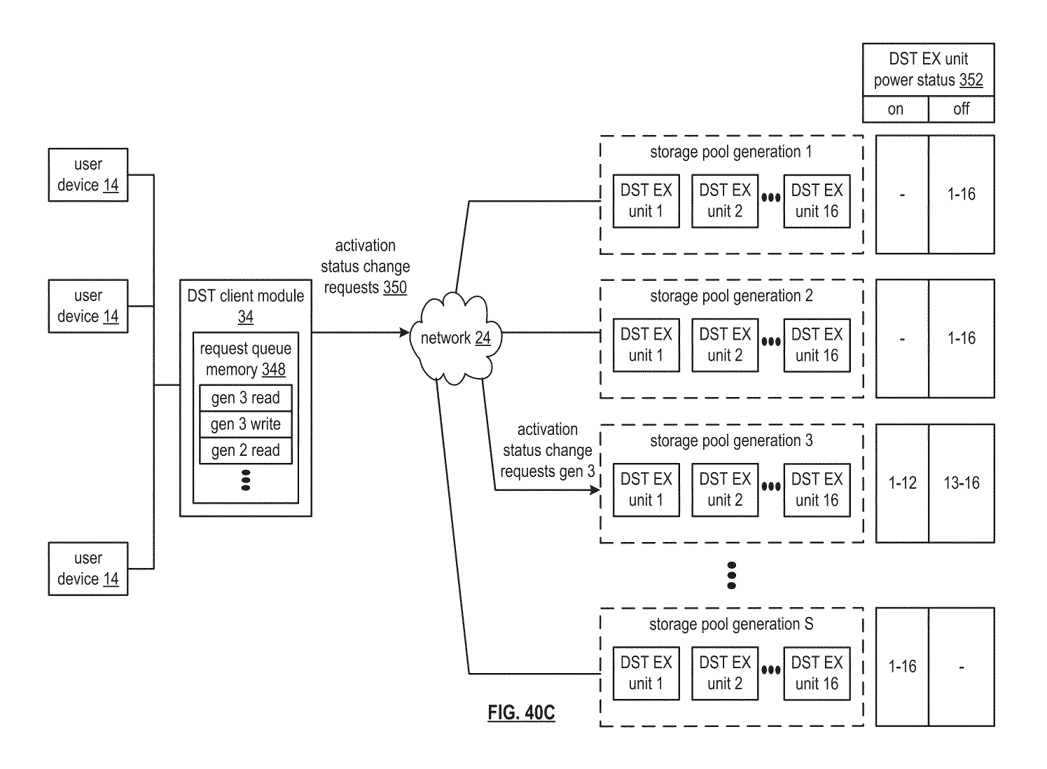

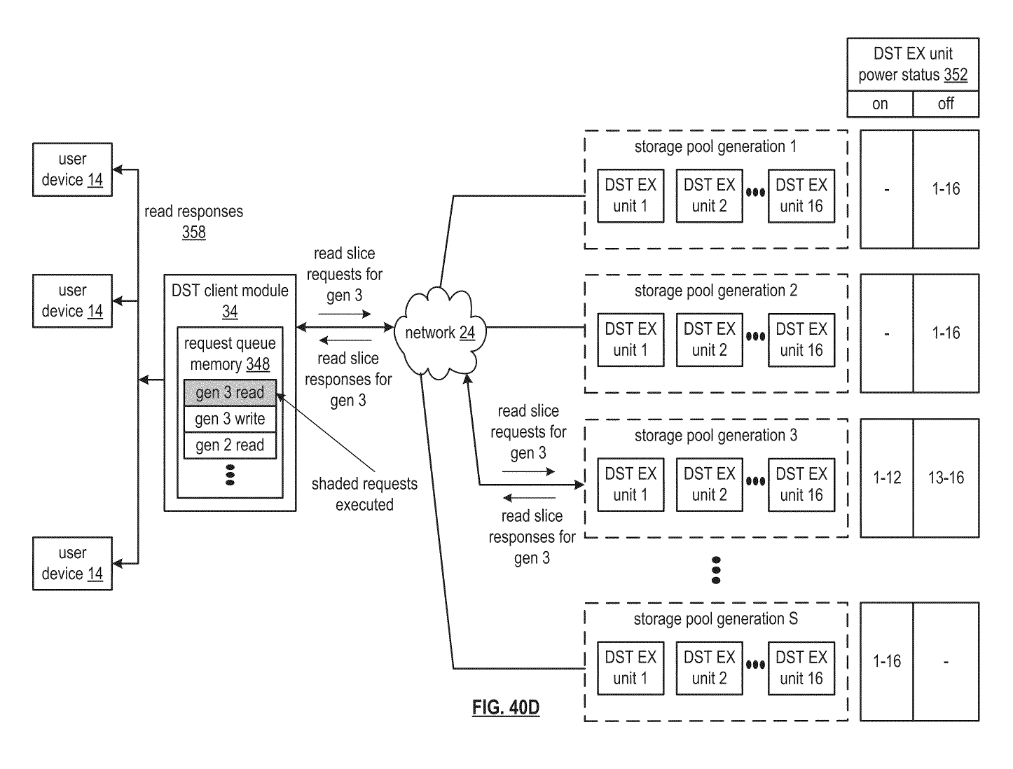

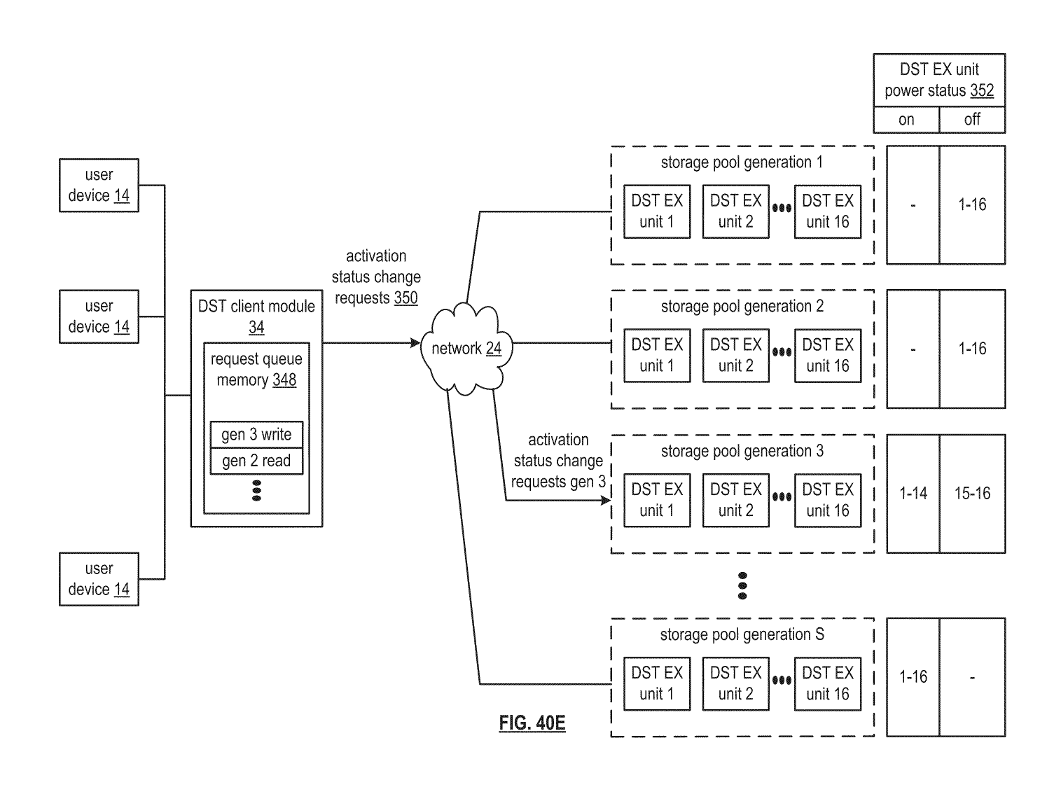

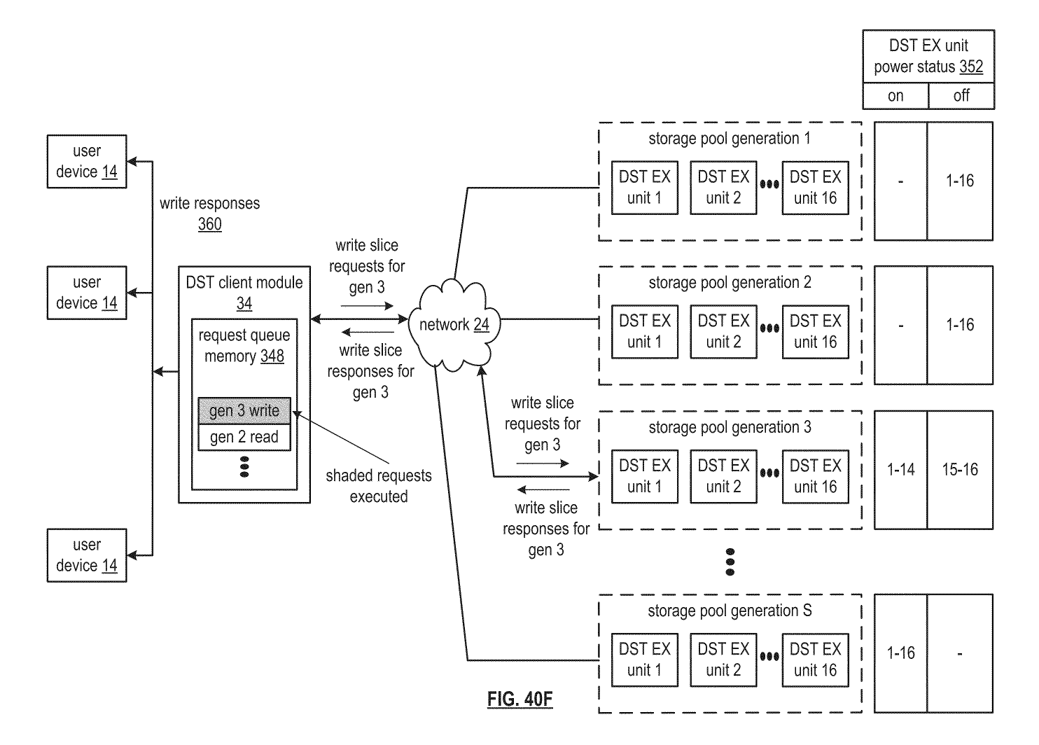

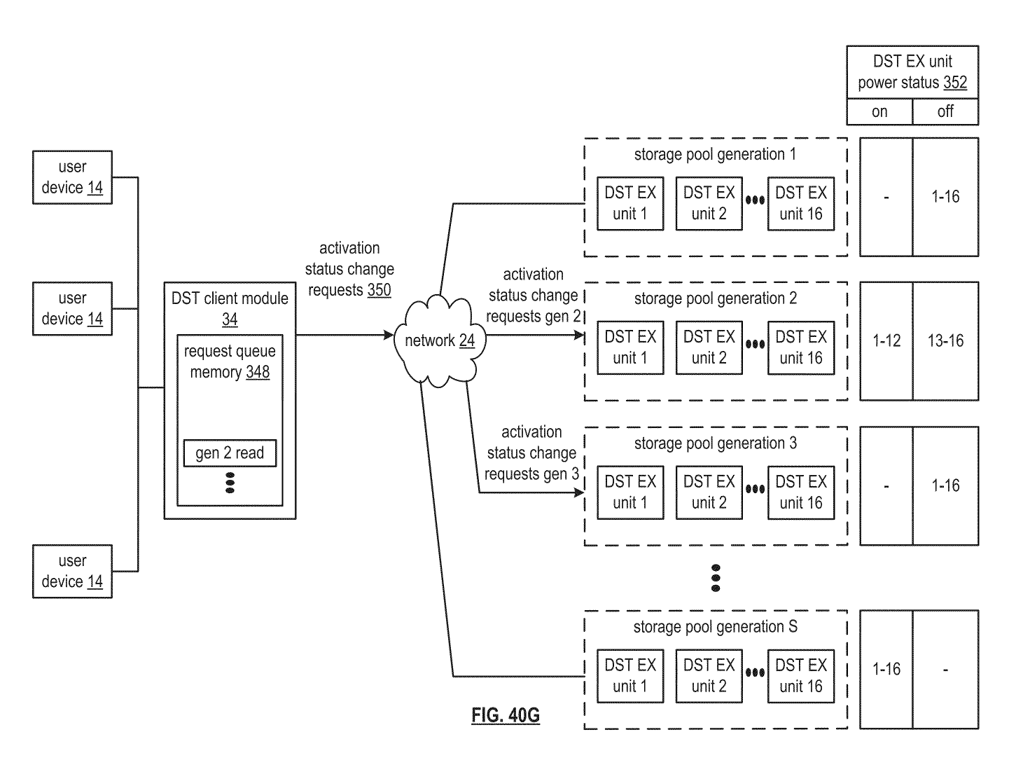

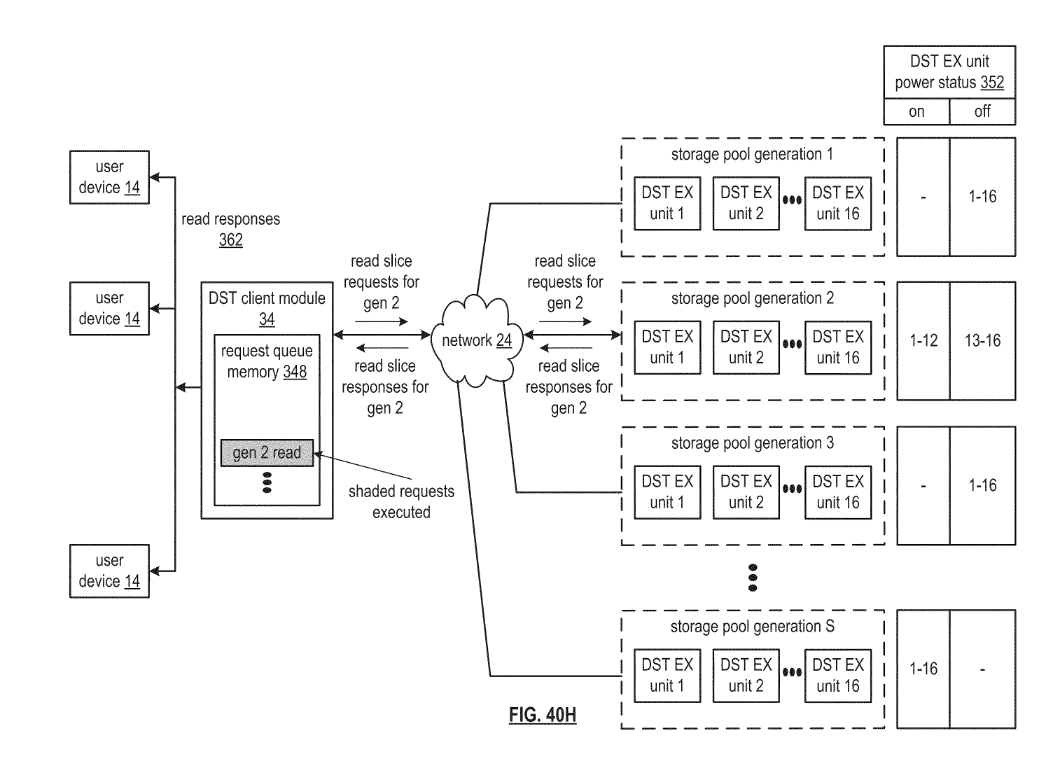

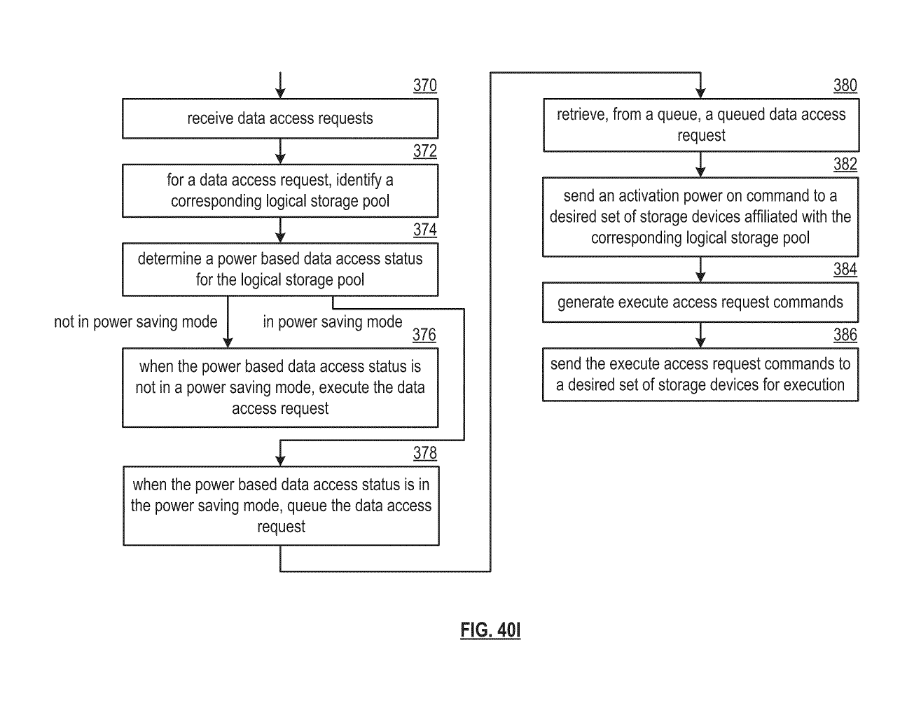

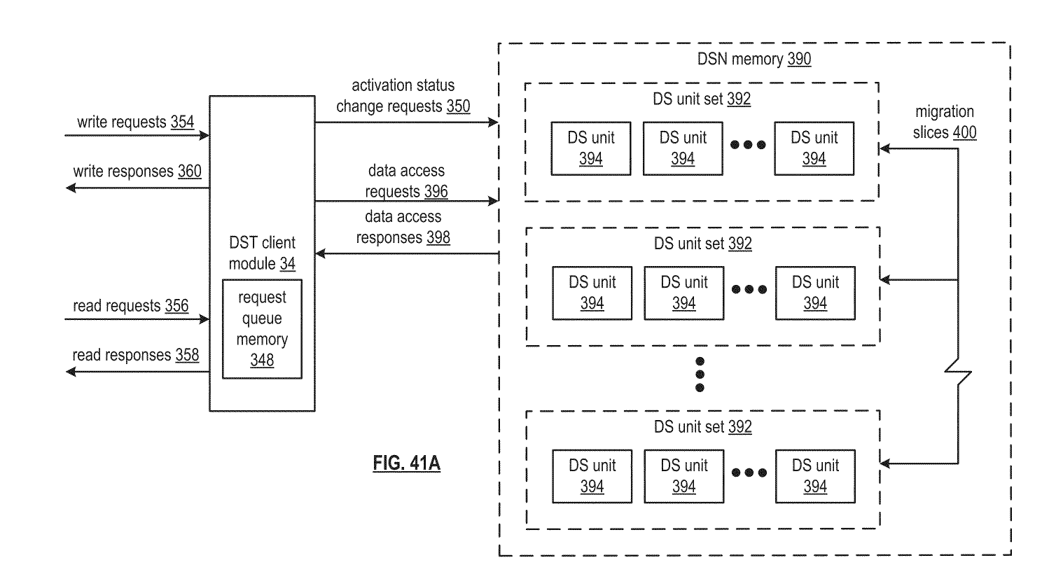

FIG. 40A-40H are schematic block diagrams of an embodiment of a dispersed storage network (DSN) illustrating an example of power control. The DSN includes a plurality of user devices 14 of FIG. 1, the distributed storage and task (DST) client module 34 of FIG. 1, the network 24 of FIG. 1, and a plurality of storage pool generations 1-S. The DST client module 34 includes a request queue memory 348. Each storage pool generation includes a set of storage devices of a plurality of storage devices of the DSN. As a specific example, a storage device may include one or more memory devices within a storage unit of the DSN. A storage unit may include at least one of the DST execution unit 36 of FIG. 1, a storage server, a memory array, the DST processing unit 16 of FIG. 1. For instance, each storage pool generation includes a set of DST execution units 1-16 of a plurality of DST execution units of the DSN when each set of storage devices includes 16 units. As another specific example, the storage device may include one or more storage units at a site of the DSN. As yet another specific example, the storage device may include one or more sites of the DSN.

The DSN functions include accessing a plurality of data objects stored in the plurality of storage pool generations 1-S. A data object is distributedly stored in a set of storage devices of the plurality of storage devices of the DSN, where the plurality of storage devices is arranged into a plurality of logical storage pools. The set of storage devices stores data that have a common data access trait. The data access trait includes one or more of age of the data object, data object type, and data object storage status. As a specific example, a data access trait that is associated with oldest data objects corresponds to a first level of storage of the DSN representing storage pool generation 1 and another data access trait that is associated with next-oldest data objects corresponds to a second-level storage in the DSN representing storage pool generation 2 etc. The set of storage devices is affiliated with one of the plurality of logical storage pools. For instance, a first set of DST execution units 1-16 is affiliated with the storage pool generation 1 and was a first logical storage pool utilized for a vault; a second set of DST execution units 1-16 is affiliated with the storage pool generation 2 and was a second logical storage pool utilized for the vault; through to a Sth set of DST execution units 1-16 that is affiliated with storage pool generation S and is a current logical storage pool utilized for a vault.

The DSN processes access requests for the plurality of data objects stored in the plurality of storage pool generations 1-S in accordance with a power based access status of one or more of the plurality of logical storage pools. The request to access the data object may include at least one of a read request, a write request, a delete request, and a list request. The power based access status includes a power saving mode and a non-power saving mode. A request to access a data object associated with a logical storage pool may be immediately executed when the power based access status of a logical storage pool indicates the non-power saving mode for the request. As a specific example, a request to access a data object stored in the storage pool generation S is immediately executed when the power based access status of the storage pool generation S indicates the non-power saving mode for all requests (e.g., for a read request, for a write request, etc.)

The request to access the data object may not be immediately executed when the power based access status of the logical storage pool indicates the power saving mode for the request. As a specific example, a request to access a data object stored in storage pool generation 3 is not immediately executed (e.g., the request is queued) when the power based access status of the storage pool generation 3 indicates the power saving mode for all requests (e.g., for a read request, for a write request, etc.). As another specific example, the request to access the data object stored in storage pool generation 3 is immediately executed when the power based access status of the storage pool generation 3 indicates the power saving mode for write and/or delete requests and the non-power saving mode for read and/or list requests and the request to access the data object is the read request.

The DST client module 34 may determine the power based access status for the logical storage pool by accessing a power based data access plan for the logical storage pool, where the power based data access plan indicates a power status for each of the storage devices affiliated with the logical storage pool. The power status is one of active power on (e.g., substantially fully powered on and processing access requests), inactive power off (e.g., substantially powered off and not processing access requests), and inactive power on (e.g., substantially fully powered on but not processing access requests) as illustrated by DST execution unit power status 352 (e.g., indicating which DST execution units are on or off). The DST client module 34 may determine the power-based data access plan for the logical storage pool based on one or more of interpreting a data access level, and estimated power consumption level of one or more of the sets of storage devices, and a power consumption threshold level.

The power consumption threshold level facilitates utilization of a desired level of power for the plurality of storage devices. The DST client module 34 may select the power consumption threshold level in accordance with a desired activation approach. As a specific example, the DST client module 34 selects the power consumption threshold level to facilitate utilization of a minimal amount of power to process the data access requests while allowing a compromised level of access performance. As another specific example, the DST client module 34 selects the power consumption threshold level to facilitate a highest level of access performance while allowing a compromised level of high-power utilization. As yet another specific example, the DST client module 34 selects the power consumption threshold level to facilitate a compromise between power consumption and access performance.

The DST client module 34 and each of the plurality of DST execution units may include further modules. As a specific example, the DST client module 34 and each of the plurality of DST execution units provide a first module, a second module, and other modules to facilitate the accessing of the plurality of data objects. For instance, the DST client module 34 includes the first and the second modules and the plurality of DST execution units includes the other modules. In another instance, a DST execution unit 1 of storage pool generation S includes the first and the second modules and remaining DST execution units includes the other modules.

FIG. 40A illustrates an example of pre-steps to steps of the accessing of the plurality of data objects stored in the plurality of storage pool generations 1-S. The pre-steps include establishing the power based access status for each of the logical storage pools. In an example of operation of the establishing the power-based access status, one of the first and second modules, when operable within the DST client module 34, causes the DST client module 34 to establish the data access approach to provide highest performance for the current generation (e.g., storage pool generation S) and highest power savings for older generations (e.g., storage pool generations 1-3) based on a planned lookup.

Having established the data access approach, the DST client module 34 establishes the power based access plan to include the storage pool generations 1-3 in the power saving mode for all data request types and to include the storage pool generation S (e.g., current generation) in the non-power saving mode for all request types. In particular, the DST client module 34 establishes the power based access plan to include the power status for each storage device of the storage pool generations 1-3 to be inactive power off and the power status for each storage device of the storage pool generation S to be active power on.

Having established the power status for each storage device of the storage pools 1-S, the DST client module issues activation status change requests 350, via the network 24, to the DST execution units of storage pool generations 1-S. For example, the DST client module 34 generates activation status change requests of generations 1-3 to indicate inactive power off for each DST execution unit and sends, via the network 24, the activation status change requests of generations 1-3 to the DST execution units of the storage pool generations 1-3. Next, the DST client module 34 generates activation status change requests of generation S to indicate active power on for each DST execution unit and sends, via the network 24, the activation status change request of generation to the DST execution units of S of the storage pool generation S.

FIG. 40B illustrates an example of initial steps of the accessing of the plurality of data objects stored in the plurality of storage pool generations 1-S. In an example of operation of the accessing of the plurality of data objects, the first module, when operable within the DST client module 34, causes the DST client module 34 to receive, directly from one or more user devices 14 or indirectly via the network 24 from the one or more user devices 14, a plurality of data access requests regarding the plurality of data objects. For example, the DST client module 34 receives write requests 354 and read requests 356. For instance, the DST client module 34 receives write requests 354 and read requests 356 for data objects associated with storage pool generation S, one or more read requests 356 for one or more data objects associated with storage pool generation 3, receives one or more write requests 354 for one or more data objects associated with storage pool generation 3, and receives one or more read requests 356 for one or more data objects associated with storage pool generation 2.

Having received the plurality of data access requests, the second module, when operable within the DST client module 34, causes the DST client module 34 to, as individual data access requests of the plurality of data access requests are received, for each of the individual data access requests, identifies a corresponding one of the plurality of logical storage pools. The data access request may include a request for one or more data segments of a plurality of data segments when the data object is divided into the plurality of data segments prior to storage in the DSN. As a specific example of identifying the corresponding one of the plurality of logical storage pools, the DST client module 34 interprets a field within the individual data access request, where the field includes data regarding one or more of a data identifier, a generation value, a vault identifier, a timestamp, user preference, a DSN data access priority, and a logical storage pool identifier. As another specific example, the DST client module 34 determines a data access trait (e.g., data access trait includes one or more of age of the data object, data object type, and data object storage status corresponding to a storage level of the DSN) of the data object of the individual data access request. For instance, the DST client module 34 determines that the age of the data object is included in an oldest data access trait.

Having identified the corresponding one of the plurality of logical storage pools, the DST client module 34 determines power based access status of the corresponding one of the plurality of logical storage pools. As a specific example, the DST client module 34 accesses, within a system registry, a power-based data access plan of the corresponding one of the plurality of logical storage pools. When the power based access status is the power saving mode, the DST client module 34 queues the individual data access request in the request queue memory 348. For instance, the DST client module 34 stores a read request 356 for a data object associated with storage pool generation 3 in the request queue memory 348. In another instance, the DST client module 34 stores a write request 354 for a data object associated with storage pool generation 3 in the request queue memory 348. In yet another instance, the DST client module 34 stores a read request 356 for a data object associated with storage pool generation 2 in the request queue memory 348.

When the power based access status is not in the power saving mode, the DST client module 34 executes the individual data access request. As a specific example, the DST client module 34 issues, via the network 24, slice access requests for generation S to the storage pool generation S and receives, via the network 24, slice access responses for generation S from the storage pool generation S when the individual data access request is for a data object associated with storage pool generation S and storage pool generation S is not in the power saving mode.

FIG. 40C illustrates an example of further steps of the accessing of the plurality of data objects stored in the plurality of storage pool generations 1-S. In an example of operation of the accessing of the plurality of data objects, the second module, when operable within the DST client module 34, causes the DST client module 34 to retrieve, from the request queue memory 348, a queued individual data access request. For example, the DST client module 34 retrieves a read request for a data object stored in the storage pool generation 3.

Having retrieved the queued individual data access request, the DST client module 34 sends, via the network 24, an activation power on command to a desired set of storage devices affiliated with a corresponding one of the plurality of logical storage pools. For instance, the DST client module 34 generates activation status change requests 350 that includes the activation power on command, and sends, via the network 24, the activation status change requests 350 to at least some of the DST execution units 1-16 of the storage pool generation 3. The generation of the activation status change requests 350 includes power status for each of the DST execution units in accordance with the power based access plan. For instance, the DST client module 34 generates activation status change requests to include the activation power on command for DST execution units 1-12 when the queued individual data access request is the read request and a read threshold number associated with the storage pool generation 3 is 12.

Having received the activation status change requests for generation 3, each DST execution unit of the storage pool generation 3 facilitates implementation of the power based access plan for the storage pool generation 3. For example, DST execution units 1-12 update internal operations to correspond to changing from inactive power down to active power on to facilitate processing of subsequent read slice requests.

Alternatively, the DST client module 34 processes queued data access requests in accordance with a group approach. In an example of operation utilizing the group approach, the second module, when operable within the DST client module 34, causes the DST client module 34 to organize queued individual data access requests into groups of requests based on the plurality of logical storage pools such that a group of requests of the groups of requests is affiliated with a given one of the plurality of logical storage pools. As a specific example, the DST client module 34 organizes all read requests for data objects associated with generation 3 as a group, organizes all write requests for data objects associated with generation 3 as another group, and organizes all read requests for data objects associated with generation 2 as yet another group.

Having organized the queued individual data access requests into groups of requests, the DST client module 34 retrieves, from the request queue memory 348, a group of queued individual data access requests. The retrieving may include prioritizing retrieving one group over another group of queued individual data access requests based on one or more of a data access request type, a priority level associated with the data access request type, a power consumption factor associated with the data access type, a storage level of the DSN (e.g., priority level by generation), a power consumption factor associated with the storage level of the DSN, and a priority level associated with the storage level of the DSN. For example, the DST client module 34 retrieves the group of read requests for the data objects associated with the generation 3 when read requests are prioritized over write requests and a most recent generation is associated with a highest priority level over older generations.

Having retrieved the group of queued individual data access requests, the DST client module 34 sends, via the network 24, the activation power on command to the desired set of storage devices affiliated with the corresponding one of the plurality of logical storage pools. The sending may include determining whether to send the activation power on command based on one or more of a number of queued individual data access requests of the group, a group threshold level, a predetermination, an estimated power utilization level, and a power utilization threshold level. As a specific example, the DST client module 34 generates the activation status change requests 350 that includes the activation power on command, and sends, via the network 24, the activation status change requests 350 to DST execution units 1-12 of the storage pool generation 3 when the group that includes the read requests, the read threshold is 12, and the number of queued individual data access requests of the group is greater than the group threshold level.

FIG. 40D illustrates an example of more further steps of the accessing of the plurality of data objects stored in the plurality of storage pool generations 1-S. In an example of operation of the accessing of the plurality of data objects, the second module, having sent the activation power on command to the desired set of storage units affiliated with a corresponding one of the plurality of logical storage pools, when operable within the DST client module 34, causes the DST client module 34 to generate execute access request commands for the desired set of storage devices. When the queued individual data access request is a read request, the DST client module 34 determines a read threshold number of storage devices as the desired set of storage devices. For instance, the DST client module 34 determines the read threshold number of storage devices as DST execution units 1-12 when the DST client module 34 obtains power status for the DST execution units 1-16 of the storage pool generation 3. Having determined the read threshold number of storage devices, the DST client module 34 generates a plurality of read commands as the execute access request commands. For instance, the DST client module 34 generates a plurality of read slice requests for generation 3 based on a read request for a data object stored in storage pool generation 3.

When the desired set of storage devices are in an active power on mode, the DST client module 34 sends the execute access request commands to the desired set of storage devices for execution. As a specific example, the DST client module 34 sends, via the network 24, the read slice requests for generation 3 to DST execution units 1-12 of the storage pool generation 3. Alternatively, the DST client module 34 sends the read slice request for generation 3 to DST execution units 1-16 of the storage pool generation 3.

Alternatively, when the DST client module 34 processes the queued data access requests in accordance with the group approach, and the DST client module 34 has retrieved the group of queued individual data access requests and sent the activation power on command to the desired set of storage devices affiliated with the corresponding one of the plurality of logical storage pools, the DST client module 34 generates, for each of the queued individual data access requests, execute access request commands for the desired set of storage devices to produce a group of execute access request commands. For instance, the DST client module 34 generates multiple sets of read slice requests for generation 3 for multiple read requests.

When the desired set of storage devices are in an active power on mode, the DST client module 34 sends the group of execute access request commands to the desired set of storage devices for execution. As a specific example, the DST client module 34 sends, via the network 24, the multiple sets of read slice requests for generation 3 to DST execution units 1-12 of storage pool generation 3. For instance, the DST client module 34 sends the multiple sets of read slice requests substantially at the same time. In another instance, the DST client module 34 sends each set of read slice requests separately. Having received the multiple sets of read slice requests for generation 3, the DST execution units 1-12 of storage pool generation 3 issues read slice responses for generation 3, via the network 24, to the DST client module 34. The DST client module 34 dispersed storage error decodes received encoded data slices of the read slice responses to reproduce a data object. Having reproduce the data object, the DST client module 34 issues one or more read responses 358 to one or more of the user devices 14, where a read response of the one or more read responses 358 includes the reproduced data object.

When the desired set of storage devices have executed the group of execute access request commands, the DST client module 34 may send an inactivation power down command to the desired set of storage devices when there are no more groups of requests associated with the desired set of storage devices. For instance, the DST client module 34 issues more activation status change requests 350 to the DST execution units 1-12 of the storage pool generation 3, where the more activation status change requests 350 includes the inactivation power down command for the DST execution units 1-12.

FIG. 40E illustrates an example of still further steps of the accessing of the plurality of data objects stored in the plurality of storage pool generations 1-S. In an example of operation of the accessing of the plurality of data objects, the second module, having retrieved the queued individual data access request (e.g., the read request for generation 3), sent the activation power on command to the desired set of storage units (e.g., DST execution units 1-12) affiliated with the corresponding one of the plurality of logical storage pools (e.g., storage pool generation 3), generated the execute access request commands (e.g., the read slice requests for generation 3) for the desired set of storage devices, and sent the execute access request commands to the desired set of storage devices for execution, when operable within the DST client module 34, causes the DST client module 34 to retrieve, from the request queue memory 348 another queued individual data access request. For instance, the DST client module 34 retrieves a write request for storage pool generation 3 after exhausting the previously retrieved read requests for storage pool generation 3. Alternatively, the DST client module 34 retrieves, from the request queue memory 348, another group of queued individual data access requests. For instance, the DST client module 34 retrieves a group of write requests for storage pool generation 3 after exhausting the previously retrieved group of read requests for storage pool generation 3.

Having retrieved the other queued individual data access request, the DST client module 34 sends, via the network 24, another activation power on command to the desired set of storage devices affiliated with the corresponding one of the plurality of logical storage pools (e.g., storage pool generation 3). For instance, the DST client module 34 generates activation status change requests 350 that includes the activation power on command, and sends, via the network 24, the activation status change requests 350 to at least some of the DST execution units 1-16 of the storage pool generation 3. The generation of the activation status change requests 350 includes power status for each of the DST execution units in accordance with the power based access plan. For instance, the DST client module 34 generates activation status change requests to include the activation power on command for DST execution units 1-14 when the queued individual data access request is the write request and a write threshold number associated with the storage pool generation 3 is 14. In another instance, the DST client module 34 generates the activation status change requests to include the activation power on command for DST execution units 13-14 when the DST execution units 1-12 are already powered on, the queued individual data access request is the write request and the write threshold number associated with the storage pool generation 3 is 14.

Having received the activation status change requests for generation 3, each DST execution unit of the storage pool generation 3 facilitates implementation of the power based access plan for the storage pool generation 3. For example, DST execution units 13-14 update internal operations to correspond to changing from inactive power down to active power on to facilitate processing of subsequent write slice requests.

Alternatively, the DST client module 34 processes queued data access requests in accordance with the group approach. In another example of operation utilizing the group approach, having retrieved the group of queued individual data access requests, the second module, when operable within the DST client module 34, causes the DST client module 34 to send, via the network 24, the activation power on command to the desired set of storage devices affiliated with the corresponding one of the plurality of logical storage pools. The sending may include determining whether to send the activation power on command based on one or more of a number of queued individual data access requests of the group, a group threshold level, a predetermination, an estimated power utilization level, and a power utilization threshold level. As a specific example, the DST client module 34 generates the activation status change requests 350 that includes the activation power on command, and sends, via the network 24, the activation status change requests 350 to DST execution units 13-14 of the storage pool generation 3 when the group that includes the write requests, the write threshold is 14, and the number of queued individual data access requests of the group is greater than the group threshold level.

FIG. 40F illustrates an example of even still further steps of the accessing of the plurality of data objects stored in the plurality of storage pool generations 1-S. In an example of operation of the accessing of the plurality of data objects, the second module, having sent the activation power on command to the desired set of storage units affiliated with a corresponding one of the plurality of logical storage pools, when operable within the DST client module 34, causes the DST client module 34 to generate execute access request commands for the desired set of storage devices. When the queued individual data access request is a write request, the DST client module 34 determines a write threshold number of storage devices as the desired set of storage devices. For instance, the DST client module 34 determines the write threshold number of storage devices as DST execution units 1-14 when the DST client module 34 obtains power status for the DST execution units 1-16 of the storage pool generation 3. Having determined the write threshold number of storage devices, the DST client module 34 generates a plurality of write commands as the execute access request commands. For instance, the DST client module 34 generates a plurality of write slice requests for generation 3 based on a write request for a data object stored in storage pool generation 3.

When the desired set of storage devices are in an active power on mode, the DST client module 34 sends the execute access request commands to the desired set of storage devices for execution. As a specific example, the DST client module 34 sends, via the network 24, the write slice requests for generation 3 to DST execution units 1-14 of the storage pool generation 3. Alternatively, the DST client module 34 sends the write slice request for generation 3 to DST execution units 1-16 of the storage pool generation 3.

Alternatively, when the DST client module 34 processes the queued data access requests in accordance with the group approach, and the DST client module 34 has retrieved the group of queued individual data access requests and sent the activation power on command to the desired set of storage devices affiliated with the corresponding one of the plurality of logical storage pools, the DST client module 34 generates, for each of the queued individual data access requests, execute access request commands for the desired set of storage devices to produce a group of execute access request commands. For instance, the DST client module 34 generates multiple sets of write slice requests for generation 3 for multiple write requests.

When the desired set of storage devices are in an active power on mode, the DST client module 34 sends the group of execute access request commands to the desired set of storage devices for execution. As a specific example, the DST client module 34 sends, via the network 24, the multiple sets of write slice request for generation 3 to DST execution units 1-14 of storage pool generation 3. For instance, the DST client module 34 sends the multiple sets of write slice requests substantially at the same time. In another instance, the DST client module 34 sends each set of write slice requests separately. Having sent the write requests for generation 3 to the DST execution units 1-14, the DST client module 34 receives write slice responses for generation 3, and issues write responses 360 (e.g., to include an indication of a success level of the writing) to one or more of the user devices 14 based on the received write slice responses for generation 3.

When the desired set of storage devices have executed the group of execute access request commands, the DST client module 34 may send an inactivation power down command to the desired set of storage devices when there are no more groups of requests associated with the desired set of storage devices. For instance, the DST client module 34 issues still more activation status change requests 350 to the DST execution units 1-14 of the storage pool generation 3, where the still more activation status change requests 350 includes the inactivation power down command for the DST execution units 1-14 when there are no more access requests for storage pool generation 3.

FIG. 40G illustrates an example of still more steps of the accessing of the plurality of data objects stored in the plurality of storage pool generations 1-S. In an example of operation of the accessing of the plurality of data objects, the second module, having processed substantially all of the data access requests associated with higher priority storage levels of the DSN (e.g., processed read requests and a requests for the storage pool generation 3), when operable within the DST client module 34, causes the DST client module 34 to retrieve, from the request queue memory 348 yet another queued individual data access request. For instance, the DST client module 34 retrieves a read request for storage pool generation 2 after exhausting the previously retrieved read and write requests for storage pool generation 3. Alternatively, the DST client module 34 retrieves, from the request queue memory 348, yet another group of queued individual data access requests. For instance, the DST client module 34 retrieves a group of read requests for storage pool generation 2 after exhausting the previously retrieved group of read and write requests for storage pool generation 3 when data access requests for storage pool generation 3 are prioritized ahead of data access requests for storage pool generation 2.

Having retrieved the yet another queued individual data access request, and having deactivated the set of storage devices affiliated with previous data access (e.g., sending activation status change requests for generation 3 to power down the DST execution units 1-16 of storage pool generation 3), the DST client module 34 sends, via the network 24, yet another activation power on command to another desired set of storage devices affiliated with another corresponding one of the plurality of logical storage pools (e.g., storage pool generation 2). For instance, the DST client module 34 generates activation status change requests 350 that includes the activation power on command, and sends, via the network 24, the activation status change requests 350 to at least some of the DST execution units 1-16 of the storage pool generation 2.

The generation of the activation status change requests 350 includes power status for each of the DST execution units in accordance with the power based access plan. For instance, the DST client module 34 generates activation status change requests 350 to include the activation power on command for DST execution units 1-12 when the queued individual data access request is the read request and a read threshold number associated with the storage pool generation 2 is 12.

Having received the activation status change requests for generation 2, each DST execution unit of the storage pool generation 2 facilitates implementation of the power based access plan for the storage pool generation 3. For example, DST execution units 1-12 update internal operations to correspond to changing from inactive power down to active power on to facilitate processing of subsequent read slice requests.

Alternatively, the DST client module 34 processes queued data access requests in accordance with the group approach. In another example of operation utilizing the group approach, having retrieved the group of queued individual data access requests, the second module, when operable within the DST client module 34, causes the DST client module 34 to send, via the network 24, the activation power on command to the other desired set of storage devices affiliated with the corresponding one of the plurality of logical storage pools. The sending may include determining whether to send the activation power on command based on one or more of a number of queued individual data access requests of the group, a group threshold level, a predetermination, an estimated power utilization level, and a power utilization threshold level. As a specific example, the DST client module 34 generates the activation status change requests 350 that includes the activation power on command, and sends, via the network 24, the activation status change requests 350 to DST execution units 1-12 of the storage pool generation 2 when the group that includes the read requests, the read threshold is 12, and the number of queued individual data access requests of the group is greater than the group threshold level.

FIG. 40H illustrates an example of still more steps of the accessing of the plurality of data objects stored in the plurality of storage pool generations 1-S. In an example of operation of the accessing of the plurality of data objects, the second module, having sent the activation power on command to the other desired set of storage units affiliated with another corresponding one of the plurality of logical storage pools, when operable within the DST client module 34, causes the DST client module 34 to generate execute access request commands for the other desired set of storage devices. When the queued individual data access request is a read request, the DST client module 34 determines a read threshold number of storage devices as the other desired set of storage devices. For instance, the DST client module 34 determines the read threshold number of storage devices as DST execution units 1-12 when the DST client module 34 obtains power status for the DST execution units 1-16 of the storage pool generation 2. Having determined the read threshold number of storage devices, the DST client module 34 generates a plurality of read commands as the execute access request commands. For instance, the DST client module 34 generates a plurality of read slice requests for generation 2 based on a read request for a data object stored in storage pool generation 2.

When the desired set of storage devices are in an active power on mode, the DST client module 34 sends the execute access request commands to the desired set of storage devices for execution. As a specific example, the DST client module 34 sends, via the network 24, the read slice requests for generation 2 to DST execution units 1-12 of the storage pool generation 2. Alternatively, the DST client module 34 sends the read slice request for generation 2 to DST execution units 1-16 of the storage pool generation 2.

Alternatively, when the DST client module 34 processes the queued data access requests in accordance with the group approach, and the DST client module 34 has retrieved the group of queued individual data access requests and sent the other activation power on command to the other desired set of storage devices affiliated with the other corresponding one of the plurality of logical storage pools, the DST client module 34 generates, for each of the queued individual data access requests, execute access request commands for the other desired set of storage devices to produce a group of execute access request commands. For instance, the DST client module 34 generates multiple sets of read slice requests for generation 2 for multiple read requests.

When the other desired set of storage devices are in an active power on mode, the DST client module 34 sends the group of execute access request commands to the other desired set of storage devices for execution. As a specific example, the DST client module 34 sends, via the network 24, the multiple sets of read slice request for generation 2 to DST execution units 1-12 of storage pool generation 2. For instance, the DST client module 34 sends the multiple sets of read slice requests substantially at the same time. In another instance, the DST client module 34 sends each set of read slice requests separately. Having sent the read slice requests for generation 2 to the DST execution units 1-12, the DST client module 34 receives read slice responses for generation 2, and issues read responses 362 (e.g., to include one or more desired data objects) to one or more of the user devices 14 based on the received read slice responses for generation 2.

When the other desired set of storage devices have executed the group of execute access request commands, the DST client module 34 may send an inactivation power down command to the other desired set of storage devices when there are no more groups of requests associated with the other desired set of storage devices. For instance, the DST client module 34 issues even more activation status change requests 350 to the DST execution units 1-12 of the storage pool generation 2, where the still more activation status change requests 350 includes the inactivation power down command for the DST execution units 1-12 when there are no more access requests for storage pool generation 2.

FIG. 40I is a flowchart illustrating an example of power control in a dispersed storage network (DSN). The method begins at step 370 where a processing module (e.g., of a distributed storage and task (DST) processing module) receives a plurality of data access requests regarding a plurality of data objects, where a data object of the plurality of data objects is distributedly stored in a set of storage devices of a plurality of storage devices of the DSN. The plurality of storage devices is arranged into a plurality of logical storage pools, where the set of storage devices stores data objects of the plurality of data objects having a common data access trait, and where the set of storage devices is affiliated with one of the plurality of logical storage pools. A storage device of the plurality of storage devices includes one or more of one or more memory devices within a storage unit of the DSN, one or more storage units at a site of the DSN, and one or more sites of the DSN.

As individual data access requests of the plurality of data access requests are received, for each of the individual data access requests, the method continues at step 372, where the processing module identifies a corresponding one of the plurality of logical storage pools. As a specific example, the processing module interprets a field within the individual data access request, where the field includes data regarding one or more of a data identifier, a generation value, a vault identifier, a timestamp, user preference, a DSN data access priority, and a logical storage pool identifier. As another specific example, the processing module determines a data access trait of the data object of the individual data access request, where the data access trait includes one or more of age of the data object, data object type, and data object storage status.

The method continues at step 374 where the processing module determines power based data access status of the corresponding one of the plurality of logical storage pools. As a specific example, the processing module accesses a power based data access plan for the corresponding one of the plurality of logical storage pools, where the power based data access plan indicates a power status for each of the storage devices affiliated with the corresponding one of the plurality of logical storage pools. The power status is one of active power on, inactive power off, and inactive power on. When the power based access status is in the power saving mode, the method branches to step 378. When the power based access status is not in the power saving mode, the method continues to step 376. The method continues at step 376 where the processing module executes the individual data access request when the power based access status is not in the power saving mode.

The method continues at step 378 where the processing module queues the individual data access request in a queue when the power based access status is the power saving mode. The method continues at step 380 where the processing module retrieves, from the queue, a queued individual data access request. The method continues at step 382 of the processing module sends an activation power on command to a desired set of storage devices affiliated with the corresponding one of the plurality of logical storage pools.

The method continues at step 384 where the processing module generates execute access request commands for the desired set of storage devices. When the queued individual data access request is a read request, the processing module determines a read threshold number of storage devices as the desired set of storage devices and generates a plurality of read commands as the execute access request commands. When the queued individual data access request is a write request, the processing module determines a write threshold number of storage devices as the desired set of storage devices and generates a plurality of write commands as the execute access request commands.

When the desired set of storage devices are in an active power on mode, the method continues at step 386 where the processing module sends the execute access request commands to the desired set of storage devices for execution. Alternatively, a group approach may be utilized for the retrieved individual data access requests. When the group approach is utilized, the processing module organizes queued individual data access requests into groups of requests based on the plurality of logical storage pools such that a group of requests of the group of requests is affiliated with a given one of the plurality of logical storage pools. Having organized the queued individual data access requests into groups, the processing module retrieves, from the queue, a group of queued individual data access requests and sends an activation power on command to a desired set of storage devices affiliated with the corresponding one of the plurality of logical storage pools. Having sent the activation power on command, the processing module generates, for each of the queued individual data access requests, execute access request commands for the desired set of storage devices to produce a group of execute access request commands. When the desired set of storage devices are in an active power on mode, the processing module sends the group of execute access request commands to the desired set of storage devices for execution. When the desired set of storage devices have executed the group of execute access request commands, the processing module sends an inactivation power down command to the desired set of storage devices.

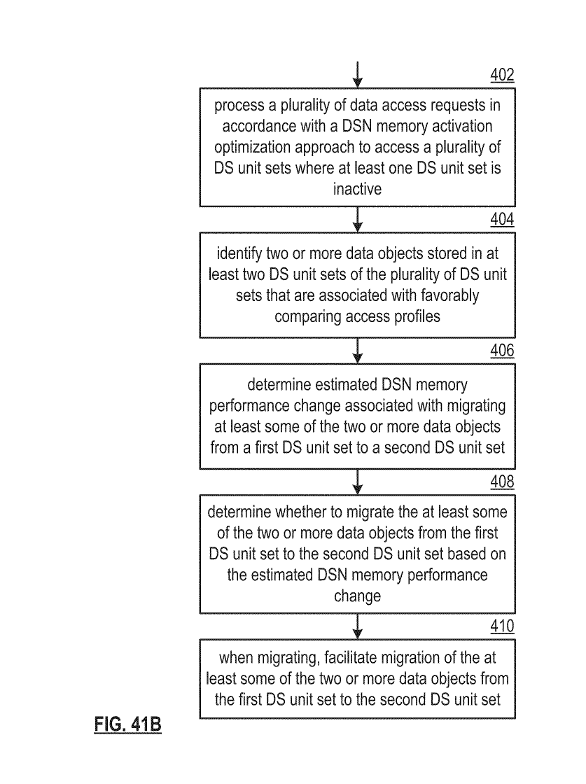

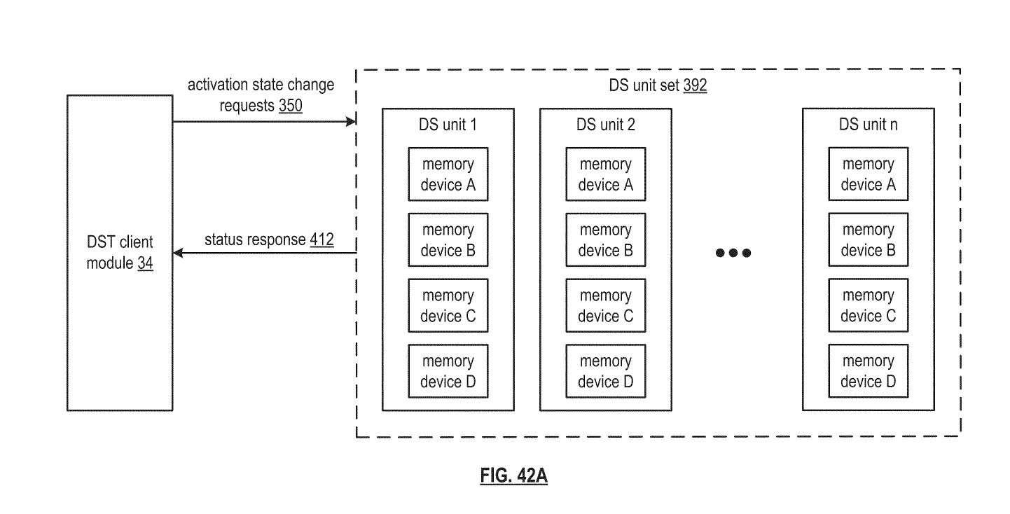

FIG. 41A is a schematic block diagram of another embodiment of a dispersed storage network (DSN) that includes at least one distributed storage and task (DST) client module 34 of FIG. 40A and a dispersed storage network (DSN) memory 390. The DSN memory 390 includes a plurality of dispersed storage (DS) units 394. The DS units 394 may be organized into one or more sets of DS units 392. Each DS unit set 392 provides a pool of storage resources accessible by the DST client module 34. Each DS unit 394 of the plurality of DS units sets 392 may be implemented utilizing one or more of a storage node, the distributed storage and task (DST) execution unit 36 of FIG. 1, a storage server, a storage unit, a storage module, a memory device, a memory, a user device, a DST processing unit, and a DST processing module. The DST client module 34 includes the request queue memory 348 of FIG. 40A for storage of pending DSN memory access requests (e.g., write requests 354, read requests 356).

The system functions to store data in the DSN memory 390 in accordance with a power management approach. Each DS unit set 392 of the plurality of DS units sets is activated and deactivated in accordance with the power management approach. Deactivation includes at least one of powering off substantially each DS unit 394 of the DS unit set 392, powering off more than a decode threshold number of DS units of the DS unit set, suspending operations of at least some of the DS units of the DS unit set, and deactivating internal resources of at least one DS unit of the DS unit set. Activation includes at least one of powering up substantially each DS unit 394 of the DS unit set 392, powering up more than the decode threshold number of DS units of the DS unit set, resuming operations of at least some of the DS units of the DS unit set, and reactivating previously deactivated internal resources of at least one DS unit of the DS unit set.

The power management approach may be executed in accordance with one or more power management factors. The one or more power management factors include a schedule, a request, and a dynamic operation. The dynamic operation may be based on one or more of real-time power provider costs, a DSN system activity level, a data object access frequency level, a data access latency performance level, a data access latency performance goal, a data security requirement, a number of pending DSN memory requests, a number of pending DSN memory requests goal, a DSN memory power consumption level, a DS unit set power consumption level, a DS unit power consumption level, the DS unit set access bandwidth level, and a DS unit set access latency level.

In an example of operation based on the power management approach, the DST client module 34 receives a plurality of data access requests. For example, the DST client module 34 receives a write request 354 to store a data object in at least one DS unit set 392. As another example, the DST client module 34 receives a read request 356 to retrieve a previously stored data object from a corresponding DS unit set 392. When a data access request is received, the DST client module 34 executes the data access request when a corresponding DS unit set 392 is active. The executing includes issuing one or more data access requests 396 to the corresponding DS unit set 392, receiving data access responses 398 from the corresponding DS unit set 392, and issuing a data access response (e.g., a write response 360, a read response 358) to a requesting entity associated with the data access request.

Alternatively, when the data access request is received, the DST client module 34 queues the data access request in a corresponding request queue associated with the corresponding DS unit set 392 when the corresponding DS unit set is inactive. For instance, the DST client module 34 stores the data access request in the request queue memory 348. The DST client module 34 may issue an activation status change request 350 to a DS unit set 392 of the plurality of DS units sets to change the activation status (e.g., from inactive to active, from active to inactive) based on the power management factors. When the activation status for a DS unit set is changed from inactive to active, the DST client module 34 may retrieve a data access request from the corresponding request queue associated with the DS unit set 392 and execute the data access request.

In another example of operation based on the power management approach, the DST client module 34 identifies two or more data objects stored in at least two DS units sets 392 that are associated with favorably comparing access profiles. The identifying includes determining whether the associated access profiles compare favorably. An access profile includes one or more of frequency of access, access time frame, requesting entity associated with the accessing, and data object identifier. For example, the DST client module 34 identifies two data objects that are associated with favorably comparing access profiles when each data object is accessed in similar time frames. For instance, similar time frames includes a first data object of the two data objects is accessed every morning around 9 AM and a second data object of the two data objects is also accessed every morning around 9 AM.

Having determined that the associated access profiles compare favorably, the DST client module 34 determines whether to migrate at least some of the two or more data objects from a first DS unit set to a second DS unit set based on a comparison of estimated DSN power management factors prior to and subsequent to a proposed migration. As a specific example, the DST client module 34 determines to migrate the first data object from the first DS unit set to the second DS unit set that includes storage of the second data object such that each of the two data objects may be accessed substantially simultaneously when the first DS unit set is inactive and the second DS unit set is inactive. The DST client module 34 facilitates migration of the at least some of the two or more data objects from the first DS unit set to the second DS unit set. The facilitating includes identifying slices of the at least some of the two or more data objects and issuing migration commands to the first DS unit set to migrate the identified slices as migration slices 400 to the second DS unit set. Alternatively, the DST client module 34 retrieves the identified slices from the first DS unit set by issuing retrieve data access requests, receives data access responses that includes retrieved slices, and issues store data access requests that includes the retrieved slices to the second DS unit set. The DST client module 34 may temporarily activate one or more of the first and second DS unit sets and issue another activation status change request 350 to activate the one or more of the first and second DS unit sets to facilitate migration.

FIG. 41B is a flowchart illustrating an example of optimizing data storage. The method begins at step 402 where a processing module (e.g., of a distributed storage and task (DST) client module) processes a plurality of data access requests in accordance with a dispersed storage network (DSN) memory activation optimization approach (e.g., DSN memory power management) to access a plurality of dispersed storage (DS) units sets where at least one DS unit set is inactive. The processing module executes a received access request immediately when a corresponding DS unit set is active. The processing module queues the received access request in a request queue when the corresponding DS unit set is inactive. The processing module may issue an activation status change request to a DS unit set to activate or deactivate the DS unit set based on the DSN memory activation optimization approach. When activating a previously inactive DS unit set, the processing module processes saved access requests from the request queue corresponding to the DS unit set.

The method continues at step 404 where the processing module identifies two or more data objects stored in at least two DS unit sets of the plurality of DS unit sets that are associated with favorably comparing access profiles. The identifying includes determining access profiles and comparing the access profiles. The determining of the access profiles includes at least one of accessing historical records, monitoring data access requests, interpreting an activation schedule, obtaining a historical activation record, and identifying frequency of access. The comparing includes correlating access profiles (e.g., correlating similar access time frames, correlating similar requesting entities for a common data object).

The method continues at step 406 where the processing module determines estimated DSN memory performance change associated with migrating at least some of the two or more data objects from a first DS unit set to a second DS unit set. The determining is in accordance with the access profiles and one or more of estimated average wait time with regards to a DS unit set activation scheduling, estimated latency, estimated performance and an estimated power consumption.

The method continues at step 408 where the processing module determines whether to migrate the at least some of the two or more data objects from the first DS unit set to the second DS unit set based on the estimated DSN memory performance change. For example, the processing module determines to migrate when the estimated DSN memory performance change compares favorably to a performance threshold (e.g., lowered access latency, lower power consumption). When migrating, the method continues at step 410 where the processing module facilitates migration of the at least some of the two or more data objects from the first DS unit set to the second DS unit set. The facilitating includes activating both DS unit sets, retrieving slices from the first DS unit set, storing the slices in the second DS unit set, and deleting the slices from the first DS unit set.

Alternatively, the processing module facilitates migration by at least one of issuing a migration request to the first DS unit set to transfer the slices to the second DS unit set, and issuing another migration request to the second DS unit set to the retrieve the slices from the first DS unit set. The processing module may modify an activation schedule based on confirmation of migration of the slices. For example, the activation schedules change to further limit activation of one DS unit set.

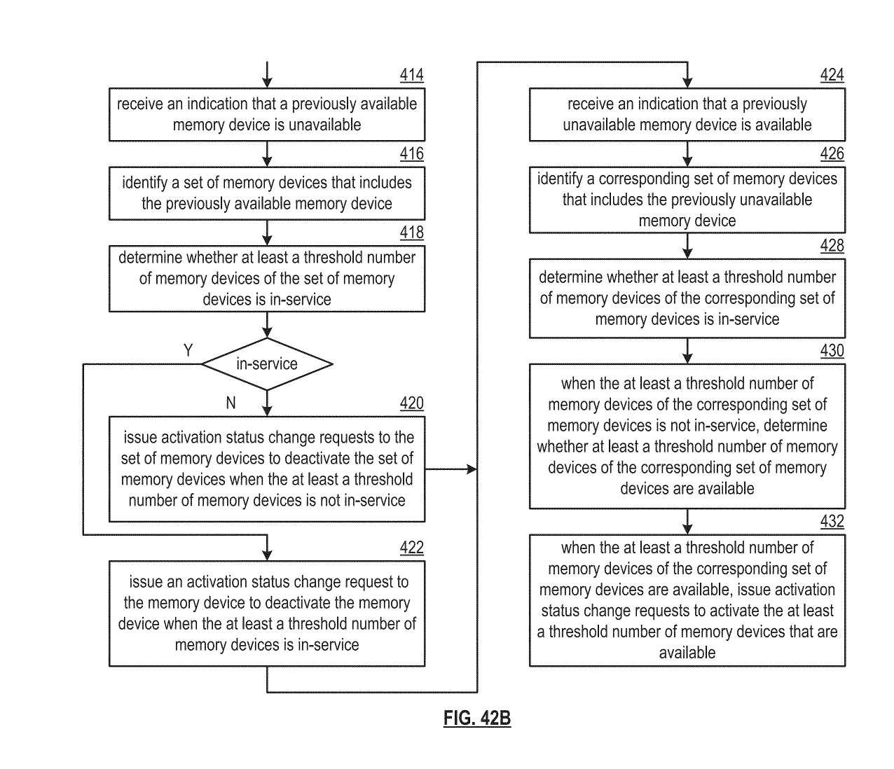

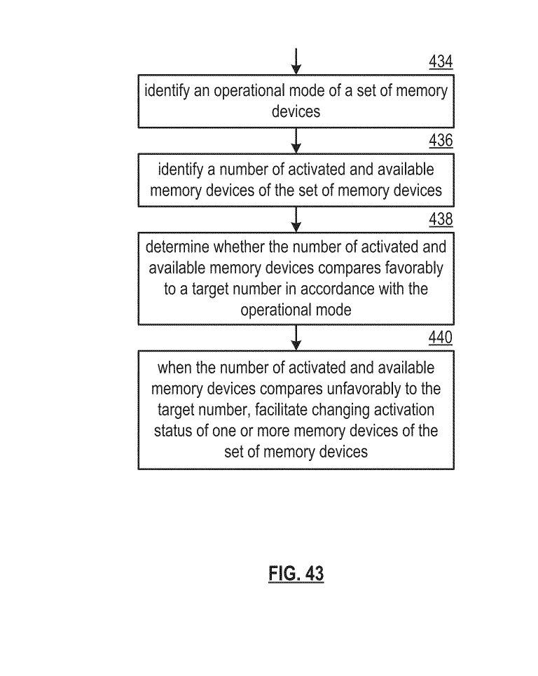

FIG. 42A is a schematic block diagram of another embodiment of a dispersed storage network (DSN) that includes at least one distributed storage and task (DST) client module 34 of FIG. 40A and the dispersed storage (DS) unit set 392 of FIG. 41A. The DS unit set 392 includes a set of n DS units 1-n. Each DS unit of the set of DS units 1-n may be implemented utilizing one or more of the DST execution unit 36 of FIG. 1, a storage node, a distributed storage and task (DST) execution unit, a storage server, a storage unit, a storage module, a memory device, a memory, a user device, a DST processing unit, and a DST processing module. Each DS unit includes a plurality of any number of memory devices (e.g., optical disc memory device, a magnetic disk memory device, solid-state memory device). For example, each DS unit includes memory devices A-D when four memory devices are utilized per DS unit.

The DS unit set 392 functions to store one or more sets of encoded data slices. Each set of encoded data slices is stored in a corresponding set of memory devices. For example, a first encoded data slice of a first set of encoded data slices is stored in memory device A of DS unit 1, a second encoded data slice of the first set of encoded data slices is stored in memory device A of DS unit 2, etc. As another example, a first encoded data slice of a second set of encoded data slices is stored in memory device B of DS unit 1, a second encoded data slice of the second set of encoded data slices is stored in memory device B of DS unit 2, etc.

Each set of memory devices is utilized for storage of data in accordance with an activation state associated with each memory device of the set of memory devices. The system functions to modify the activation state of each memory device in accordance with an availability status of the set of memory devices. The activation state includes an active state and an inactive state. When active, the memory device may be utilized for access (e.g., store/retrieve a slice). When inactive, the memory device is not utilized for access (e.g., in an out of service condition).

In an example of operation, the DST client module 34 issues an activation change state request 350 to a DS unit with regards to a memory device to change the activation state of the memory device. The activation change state request 350 includes at least one of an activate request and an inactivate request. When receiving the inactivate request, a receiving DS unit deactivates a corresponding memory device of the inactivate request. Deactivation includes at least one of powering off the corresponding memory device, lowering power to the corresponding memory device (e.g., spinning a magnetic disk memory device at a lower speed), suspending access to the corresponding memory device, and deactivating other internal resources associated with one or more of the corresponding memory device and the receiving DS unit. When receiving the activate request, the receiving DS unit activates the corresponding memory device of the activate request. Activation includes at least one of powering up the corresponding memory device, raising power to the corresponding memory device (e.g., spinning the magnetic disk memory device at a higher speed), resuming access to the corresponding memory device, and reactivating the other internal resources associated with the one or more of the corresponding memory device and the receiving DS unit.

The availability status includes available status and unavailable status. When available, the memory device may be activated to enable access in an in-service condition. The in-service condition occurs when the memory device is available and activated. When unavailable, the memory device may not be activated and remains in the out of service condition. An available memory device indicates that a level of potential utilization compares favorably to an expected level of utilization. For example, the available memory device is capable of full operation. An unavailable memory device indicates that the level of potential utilization compares unfavorably to the expected level of utilization. For example, the unavailable memory device is incapable of full operation (e.g., failed, errors greater than an error threshold, etc.)

In an example of operation to deactivate a set of memory devices, the DST client module 34 receives a status response 412 from a DS unit indicating that a previously available memory device associated with the DS unit is now unavailable. The receiving includes at least one of receiving an error message, detecting that the memory device is nonresponsive within an expected response timeframe, and receiving the status response 412 to include an unavailable memory device identifier (ID). The DST client module 34 identifies a set of memory devices that includes the memory device. The identifying includes at least one of accessing a memory device set table, identifying an address range associated with the memory device, and identifying a set of memory devices based on the address range associated with the memory device. For example, the DST client module 34 identifies a set of memory devices B when the memory device is memory device B of a DS unit of a set of DS units corresponding to the set of memory devices B.

The DST client module 34 determines whether at least a threshold number of memory devices of the set of memory devices are in-service (e.g., active and available). The threshold number includes at least one of a decode threshold associated with a dispersed storage error coding function utilized to encode a data segment to produce a set of encoded data slices that are stored in the set of memory devices, a read threshold, a write threshold, an in-service threshold, and a pillar width. The determining includes at least one of initiating a query, receiving a response, accessing an active memory device list, accessing an available memory device list, receiving an availability status from at least some of the memory devices of the set of memory devices, receiving an activation state from the at least some of the memory devices of the set of memory devices, and obtaining a memory device set in-service indicator.

When the at least a threshold number of memory devices is not in-service, DST client module 34 issues activation status change requests 350 to the set of memory devices to deactivate the set of memory devices such that each memory device of the set of memory devices is out of service. Alternatively, the DST client module 34 issues the activation status change request 350 to deactivate the set of memory devices only when the number of in-service memory devices is the threshold number minus one indicating that the number of in-service memory devices has just fallen below the threshold number (e.g., to facilitate only sending the deactivation once). When the at least a threshold number of memory devices is in-service (e.g., still in-service even after receiving the unavailable status response), the DST client module 34 issues an activation status change request 350 to the memory device that includes a deactivation request to take the memory device out of service.

In an example of operation to activate the set of memory devices, the DST client module 34 receives a status response 412 from a DS unit indicating that a previously unavailable memory device associated with the DS unit is now available. The receiving includes at least one of receiving an error message, detecting that the memory device is responsive within the expected response timeframe, and receiving the status response 412 to include an available memory device identifier (ID).

Having received the status response 412, the DST client module 34 identifies the set of memory devices that includes the memory device. The DST client module 34 determines whether at least a threshold number of memory devices of the set of memory devices is in-service (e.g., indicating that the set of memory devices is in-service). When the at least a threshold number of memory devices is not in-service (e.g., the set of memory devices is not in-service), the DST client module 34 determines whether at least a threshold number of memory devices of the set of memory devices are available. When the at least a threshold number of memory devices of the set of memory devices is available, the DST client module 34 issues activation status change requests 350 to the at least a threshold number of memory devices that are available to activate the at least a threshold number of memory devices that are available.

FIG. 42B is a flowchart illustrating an example of optimizing data storage performance. The method begins at step 414 where a processing module (e.g., of a distributed storage and task (DST) client module) receives an indication that a previously available memory device is unavailable. The method continues at step 416 where the processing module identifies a set of memory devices that includes the previously available memory device. The identifying includes at least one of a lookup based on a common DSN address range affiliation by source name, receiving a memory device set identifier (ID), initiating a query, and receiving a response.

The method continues at step 418 where the processing module determines whether at least a threshold number of memory devices of the set of memory devices is in-service (e.g., available and activated). The determining includes at least one of performing a status table lookup, initiating a query, receiving a response, receiving a message, and performing a test. The threshold number includes at least one of a decode threshold number, a read threshold number, a write threshold number, an in-service threshold number, and a pillar width number. The method branches to step 422 when the at least a threshold number of memory devices is in-service. The method continues to step 420 when the at least a threshold number of memory devices is not in-service. The method continues at step 420 where the processing module issues activation status change requests to the set of memory devices to deactivate the set of memory devices when the at least a threshold number of memory devices is not in-service. The method branches to step 424. The method continues at step 422 where the processing module issues an activation status change request to the memory device to deactivate the memory device when the at least a threshold number of memory devices is in-service.

The method continues at step 424 where the processing module receives an indication that a previously unavailable memory device is available. The receiving includes at least one of obtaining the indication, receiving a status response, accessing a message, and receiving an error indication. The method continues at step 426 where the processing module identifies a corresponding set of memory devices that includes the previously unavailable memory device. The identifying includes at least one of a lookup based on a common DSN address range affiliation by source name, receiving a corresponding memory device set identifier (ID), initiating a query, and receiving a response. The method continues at step 428 where the processing module determines whether at least a threshold number of memory devices of the corresponding set of memory devices is in-service. The determining includes at least one of performing a status table lookup, initiating a query, receiving a response, receiving a message, and performing a test.

When the at least a threshold number of memory devices of the corresponding set of memory devices is not in-service, the method continues at step 430 where the processing module determines whether at least a threshold number of memory devices of the corresponding set of memory devices are available. The determining includes at least one of performing an availability table lookup, initiating a query, receiving a response, receiving a message, and performing a test. When the at least a threshold number of memory devices of the corresponding set of memory devices are available, the method continues at step 432 where the processing module issues activation status change requests to activate the at least a threshold number of memory devices that are available.

FIG. 43 is a flowchart illustrating another example of optimizing data storage performance. The method begins at step 434 where a processing module (e.g., of a dispersed storage (DS) processing module) identifies an operational mode of a set of memory devices. The operational mode includes at least one of a read-only mode and a read and write mode. The identifying includes at least one of performing a lookup, initiating a query, receiving a response, determining the operational mode based on one or more of memory availability, memory capacity, a dispersed storage network (DSN) memory performance level, and a DSN memory performance goal threshold. The method continues at step 436 where the processing module identifies a number of activated and available memory devices of the set of memory devices (e.g., in-service memory devices). The identifying includes at least one of performing a lookup, initiating a query, receiving a response, and receiving identifiers.

The method continues at step 438 where the processing module determines whether the number of activated and available memory devices compares favorably to a target number in accordance with the operational mode. For example, while in the read mode, the target number is a read threshold which is greater than or equal to a decode threshold. As another example, while in the read and write mode, the target number is a write threshold which is greater than or equal to the read threshold. The processing module indicates favorable when the number of activated and available memory devices is greater than the target number.

When the number of activated and available memory devices compares unfavorably to the target number, the method continues at step 440 where the processing module facilitates changing activation status of one or more memory devices of the set of memory devices. The facilitating includes issuing activation status change requests to the one or more memory devices that includes an activate request when the number of active unavailable memory devices is less than the target number and includes a deactivate request when the number of active unavailable memory devices is greater than the target number.

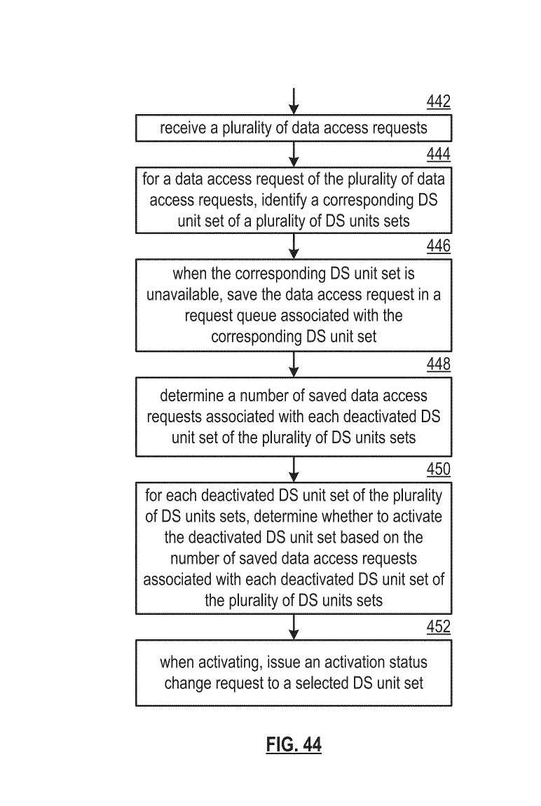

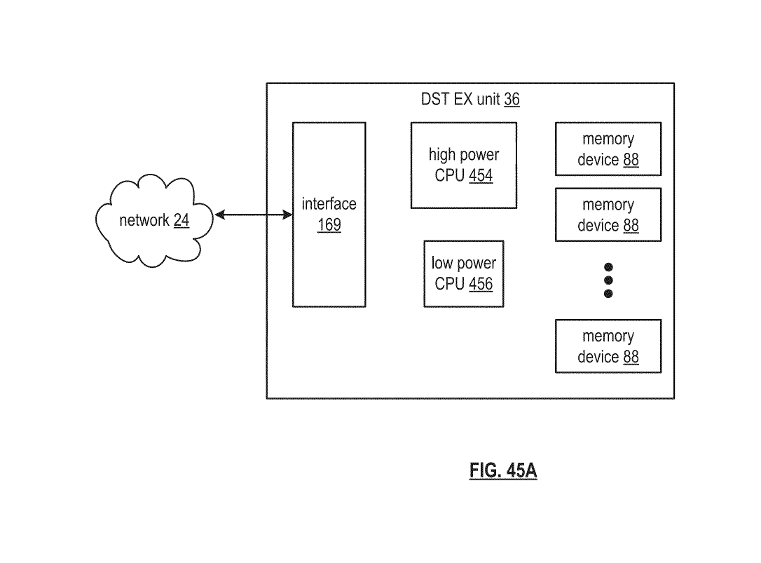

FIG. 44 is a flowchart illustrating an example of optimizing data access. The method begins at step 442 where a processing module (e.g., of a dispersed storage (DS) processing module) receives a plurality of data access requests. The method continues at step 444 where, for a data access request of the plurality of data access requests, the processing module identifies a corresponding DS unit set of a plurality of DS unit sets. When the corresponding DS unit set is unavailable, the method continues at step 446 where the processing module saves the data access request in a request queue associated with the corresponding DS unit set. The processing module determines whether the corresponding DS unit set is unavailable based on at least one of a query, a lookup, initiating a test, receiving a result, and accessing a schedule.

The method continues at step 448 where the processing module determines a number of saved data access requests associated with each deactivated DS unit set of the plurality of DS unit sets. The determining may be based on one or more of initiating a query, receiving a response, performing a lookup, and receiving information. For each deactivated DS unit set of the plurality of DS unit sets, the method continues at step 450 where the processing module determines whether to activate the deactivated DS unit set based on the number of saved data access requests associated with each deactivated DS unit set of the plurality of DS unit sets. The determining may be based on one or more of comparing a number of saved data access requests, identifying a DS unit set with a greatest number of saved data access requests as a select a DS unit set, selecting all DS unit sets with a number of saved data access requests greater than a saved threshold, selecting based on availability of other system entities including user devices in DS processing modules, and selecting based on proximity of the DS unit set to requesting entities (e.g., select closest).

When activating, the method continues at step 452 where the processing module issues an activation status change request to a selected DS unit set. The issuing includes generating the activation status change request to include an activate request based on the determining whether to change the activation status. The issuing further includes outputting the activation status change request to the selected DS unit set.

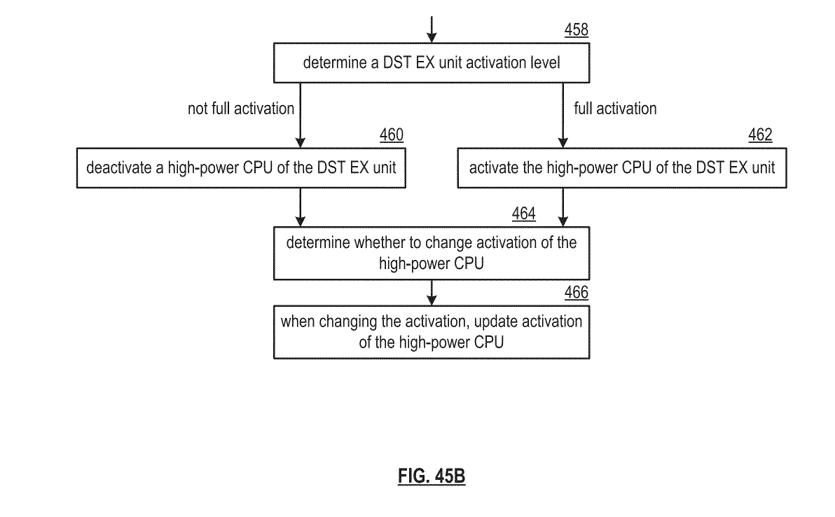

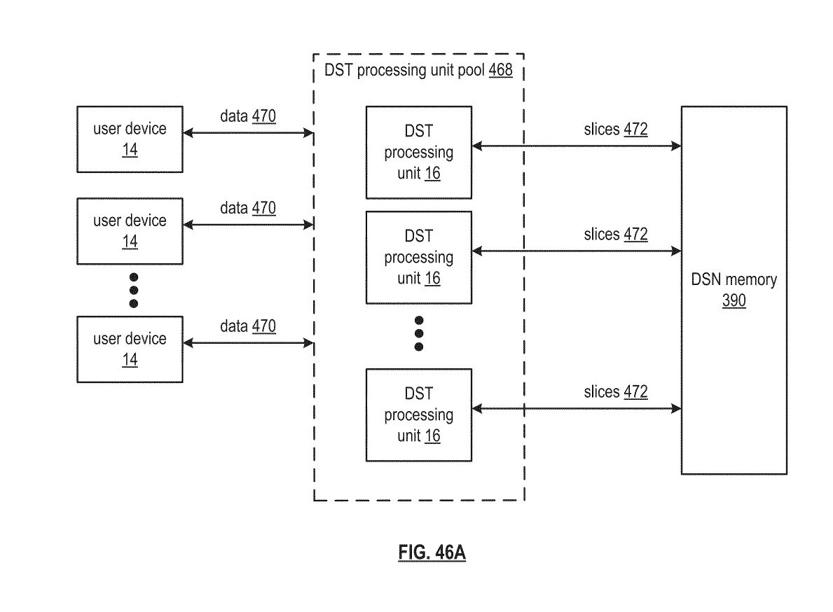

FIG. 45A is a schematic block diagram of another embodiment of a distributed storage and task (DST) execution unit 36 that includes the interface 169 of FIG. 11, the network 24 of FIG. 1, at least one high-power central processing unit (CPU) 454, at least one low-power CPU 456, and a plurality of the memory devices 88 of FIG. 3. The DST execution unit 36 may be implemented utilizing one or more of a storage node, a dispersed storage unit, a storage server, a storage unit, a storage module, a memory system, a memory, a user device, the DST processing unit 16 of FIG. 1, and a DST processing module. Each memory device 88 may be implemented utilizing one of an optical disc, a magnetic disk, and solid-state memory. The high-power CPU 454 and the low-power CPU 456 may be implemented utilizing one or more of a computer, a computer card, a computer module, the processing module, a microcontroller, a microprocessor, and a floating-point gate array.

The high-power CPU 454 provides a processing resource to perform one or more functions including transferring a slice via the interface 169 from the network 24 to a memory device 88, transferring a slice from a memory device 88 via the interface 169 to the network 24, performing a rebuilding function to rebuild a slice associated with a slice error, performing a distributed computing partial task on one or more slices stored in one or more memory devices 88 of the plurality of memory devices to produce one or more partial results, transferring partial results via the interface 169 to the network 24, and migrating one or more slices from one or more memory devices 88 to one or more other memory devices and/or via the interface 169 to the network 24.

The low-power CPU 456 provides another processing resource to perform one or more functions including limited transfer of slices between the plurality of memories 88 and via the interface 169 to the network 24, sending and receiving, via the interface 169, a limited number of DS unit commands, providing sleep mode sentinel functions (e.g., to respond to a wake-up command), facilitating activation/deactivation of the high-power CPU 454, and facilitating activation/deactivation of one or more memory devices 88 of the plurality of memory devices. The low-power CPU 456 is capable of fewer operations per second than the high-power CPU 454. The low-power CPU 456 consumes less power than the high-power CPU 454.

The DST execution unit 36 functions to optimize resource utilization to perform functions associated with the DST execution unit 36. In particular, the DST execution unit 36 is operable to activate and deactivate one or more of the high-power CPU 454, the low-power CPU 456, and each memory device 88 of the plurality of memory devices in accordance with a DST execution unit power optimization approach. In an example of operation, the DST execution unit 36 utilizes the DST execution unit power optimization approach, where a processing module (e.g., associated with the DST execution unit 36 which may include the low-power CPU 456, an off-site DS processing module, an off-site DS managing unit, etc.) selects an activation level for the DST execution unit 36. The activation level includes a full activation level (e.g., high-power CPU activated), a limited activation level (e.g., high-power CPU deactivated), and a deactivated level (e.g., high-power CPU and the plurality of memory devices deactivated).

The selecting is based on one or more of receiving a request, determining an estimated DST execution unit loading level, determining a DST execution unit performance goal level, estimating a DST execution unit performance level, identifying pending activity for execution, interpreting an activation schedule, interpreting a task prioritization requirement, identifying a task type, identifying a power utilization goal level, and estimating a power utilization level. For example, the processing module selects the full activation level when a level of pending activity is greater than a high pending threshold and estimated power utilization level is less than a high power utilization threshold. As another example, the processing module selects the limited activation level when the level of pending activity is less than the high pending threshold and a task type associated with the pending activity is not associated with a requirement to utilize the high-power CPU (e.g., not rebuilding slices, not performing a distributed computing task). As yet another example, the processing module selects the deactivated level when the level of pending activity is less than a low pending threshold and the estimated power utilization level is greater than a high power utilization threshold.

When the selected activation level is the limited activation level, the processing module facilitates deactivating the high-power CPU 454. When the selected activation level is the deactivated activation level the processing module facilitates deactivating the high-power CPU 454 and the plurality of memory devices 88. When the selected activation level is the full activation level, the processing module facilitates activating the high-power CPU 454.

The processing module determines whether to change the activation level of the DST execution unit 36. The processing module may determine to change the activation level from the full activation level to the limited activation level, the full activation level to the deactivated level, the limited activation level to the deactivated level, the deactivated level to the limited activation level, the limited activation level to the full activation level, and the deactivated level to the full activation level. The determining is based on one or more of receiving another request, determining an updated estimated DST execution unit loading level, determining an updated DST execution unit performance goal level, estimating an updated DST execution unit performance level, identifying new pending activity for execution, interpreting an updated activation schedule, interpreting an updated task prioritization requirement, identifying an updated task type, identifying an updated power utilization goal level, and estimating an updated power utilization level. When changing the activation level, the processing module facilitates implementing a change of activation level in accordance with the determined change in activation level.

FIG. 45B is a flowchart illustrating an example of optimizing distributed storage and task execution unit operation. The method begins at step 458 where a processing module (e.g., of a dispersed storage (DS) processing module, of a DS unit, of a DS managing unit, of a DST client module) determines a DST execution unit activation level. The determining may be based on one or more of receiving a request, determining an estimated loading level, obtaining historical loading information, and identifying pending requests. For example, the processing module determines to utilize full activation when an identified pending request includes a distributed computing partial task execution request. As another example, a processing module determines to not utilize full activation when the estimated loading level is less than a low loading level threshold and identified pending requests include encoded data slice access requests, no rebuilding requests, and no distributed computing task requests. When the level of activation is full activation, the method branches to step 462. When the level of activation is not full activation, the method continues to step 460.

The method continues at step 460 where the processing module facilitates deactivating a high-power CPU of the DST execution unit (e.g., fully turning off the high-power CPU, lowering a clock speed of the high-power CPU). The facilitating includes at least one of issuing a deactivation command to the high-power CPU and issuing the deactivation command via a low-power CPU associated with the high-power CPU to further facilitate the deactivation. The method branches to step 464.

The method continues at step 462 where the processing module facilitates activating the high-power CPU of the DST execution unit (e.g., fully turning on the high-power CPU, raising the clock speed of the high-power CPU) when the determined DS unit activation level is full activation. The facilitating includes at least one of issuing an activation command to the high-power CPU and issuing the activation command via the low-power CPU associated with the high-power CPU to further facilitate the activation. The method branches to step 464.

The method continues at step 464 where the processing module determines whether to change activation of the high-power CPU. The determining may be based on one or more of a power savings goal, pending task power requirements, the number of pending tasks, a type of pending tasks, the starkly executed task, the request, an error message, a historical performance level, and a performance level goal. For example, the processing module determines to activate the high-power CPU when the high-power CPU is inactive and when pending tasks require more CPU power. As another example, the processing module determines to deactivate the high-power CPU when power consumption of the DS unit is greater than a high power consumption threshold level. When changing the activation, the method continues at step 466 where the processing module facilitates updating activation of the high-power CPU. The facilitating includes activating or deactivating in accordance with the determining whether to change the activation.

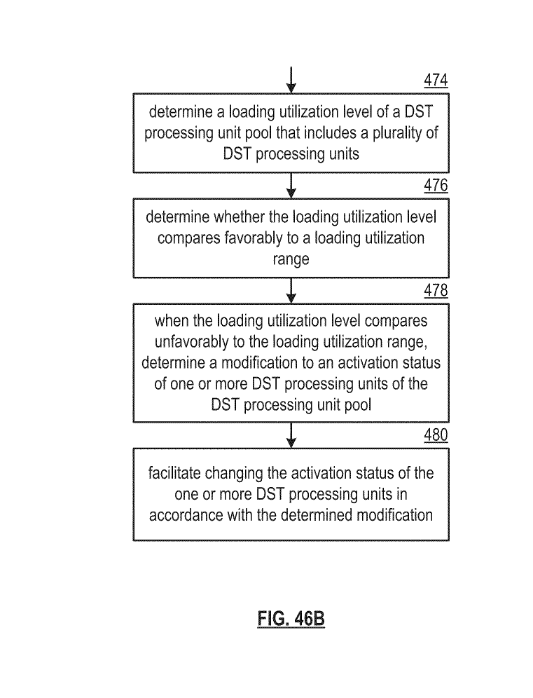

FIG. 46A is a schematic block diagram of another embodiment of a dispersed storage network system that includes a plurality of user devices 14 of FIG. 1, a distributed storage and task (DST) processing unit pool 468, and a dispersed storage network (DSN) memory 390 of FIG. 41A. The DSN memory 390 includes a plurality of DS units. The DST processing unit pool 468 includes a plurality of DST processing units 16 of FIG. 1.

The system functions to store data 470, as slices 472, in the DSN memory 390 in accordance with a DST processing unit pool power consumption approach. Each DST processing unit 16 may operate in accordance with an activation state, where the activation status includes an activated state and a deactivated state. The DST processing unit 16 is substantially nonoperational and turned off when in the deactivated state and is fully operational consuming power in the activated state. The system may provide a power savings by utilizing just enough DST processing units 16 to meet a DST processing unit pool loading demand level from the plurality of user devices 14 in accordance with the DST processing unit pool power consumption approach. Each user device 14 may access each DST processing unit 16 such that when a DST processing unit is deactivated, a user device 14 may select another DST processing unit for utilization to gain access to the DSN memory 390.

A processing module (e.g., of a DS managing unit, of a DST processing unit) determines a DST processing unit pool loading utilization level and a DST processing unit pool loading capability level. The determining may be based on one or more of accessing a historical record, receiving an error message, accessing a management record, monitoring data requests, monitoring slice transfers, initiating a test, initiating a query, receiving a response, receiving a result, and a lookup. The processing module determines whether the DST processing unit pool loading utilization level compares unfavorably to the DST processing unit pool loading capability level. The determining includes calculating a utilization percentage level by dividing the DST processing unit pool loading utilization level by the DST processing unit pool loading capability level. The determining further includes comparing the utilization percentage level to a high threshold level and a low threshold level. The processing module determines that the comparison is unfavorable when either the utilization percentage level is greater than the high threshold level (e.g., over utilized) or less than the low threshold level (e.g., underutilized and wasting too much power).

When the DST processing unit pool loading utilization level compares unfavorably to the DST processing unit pool loading capability level, the processing module determines a modification to an activation state for one or more DST processing units 16. For example, the processing module determines to activate one or more DST processing units 16 when the comparison is unfavorable due to the utilization percentage level being greater than the high threshold level. As another example, the processing module determines to deactivate one or more DST processing units when the comparison is unfavorable due to the utilization percentage level being less than the low threshold level. The processing module facilitates modifying the activation state for the one or more DST processing units 16 in accordance with the determined modification to the activation state for the one or more DST processing units 16. The facilitating includes issuing an activation command to the one or more DST processing units 16 when determining to activate the one or more DST processing units 16. The facilitating further includes issuing a deactivation command to the one or more DST processing units 16 when determining to deactivate the one or more DST processing units 16.

FIG. 46B is a flowchart illustrating an example of optimizing distributed storage and task (DST) processing unit operation. The method begins at step 474 where a processing module (e.g., of a dispersed storage (DS) processing module, of a DS processing unit, of a DS managing unit, of a DST processing unit) determines a loading utilization level of a DST processing unit pool that includes a plurality of DST processing units. The determining includes obtaining a loading level via at least one of a query, a test, and a lookup; obtaining a capability level based on at least one of a lookup, receiving, and initiating a query; and dividing the loading level by the capability level to produce the loading utilization level (e.g., as a percentage). The method continues at step 476 where the processing module determines whether the loading utilization level compares favorably to a loading utilization range. For example, the processing module indicates a favorable comparison when the loading utilization level is less than a high threshold and greater than a low threshold (e.g., within the loading utilization range).

When the loading utilization level compares unfavorably to the loading utilization range, the method continues at step 478 where the processing module determines a modification to an activation status of one or more DST processing units of the DST processing unit pool. When the loading utilization level is greater than the high threshold, the processing module identifies one or more DST processing units of the DST processing unit pool to activate. When the loading utilization level is less than the low threshold, the processing module identifies one or more DST processing units of the DST processing unit pool to deactivate. The processing module may select a number of DST processing units to achieve an estimated loading utilization level such that the estimated loading utilization level compares favorably to the loading utilization range. The method continues at step 480 where the processing module facilitates changing the activation status of the one or more DST processing units in accordance with the determined modification. The facilitating includes generating and outputting an activation status change request to the one or more DST processing units in accordance with the determined modification (e.g., an activation request, a deactivation request).

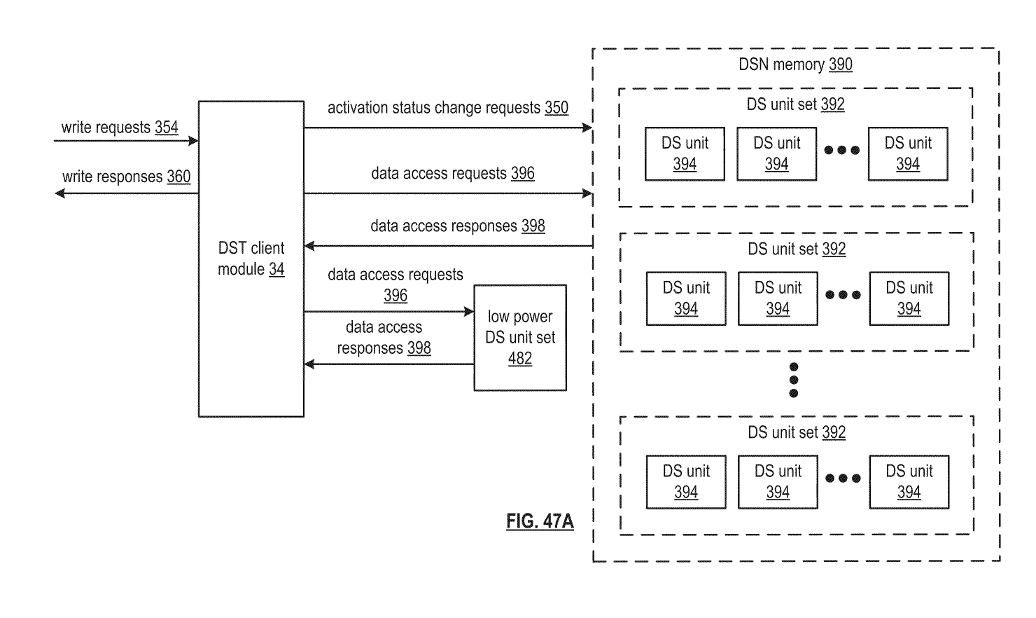

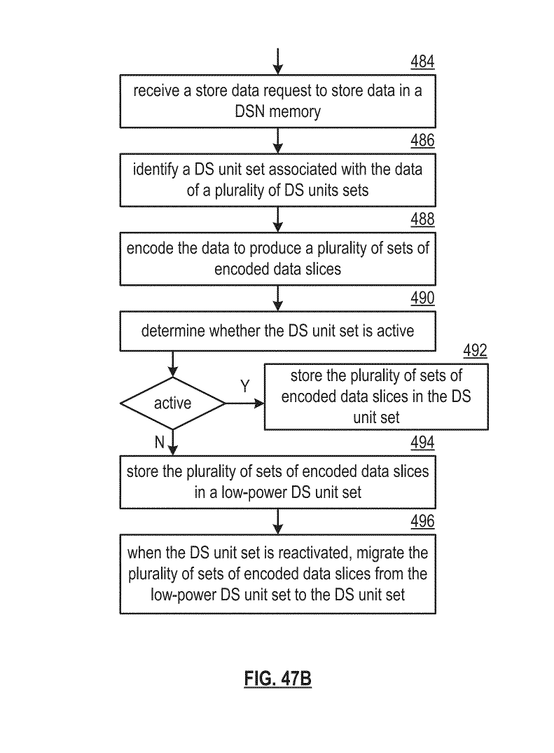

FIG. 47A is a schematic block diagram of another embodiment of a dispersed storage network system that includes at least one distribute storage and task (DST) client module 34 of FIG. 1, a low-power dispersed storage (DS) unit set 482, and the dispersed storage network (DSN) memory 390 of FIG. 41A. The DSN memory 390 includes a plurality of DS units 394 organized into a plurality of sets of DS units. The low-power DS unit set 482 may be implemented utilizing one or more of a memory device, a memory, a plurality of memories, a user device, a storage server, a local DS unit set, and a storage module. The low-power DS unit set 482 requires substantially less power than a DS unit set 392 of a plurality of DS units sets of the plurality of DS units of the DSN memory 390.

The system functions to store data in the DSN memory 390 in accordance with a power management approach. Each DS unit set of the plurality of DS units sets is activated and deactivated in accordance with the power management approach (e.g., the DST client module 34 issues activation status change requests 350 to the DSN memory 390). Deactivation includes at least one of powering off substantially each DS unit 394 of the DS unit set, powering off more than a decode threshold number of DS units 394 of the DS unit set, suspending operations of at least some of the DS units 394 of the DS unit set, and deactivating internal resources of at least one DS unit 394 of the DS unit set. Activation includes at least one of powering up substantially each DS unit 394 of the DS unit set, powering up more than the decode threshold number of DS units 394 of the DS unit set, resuming operations of at least some of the DS units 394 of the DS unit set, and reactivating previously deactivated internal resources of at least one DS unit 394 of the DS unit set.

The power management approach may be executed in accordance with one or more power management factors. The one or more power management factors include a schedule, a request, and a dynamic operation. The dynamic operation may be based on one or more of real-time power provider costs, DSN system activity level, a data object access frequency level, a data access latency performance level, a data access latency performance goal, a data security requirement, a number of pending DSN memory requests, a number of pending DSN memory requests goal, a DSN memory power consumption level, a DS unit set power consumption level, a DS unit power consumption level, the DS unit set access bandwidth level, and a DS unit set access latency level.

In an example of operation using the power management approach, the DST client module 34 receives a plurality of data access requests 396. For example, the DST client module 34 receives a store data request to store a data object in at least one DS unit set. When a store data access request is received, the DST client module 34 identifies a corresponding DS unit set as an identified DS unit set. The identifying is based on one or more of a requesting entity identifier (ID), a corresponding vault ID, obtaining a data ID associated with the data access request, identifying a source name, identifying at least one set of slice names, identifying a DSN address, identifying a data tag (e.g., a result of performing a deterministic function on the data object) associated with the data access request, accessing a hierarchical dispersed index, accessing a directory, initiating a query, receiving a response, and performing a lookup of a DSN address to physical location table.

The DST client module 34 determines whether the identified DS unit set is active based on one or more of accessing an activation list, initiating a query, receiving a response, performing a test, and receiving an error message. The DS unit set is active when activated and inactive when deactivated. The DST client module 34 processes the received data access request including accessing at least one of the identified DS unit set and the low-power DS unit set; and issuing write responses 360 as a data access response to a requesting entity based on accessing the at least one of the identified DS unit set and the low-power DS unit set. The DST client module 34 encodes the data object using a dispersed storage error coding function to produce a plurality of sets of encoded data slices. The DST client module 34 generates one or more data access requests 396 that include the plurality of sets of encoded data slices (e.g., generating write slice requests).

When the identified DS unit set is active, the DST client module 34 accesses the identified DS unit set including outputting the one or more data access requests 396 to the identified DS unit set, and receiving one or more data access responses 398 from the identified DS unit set (e.g., receiving write slice responses). When the identified DS unit set is inactive, the DST client module 34 accesses the low-power DS unit set 482 including outputting the one or more data access requests 396 to the low-power DS unit set 482 to facilitate temporary storage of the plurality of encoded data slices in the low-power DS unit set 482, and receiving one or more data access responses 398 from the low-power DS unit set 482 (e.g., receiving write slice responses).

The issuing of the data access response (e.g., the write responses 360) to the requesting entity includes generating the data access response based on the data access responses 398 from the DS unit set. For example, the DST client module 34 generates a store data response based on write slice responses for the data access requests issued to at least one of the identified DS unit set and the low-power DS unit set.

In another example of operation based on the power management approach, when the identified DS unit set is inactive, the DST client module 34 detects when the inactive identified DS unit set has been reactivated. The detecting includes at least one of determining, receiving an error message, detecting a power consumption change, interpreting a schedule, initiating a query, receiving a response, receiving an alert, initiating a test, receiving a test result, and interpreting a predetermination. When the inactive identified DS unit set has been reactivated, the DST client module 34 facilitates migration of the plurality of encoded data slices from the low-power DS unit set 482 to the identified DS unit set. The facilitating includes at least one of issuing read slice requests as data access requests 396 to the low-power DS unit set 482, receiving data access responses 398 that includes the plurality of sets of encoded data slices, and issuing write slice requests as data access requests 396 to the identified DS unit set that includes the plurality of sets of encoded data slices; issuing a migration data access request to the low-power DS unit set, and issuing the migration data access request to the identified DS unit set. The DST client module 34 detects when migration of the slices is confirmed and facilitates storage of the slices from the low-power DS unit set. For example, the DST client module 34 issues delete data access requests to the low-power DS unit set to facilitate deletion of the plurality of sets of encoded data slices.

FIG. 47B is a flowchart illustrating an example of optimizing dispersed storage network memory operation. The method begins at step 484 where a processing module (e.g., of a distributed storage and task (DST) client module) receives a store data request to store data in a dispersed storage network (DSN) memory. The store data request includes one or more of the data, a data identifier (ID), a priority indicator, a security indicator, a performance indicator, a vault ID, a source name, and a DS unit set ID. The method continues at step 486 where the processing module identifies a DS unit set associated with the data, where a plurality of DS units sets of the DSN memory includes the DS unit set. The identifying includes at least one of performing a lookup based on one or more of the data ID, a vault ID, the source name, the priority indicator, the security indicator, the performance indicator; receiving the DS unit set ID; randomly selecting the DS unit set; and selecting a DS unit set associated with an activated status (e.g., to facilitate immediate storage).

The method continues at step 488 where the processing module encodes the data using a dispersed storage error coding function to produce a plurality of sets of encoded data slices. The method continues at step 490 where the processing module determines whether the DS unit set is active. The determining may be based on one or more of initiating a query, initiating a test, issuing a query, performing a lookup, receiving an activation state indicator, and interpreting a schedule. The method branches to step 494 when the DS unit set is inactive. The method continues to step 492 when the DS unit set is active. The method continues at step 492 where the processing module stores the plurality of sets of encoded data slices in the DS unit set when the DS unit set is active. The storing includes generating one or more sets of write slice requests that includes the plurality of sets of encoded data slices and outputting the one or more sets of write slice requests to the DS unit set. Alternatively, or in addition to, the processing module updates a directory and/or a hierarchical dispersed index to associate a DS unit set storage location of the plurality of encoded data slices with the data ID.

The method continues at step 494 where the processing module stores the plurality of sets of encoded data slices in a low-power DS unit set when the DS unit set is inactive. The storing includes generating the one or more sets of write slice requests that includes the plurality of sets of encoded data slices and outputting the one or more sets of write slice requests to the low-power DS unit set. Alternatively, the processing module re-encodes the data using alternative dispersal parameters of the dispersed storage error coding function to produce an alternative plurality of sets of encoded data slices for storage in the low-power DS unit set based on one or more aspects of the low-power DS unit set. Alternatively, or in addition to, the processing module updates the directory and/or the hierarchical dispersed index to associate a low-power DS unit set storage location of the plurality of encoded data slices with the data ID.

When the DS unit set is reactivated, the method continues at step 496 where the processing module facilitates migration of the plurality of sets of encoded data slices from the low-power DS unit set to the DS unit set. The facilitating includes one or more of issuing one or more sets of read slice requests to the low-power DS unit set, receiving the plurality of sets of encoded data slices from the low-power DS unit set, issuing one or more sets of write slice requests to the DS unit set that includes the plurality of sets of encoded data slices, issuing one or more sets of delete slice requests to the low-power DS unit set to facilitate deletion of the plurality of sets of encoded data slices from the low-power DS unit set when the migration is confirmed, and updating one or more of the directory and the hierarchical dispersed index to associate the plurality of encoded data slices with the DS unit set.

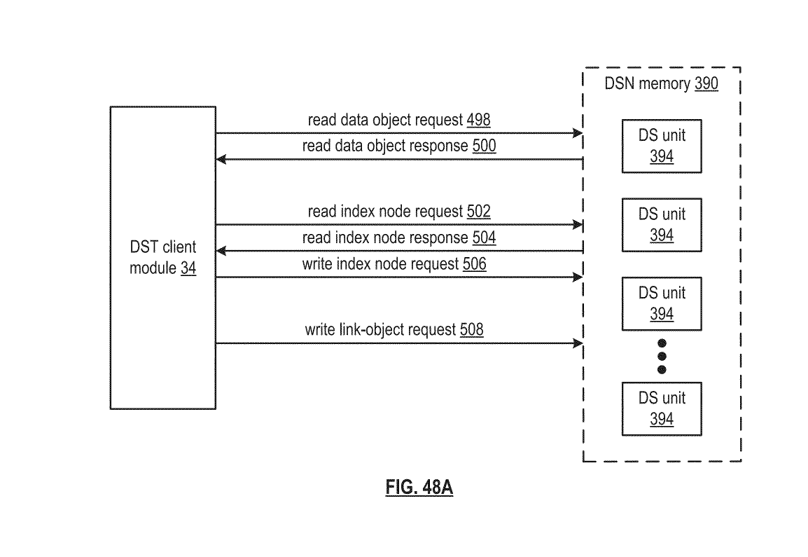

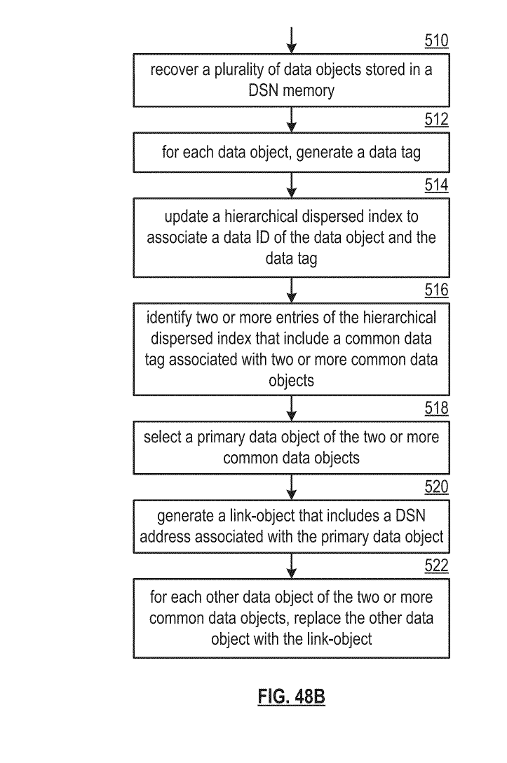

FIG. 48A is a schematic block diagram of another embodiment of a dispersed storage network system that includes at least one dispersed storage and task (DST) client module 34 of FIG. 1 and the dispersed storage network (DSN) memory 390 of FIG. 41A. The DSN memory 390 includes a plurality of DS units 394 and may be organized into one or more sets of DS units.

The system functions to optimize data storage efficiency within the DSN memory 390 in accordance with a data de-duplication approach. For example, the DST client module 34 functions to identify a plurality of previously stored duplicate copies of a data object and eliminates at least some of the duplicate copies to improve the data storage efficiency of the DSN memory. A hierarchical dispersed index may be utilized to associate a plurality of data identifiers (IDs) with the plurality of previously stored duplicate copies of the data object. For example, an entry of a first index node of the hierarchical dispersed index includes a first data ID and a DSN address of a storage location associated with a first copy of the plurality of previously stored duplicate copies of the data object and another entry of a second index node of the hierarchical dispersed index includes a second data ID and a DSN address of a storage location associated with a second copy of the plurality of previously stored duplicate copies of the data object.

In an example of utilizing the data de-duplication approach, the DST client module 34 recovers a data object stored in the DSN memory 390 by issuing a read data object request 498 to the DSN memory 390 using a data ID associated with the data object, receiving a read data object response 500, and decoding the read data object response 500 to produce a recovered data object. The DST client module 34 may obtain the data ID based on at least one of randomly selecting a data ID from a data ID list, selecting a next data ID from the data ID list, receiving the data ID, and retrieving the data ID from the hierarchical dispersed index. The issuing includes generating a plurality of sets of slice names based on the data ID, generating one or more sets of read slice requests that includes the plurality of sets of slice names, and outputting the one or more sets of read slice requests to the DSN memory 390. The generating the plurality of sets of slice names includes recovering a source name (e.g., DSN address, a storage location) from at least one of the hierarchical dispersed index and a directory using the data ID and generating the plurality of sets of slice names to include the source name. The receiving the read data object response 500 includes receiving at least a decode threshold number of encoded data slices corresponding to each set of slice names of the plurality of sets of slice names. The decoding the read data object response includes decoding the at least a decode threshold number of encoded data slices corresponding to each set of slice names using a dispersed storage error coding function to recover an associated data segment and aggregating a plurality of recovered data segments to produce the recovered data object.

The DST client module 34 generates a data tag for the recovered data object by performing a deterministic function on the recovered data object. The deterministic function includes at least one of performing a cyclic redundancy code check function, performing a hashing function, performing a hash-based message authentication code function, performing a mask generating function, performing a finite field mathematical function, and performing a sponge function. The DST client module 34 updates the hierarchical dispersed index to associate the data ID and the data tag. The updating includes identifying an index node of the hierarchical dispersed index corresponding to the data ID (e.g., read the index, list the index, issue a read index node request 502, receive read index node response 504, compare entries to the data ID to identify the corresponding index node), issuing a read index node request 502 (e.g., issuing a set of read slice requests), receiving a read index node response 504 that includes the index node (e.g., receiving at least a decode threshold number of index slices), modifying the index node to include the association (e.g., add the data tag to the entry of the index node associated with the data ID), and issuing a write index node request 506 (e.g., encoding the modified index node using the dispersed storage error coding function to generate a set of updated index slices, issuing a set of write slice requests that includes the set of updated index slices) to the DSN memory 390 that includes the modified index node.

The DST client module 34 identifies two or more entries of the hierarchical dispersed index that include a common data tag. For example, the DST client module 34 searches the hierarchical dispersed index for matching data tags. The DST client module 34 selects a primary DSN address associated with storage of a data object copy of two or more data objects stored in the DSN memory 390 that corresponds to the two or more entries of the hierarchical dispersed index that includes the common data tag. Two or more DSN addresses associated with storage of the two or more data objects includes the primary DSN address. The selecting includes at least one of a random selection, identifying a lowest ordered DSN address, identifying a highest ordered DSN address, identify a longest stored data object copy as the data object copy, and selecting a DSN address associated with a predetermined preferred DSN address range.

The DST client module 34 generates a link-object that includes the primary DSN address. The generating further includes generating the link-object to include the common data tag. For each remaining DSN address of the two or more DSN addresses (e.g., not including the primary DSN address) corresponding to each other data object copy of the two or more data object copies, the DST client module 34 replaces the other data object copy at a corresponding remaining DSN address with the link-object. The replacing includes encoding the link-object using the dispersed storage error coding function to produce a set of link-object slices, generating a set of write slice requests that includes the set of link-object slices and a set of slice names corresponding to the remaining DSN address, and outputting the set of write slice requests as a write link object request 508 to the DSN memory 390.

In an example of a retrieval operation, the DST client module 34 receives a request to recover a data object with another data ID. The DST client module 34 performs a hierarchical dispersed index lookup using the other data ID to recover a DSN address of a link-object stored in the DSN memory 390. The DST client module 34 retrieves the link-object from the DSN memory 390 using the DSN address of the link-object. The DST client module 34 recovers a DSN address of the data object from the link-object. The DST client module 34 recovers the data object from the DSN memory using the DSN address of the data object.

FIG. 48B is a flowchart illustrating an example of consolidating redundantly stored data. The method begins at step 510 where a processing module (e.g., of distributed storage and task (DST) client module) recovers a plurality of data objects stored in a dispersed storage network (DSN) memory. The recovering includes, for each data object, issuing one or more sets of read slice requests based on a DSN address associated with the data object, receiving read slice responses, and decoding encoded data slices using a dispersed storage error coding function to reproduce the data object.

For each data object, the method continues at step 512 where the processing module generates a data tag. The generating includes performing a deterministic function on the data object to produce the data tag. The method continues at step 514 where the processing module updates a hierarchical dispersed index to associate a data identifier (ID) of the data object and the data tag. The updating includes accessing the hierarchical dispersed index to recover an entry associated with the data object, modifying the entry to include the data tag, and storing the modified entry in the hierarchical dispersed index. Alternatively, or in addition to, the processing module creates and/or updates the hierarchical dispersed index to be searchable by data tags.

The method continues at step 516 where the processing module identifies two or more entries of the hierarchical dispersed index that includes a common data tag associated with two or more common data objects. The identifying includes accessing the hierarchical dispersed index to identify the two or more entries that include the common data tag and recovering the two or more entries. The method continues at step 518 where the processing module selects a primary data object of the two or more common data objects. The selecting includes identifying a data object of the two or more common data objects based on one or more of a likelihood of deletion, an association with a user identifier, an earliest storage timestamp, a latest storage timestamp, a random selection, a predetermined storage location, and a DSN address preference.

The method continues at step 520 where the processing module generates a link-object that includes a DSN address associated with the primary data object. The generating includes identifying the DSN address associated with the primary data object from a corresponding entry of the hierarchical dispersed index. The processing module may further generate the link-object to include the common data tag. For each other data object of the two or more common data objects (e.g., outside of the primary data object), the method continues at step 522 where the processing module replaces the other data object with the link-object. The replacing includes identifying a DSN address associated with the other data object from the hierarchical dispersed index, replacing a first stored data segment with the link-object using the DSN address (e.g., overwrite a first set of slices of the first store data segment with a set of link-object slices), and deleting remaining data segments of the plurality of data segments associated with the other data object (e.g., issuing delete slice requests for each remaining data segment of the plurality of data segments).

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “operably coupled to”, “coupled to”, and/or “coupling” includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item. As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

As may also be used herein, the terms “processing module”, “processing circuit”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may be, or further include, memory and/or an integrated memory element, which may be a single memory device, a plurality of memory devices, and/or embedded circuitry of another processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

The present invention has been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

The present invention may have also been described, at least in part, in terms of one or more embodiments. An embodiment of the present invention is used herein to illustrate the present invention, an aspect thereof, a feature thereof, a concept thereof, and/or an example thereof. A physical embodiment of an apparatus, an article of manufacture, a machine, and/or of a process that embodies the present invention may include one or more of the aspects, features, concepts, examples, etc., described with reference to one or more of the embodiments discussed herein. Further, from figure to figure, the embodiments may incorporate the same or similarly named functions, steps, modules, etc., that may use the same or different reference numbers and, as such, the functions, steps, modules, etc., may be the same or similar functions, steps, modules, etc., or different ones.

While the transistors in the above described figure(s) is/are shown as field effect transistors (FETs), as one of ordinary skill in the art will appreciate, the transistors may be implemented using any type of transistor structure including, but not limited to, bipolar, metal oxide semiconductor field effect transistors (MOSFET), N-well transistors, P-well transistors, enhancement mode, depletion mode, and zero voltage threshold (VT) transistors.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of the various embodiments of the present invention. A module includes a processing module, a functional block, hardware, and/or software stored on memory for performing one or more functions as may be described herein. Note that, if the module is implemented via hardware, the hardware may operate independently and/or in conjunction software and/or firmware. As used herein, a module may contain one or more sub-modules, each of which may be one or more modules.

While particular combinations of various functions and features of the present invention have been expressly described herein, other combinations of these features and functions are likewise possible. The present invention is not limited by the particular examples disclosed herein and expressly incorporates these other combinations.

What is claimed is:

1. A method for execution by one or more processing modules of one or more computing devices of a dispersed storage network (DSN), the method comprises:
receiving a plurality of data access requests regarding a plurality of data objects, wherein a data object of the plurality of data objects is distributedly stored in a set of storage devices of a plurality of storage devices of the DSN, wherein the plurality of storage devices is arranged into a plurality of logical storage pools, wherein the set of storage devices stores data objects of the plurality of data objects having a common data access trait, and wherein the set of storage devices is affiliated with one of the plurality of logical storage pools; and
as individual data access requests of the plurality of data access requests are received, for each individual data access request of the individual data access requests:
identifying a corresponding one of the plurality of logical storage pools;
determining power based access status of the corresponding one of the plurality of logical storage pools;
when the power based access status is power saving mode, queuing the individual data access request; and
when the power based access status is not in the power saving mode, executing the individual data access request.

2. The method of claim 1, wherein the identifying the corresponding one of the plurality of logical storage pools comprises at least one of:
interpreting a field within the individual data access request, wherein the field includes data regarding one or more of a data identifier, a generation value, a vault identifier, a timestamp, user preference, a DSN data access priority, and a logical storage pool identifier; and
determining a data access trait of the data object of the individual data access request, wherein the data access trait includes one or more of age of the data object, data object type, and data object storage status.

3. The method of claim 1, wherein the determining the power based access status comprises:
accessing a power based data access plan for the corresponding one of the plurality of logical storage pools, wherein the power based data access plan indicates a power status for each storage device affiliated with the corresponding one of the plurality of logical storage pools, wherein the power status is one of active power on, inactive power off, and inactive power on.

4. The method of claim 1 further comprises:
retrieving, from a queue, a queued individual data access request;
sending an activation power on command to a desired set of storage devices affiliated with the corresponding one of the plurality of logical storage pools;
generating execute access request commands for the desired set of storage devices; and
when the desired set of storage devices are in an active power on mode, sending the execute access request commands to the desired set of storage devices for execution.

5. The method of claim 4 further comprises:
when the queued individual data access request is a read request:
determining a read threshold number of storage devices as the desired set of storage devices; and
generating a plurality of read commands as the execute access request commands.

6. The method of claim 4 further comprises:
when the queued individual data access request is a write request:
determining a write threshold number of storage devices as the desired set of storage devices; and
generating a plurality of write commands as the execute access request commands.

7. The method of claim 1, wherein a storage device of the plurality of storage devices comprises one or more of:
one or more memory devices within a storage unit of the DSN;
one or more storage units at a site of the DSN; and
one or more sites of the DSN.

8. The method of claim 1 further comprises:
organizing queued individual data access requests into groups of requests based on the plurality of logical storage pools such that a group of requests of the groups of requests is affiliated with a given one of the plurality of logical storage pools.

9. The method of claim 8 further comprises:
retrieving, from a queue, a group of queued individual data access requests;
sending an activation power on command to a desired set of storage devices affiliated with the corresponding one of the plurality of logical storage pools;
generating, for each of the queued individual data access requests, execute access request commands for the desired set of storage devices to produce a group of execute access request commands;
when the desired set of storage devices are in an active power on mode, sending the group of execute access request commands to the desired set of storage devices for execution; and
when the desired set of storage devices have executed the group of execute access request commands, sending an inactivation power down command to the desired set of storage devices.

10. A dispersed storage (DS) module of a dispersed storage network (DSN), the DS module comprises:
a first module, when operable within a computing device, causes the computing device to:
receive a plurality of data access requests regarding a plurality of data objects, wherein a data object of the plurality of data objects is distributedly stored in a set of storage devices of a plurality of storage devices of the DSN, wherein the plurality of storage devices is arranged into a plurality of logical storage pools, wherein the set of storage devices stores data objects of the plurality of data objects having a common data access trait, and wherein the set of storage devices is affiliated with one of the plurality of logical storage pools; and
a second module, when operable within the computing device, causes the computing device to:
as individual data access requests of the plurality of data access requests are received, for each individual data access request of the individual data access requests:
identify a corresponding one of the plurality of logical storage pools;
determine power based access status of the corresponding one of the plurality of logical storage pools;
when the power based access status is power saving mode, queue the individual data access request; and
when the power based access status is not in the power saving mode, execute the individual data access request.

11. The DS module of claim 10, wherein the second module causes the computing device to identify the corresponding one of the plurality of logical storage pools by at least one of:
interpreting a field within the individual data access request, wherein the field includes data regarding one or more of a data identifier, a generation value, a vault identifier, a timestamp, user preference, a DSN data access priority, and a logical storage pool identifier; and
determining a data access trait of the data object of the individual data access request, wherein the data access trait includes one or more of age of the data object, data object type, and data object storage status.

12. The DS module of claim 10, wherein the second module causes the computing device to determine the power based access status by:
accessing a power based data access plan for the corresponding one of the plurality of logical storage pools, wherein the power based data access plan indicates a power status for each storage device affiliated with the corresponding one of the plurality of logical storage pools, wherein the power status is one of active power on, inactive power off, and inactive power on.

13. The DS module of claim 10 further comprises:
the second module, when operable within the computing device, further causes the computing device to:
retrieve, from a queue, a queued individual data access request;
send an activation power on command to a desired set of storage devices affiliated with the corresponding one of the plurality of logical storage pools;
generate execute access request commands for the desired set of storage devices; and
when the desired set of storage devices are in an active power on mode, send the execute access request commands to the desired set of storage devices for execution.

14. The DS module of claim 13 further comprises:
the second module, when operable within the computing device, further causes the computing device to:
when the queued individual data access request is a read request:
determine a read threshold number of storage devices as the desired set of storage devices; and
generate a plurality of read commands as the execute access request commands.

15. The DS module of claim 13 further comprises:
the second module, when operable within the computing device, further causes the computing device to:
when the queued individual data access request is a write request:
determine a write threshold number of storage devices as the desired set of storage devices; and
generate a plurality of write commands as the execute access request commands.

16. The DS module of claim 10, wherein a storage device of the plurality of storage devices comprises one or more of:
one or more memory devices within a storage unit of the DSN;
one or more storage units at a site of the DSN; and
one or more sites of the DSN.

17. The DS module of claim 10 further comprises:
the second module, when operable within the computing device, further causes the computing device to:
organize queued individual data access requests into groups of requests based on the plurality of logical storage pools such that a group of requests of the groups of requests is affiliated with a given one of the plurality of logical storage pools.

18. The DS module of claim 17 further comprises:
the second module, when operable within the computing device, further causes the computing device to:
retrieve, from a queue, a group of queued individual data access requests;
send an activation power on command to a desired set of storage devices affiliated with the corresponding one of the plurality of logical storage pools;
generate, for each of the queued individual data access requests, execute access request commands for the desired set of storage devices to produce a group of execute access request commands;
when the desired set of storage devices are in an active power on mode, send the group of execute access request commands to the desired set of storage devices for execution; and
when the desired set of storage devices have executed the group of execute access request commands, send an inactivation power down command to the desired set of storage devices.
